(19) United States
(12) Patent Application Publication
(10) Pub. No.: US 2007/0154270 A1
(43) Pub. Date: Jul. 5, 2007

(54) PIPELINE

(75) Inventors: Kevin Karl Waddell, Houston, TX (US); Mark Shuster, Voorburg (NL); Anthony Cole, Den Haag (NL); Robert Lance Cook, Katy, TX (US); R. Bruce Stewart, Edinburgh (GB); Richard Carl Haut, The Woodlands, TX (US); David Paul Brisco, Duncan, OK (US); Lev Ring, Houston, TX (US); Robert Donald Mack, Wassenaar (NL); Serge Roggeband, Ijssel (NL)

Correspondence Address: HAYNES AND BOONE, LLP, 901 MAIN STREET, SUITE 3100, DALLAS, TX, 75202-3789, US

(73) Assignee: Shell Oil Company, Houston, TX (US)

(21) Appl. No.: 11/560,154

(22) Filed: Nov. 15, 2006

Related U.S. Application Data
(63) Continuation-in-part of application No. 10/199,524, filed on Jul. 19, 2002, now Pat. No. 7,159,665.
Application No. 10/199,524 is a continuation of application No. 09/454,139, filed on Dec. 3, 1999, now Pat. No. 6,497,289.
(60) Provisional application No. 60/832,909, filed on Jul. 24, 2006.
(60) Provisional application No. 60/111,293, filed on Dec. 7, 1998.

(51) Int. Cl. F16L 55/18

(52) U.S. Cl. 405/184.1

(57) ABSTRACT

A pipeline.

### CROSS REFERENCE TO RELATED APPLICATIONS

This application claims the benefit of the filing date of U.S. provisional patent application Ser. No. 60/832,909, attorney docket number 25791.407, filed on Jul. 24, 2006, the disclosure of which is incorporated herein by reference.

This application is a continuation-in-part of U.S. patent application Ser. No. 10/199,524, attorney docket no. 25791.100, filed on Jul. 19, 2002 which was a continuation of U.S. patent application Ser. No. 09/454,139, attorney docket no. 25791.3.02, filed on Dec. 3, 1999, which issued as U.S. Pat. No. 6,497,289, which claimed the benefit of the filing date of U.S. Provisional Patent Application Ser. No. 60/111,293, attorney docket number 25791.3, filed on Dec. 7, 1998, the disclosures of which are incorporated herein by reference.

This application is related to the following co-pending applications: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. Pat. No. 6,640,903 which was filed as U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/______, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application serial No. 60/343,674, attorney docket no. 25791.68, filed on Dec. 27, 2001, (46) U.S. utility patent application Ser. No. 09/969,922, attorney docket no. 25791.69, filed on Oct. 3, 2001, (now U.S. Pat. No. 6,634,431 which issued Oct. 21, 2003), which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, (now U.S. Pat. No. 6,634,431 which issued Oct. 21, 2003), which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, (now U.S. Pat. No. 6,634,431 which issued Oct. 21, 2003), which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999; (122) PCT patent application serial no. PCT/US2004/06246, attorney docket no. 25791.238.02, filed on Feb. 26, 2004; (123) PCT patent application serial number PCT/US2004/08170, attorney docket number 25791.40.02, filed on Mar. 15, 2004; (124) PCT patent application serial number PCT/US2004/08171, attorney docket number 25791.236.02, filed on Mar. 15, 2004; (125) PCT patent application serial number PCT/US2004/08073, attorney docket number 25791.262.02, filed on Mar. 18, 2004; (126) PCT patent application serial number PCT/US2004/07711, attorney docket number 25791.253.02, filed on Mar. 11, 2004; (127) PCT patent application serial number PCT/US2004/029025, attorney docket number 25791.260.02, filed on Mar. 26, 2004; (128) PCT patent application serial number PCT/US2004/010317, attorney docket number 25791.270.02, filed on Apr. 2, 2004; (129) PCT patent application serial number PCT/US2004/010712, attorney docket number 25791.272.02, filed on Apr. 6, 2004; (130) PCT patent application serial number PCT/US2004/010762, attorney docket number 25791.273.02, filed on Apr. 6, 2004; (131) PCT patent application serial number PCT/US2004/011973, attorney docket number 25791.277.02, filed on Apr. 15, 2004; (132) U.S. provisional patent application Ser. No. 60/495,056, attorney docket number 25791.301, filed on Aug. 14, 2003; (133) U.S. provisional patent application Ser. No. 60/600,679, attorney docket number 25791.194, filed on Aug. 11, 2004; (134) PCT patent application serial number PCT/US2005/027318, attorney docket number 25791.329.02, filed on Jul. 29, 2005; (135) PCT patent application serial number PCT/US2005/028936, attorney docket number 25791.338.02, filed on Aug. 12, 2005; (136) PCT patent application serial number PCT/US2005/028669, attorney docket number 25791.194.02, filed on Aug. 11, 2005; (137) PCT patent application serial number PCT/US2005/028453, attorney docket number 25791.371, filed on Aug. 11, 2005; (138) PCT patent application serial number PCT/US2005/028641, attorney docket number 25791.372, filed on Aug. 11, 2005; (139) PCT patent application serial number PCT/US2005/028819, attorney docket number 25791.373, filed on Aug. 11, 2005; (140) PCT patent application serial number PCT/US2005/028446, attorney docket number 25791.374, filed on Aug. 11, 2005; (141) PCT patent application serial number PCT/US2005/028642, attorney docket number 25791.375, filed on Aug. 11, 2005; (142) PCT patent application serial number PCT/US2005/028451, attorney docket number 25791.376, filed on Aug. 11, 2005, and (143). PCT patent application serial number PCT/US2005/028473, attorney docket number 25791.377, filed on Aug. 11, 2005, (144) U.S. utility patent application Ser. No. 10/546,082, attorney docket number 25791.378, filed on Aug. 16, 2005, (145) U.S. utility patent application Ser. No. 10/546,076, attorney docket number 25791.379, filed on Aug. 16, 2005, (146) U.S. utility patent application Ser. No. 10/545,936, attorney docket number 25791.380, filed on Aug. 16, 2005, (147) U.S. utility patent application Ser. No. 10/546,079, attorney docket number 25791.381, filed on Aug. 16, 2005 (148) U.S. utility patent application Ser. No. 10/545,941, attorney docket number 25791.382, filed on Aug. 16, 2005, (149) U.S. utility patent application serial number 546078, attorney docket number 25791.383, filed on Aug. 16, 2005, filed on Aug. 11, 2005., (150) U.S. utility patent application Ser. No. 10/545,941, attorney docket number 25791.185.05, filed on Aug. 16, 2005, (151) U.S. utility patent application Ser. No. 11/249,967, attorney docket number 25791.384, filed on Oct. 13, 2005, (152) U.S. provisional patent application Ser. No. 60/734,302, attorney docket number 25791.24, filed on Nov. 7, 2005, (153) U.S. provisional patent application Ser. No. 60/725,181, attorney docket number 25791.184, filed on Oct. 11, 2005, (154) PCT patent application serial number PCT/US2005/023391, attorney docket number 25791.299.02 filed Jun. 29, 2005 which claims priority from U.S. provisional patent application Ser. No. 60/585,370, attorney docket number 25791.299, filed on Jul. 2, 2004, (155) U.S. provisional patent application Ser. No. 60/721,579, attorney docket number 25791.327, filed on Sep. 28, 2005, (156) U.S. provisional patent application Ser. No. 60/717,391, attorney docket number 25791.214, filed on Sep. 15, 2005, (157) U.S. provisional patent application Ser. No. 60/702,935, attorney docket number 25791.133, filed on Jul. 27, 2005, (158) U.S. provisional patent application Ser. No. 60/663,913, attorney docket number 25791.32, filed on Mar. 21, 2005, (159) U.S. provisional patent application Ser. No. 60/652,564, attorney docket number 25791.348, filed on Feb. 14, 2005, (160) U.S. provisional patent application Ser. No. 60/645,840, attorney docket number 25791.324, filed on Jan. 21, 2005, (161) PCT patent application serial number PCT/US2005/043122, attorney docket number 25791.326.02, filed on Nov. 29, 2005 which claims priority from U.S. provisional patent application Ser. No. 60/631,703, attorney docket number 25791.326, filed on Nov. 30, 2004, (162) U.S. provisional patent application Ser. No. 60/752787, attorney docket number 25791.339, filed on Dec. 22, 2005, (163) U.S. National Stage application Ser. No. 10/548,934, attorney docket no. 25791.253.05, filed on Sep. 12, 2005; (164) U.S. National Stage application Ser. No. 10/549,410, attorney docket no. 25791.262.05, filed on Sep. 13, 2005; (165) U.S. Provisional Patent Application No. 60/717391, attorney docket no. 25791.214 filed on Sep. 15, 2005; (166) U.S. National Stage application Ser. No. 10/550,906, attorney docket no. 25791.260.06, filed on Sep. 27, 2005; (167) U.S. National Stage application Ser. No. 10/551,880, attorney docket no. 25791.270.06, filed on Sep. 30, 2005; (168) U.S. National Stage application Ser. No. 10/552,253, attorney docket no. 25791.273.06, filed on Oct. 4, 2005; (169) U.S. National Stage application Ser. No. 10/552,790, attorney docket no. 25791.272.06, filed on Oct. 11, 2005; (170) U.S. Provisional Patent Application No. 60/725,181, attorney docket no. 25791.184 filed on Oct. 11, 2005; (171) U.S. National Stage application Ser. No. 10/553,094, attorney docket no. 25791.193.03, filed on Oct. 13, 2005; (172) U.S. National Stage application Ser. No. 10/553,566, attorney docket no. 25791.277.06, filed on Oct. 17, 2005; (173) PCT Patent Application No. PCT/US2006/002449, attorney docket no. 25791.324.02 filed on Jan. 20, 2006, and (174) PCT Patent Application No. PCT/US2006/004809, attorney docket no. 25791.348.02 filed on Feb. 9, 2006; (175) U.S. Utility patent application Ser. No. 11/356,899, attorney docket no. 25791.386, filed on Feb. 17, 2006, (176) U.S. National Stage application Ser. No. 10/568,200, attorney docket no. 25791.301.06, filed on Feb. 13, 2006, (177) U.S. National Stage application Ser. No. 10/568,719, attorney docket no. 25791.137.04, filed on Feb. 16, 2006, filed on Feb. 16, 2006, (178) U.S. National Stage application Ser. No. 10/569,323, attorney docket no. 25791.215.06, filed on Feb. 17, 2006, (179) U.S. National State patent application Ser. No. 10/571,041, attorney docket no. 25791.305.05, filed on Mar. 3, 2006; (180) U.S. National State patent application Ser. No. 10/571,017, attorney docket no. 25791.306.04, filed on Mar. 3, 2006; (181) U.S. National State patent application Ser. No. 10/571,086, attorney docket no. 25791.307.04, filed on Mar. 6, 2006; and (182) U.S. National State patent application Ser. No. 10/571,085, attorney docket no. 25791.308.07, filed on Mar. 6, 2006, (183) U.S. utility patent application Ser. No. 10/938,788, attorney docket number 25791.330, filed on Sep. 10, 2004, (184) U.S. utility patent application Ser. No. 10/938,225, attorney docket number 25791.331, filed on Sep. 10, 2004, (185) U.S. utility patent application Ser. No. 10/952,288, attorney docket number 25791.332, filed on Sep. 28, 2004, (186) U.S. utility patent application Ser. No. 10/952,416, attorney docket number 25791.333, filed on Sep. 28, 2004, (187) U.S. utility patent application Ser. No. 10/950,749, attorney docket number 25791.334, filed on Sep. 27, 2004, (188) U.S. utility patent application Ser. No. 10/950,869, attorney docket number 25791.335, filed on Sep. 27, 2004; (189) U.S. provisional patent application Ser. No. 60/761,324, attorney docket number 25791.340, filed on Jan. 23, 2006, (190) U.S. provisional patent application Ser. No. 60/754,556, attorney docket number 25791.342, filed on Dec. 28, 2005, (191) U.S. utility patent application Ser. No. 11/380,051, attorney docket number 25791.388, filed on Apr. 25, 2006, (192) U.S. utility patent application Ser. No. 11/380,055, attorney docket number 25791.389, filed on Apr. 25, 2006, (193) U.S. utility patent application Ser. No. 10/522,039, attorney docket number 25791.106.05, filed on Mar. 10, 2006; (194) U.S. provisional patent application Ser. No. 60/746,813, attorney docket number 25791.259, filed on May 9, 2006; (195) U.S. utility patent application Ser. No. 11/456,584, attorney docket number 25791.403, filed on Jul. 11, 2006; and (196) U.S. utility patent application Ser. No. 11/456,587, attorney docket number 25791.404, filed on Jul. 11, 2006; (197) PCT Patent Application No. PCT/US2006/009886, attorney docket no. 25791.32.02 filed on Mar. 21, 2006; and (198) PCT Patent Application No. PCT/US2006/010674, attorney docket no. 25791.337.02 filed on Mar. 21, 2006, the disclosures of which are incorporated herein by reference.

### BACKGROUND OF THE INVENTION

This invention relates generally to pipelines, and in particular to pipelines that are formed using expandable tubing.

### BRIEF DESCRIPTION OF THE DRAWINGS

FIG. 1 is a fragmentary cross-sectional view illustrating an underground pipeline.

FIG. 2 is a fragmentary cross-sectional view illustrating the unearthing the pipeline of FIG. 1 at spaced apart locations.

FIG. 3 is a fragmentary cross-sectional view illustrating the removal of portions of the unearthed portions of the pipeline of FIG. 2.

FIG. 4 is a fragmentary cross-sectional view illustrating the injection of a pig into an open end of the one of the unearthed portions of the pipeline of FIG. 3.

FIG. 5 is a fragmentary cross-sectional view illustrating the continued injection of a pig into an open end of the one of the unearthed portions of the pipeline of FIG. 4.

FIG. 6 is a fragmentary cross-sectional view illustrating the placement of an assembly for coupling pipe sections into one of the unearthed portions of the pipeline of FIG. 5.

FIG. 6a is a schematic view illustrating the welding and inspection assembly of FIG. 6.

FIG. 6b is a schematic view illustrating the coating assembly of FIG. 6.

FIG. 6c is a schematic view illustrating the actuator assembly of FIG. 6.

FIG. 7 is a fragmentary cross-sectional and schematic view illustrating the operation of the assembly for coupling pipe sections of FIG. 6.

FIG. 8 is a fragmentary cross-sectional and schematic view illustrating the continued operation of the assembly for coupling pipe sections of FIG. 7.

FIG. 8a is a fragmentary cross-sectional and schematic view illustrating the operation of the welding and inspection assembly for coupling pipe sections of FIG. 8.

FIG. 8b is a fragmentary cross-sectional and schematic view illustrating the continued operation of the welding and inspection assembly for coupling pipe sections of FIG. 8a.

FIG. 8ba is a fragmentary cross-sectional view illustrating the coupling of adjacent pipe sections in the welding and inspection assembly of FIG. 8b.

FIG. 8c is a fragmentary cross-sectional and schematic view illustrating the continued operation of the welding and inspection assembly for coupling pipe sections of FIG. 8b.

FIG. 8d is a fragmentary cross-sectional and schematic view illustrating the continued operation of the welding and inspection assembly for coupling pipe sections of FIG. 8b.

FIG. 9 is a fragmentary cross-sectional and schematic view illustrating the continued operation of the assembly for coupling pipe sections of FIG. 8.

FIG. 9a is a fragmentary cross-sectional and schematic view illustrating the operation of the coating assembly for coating coupled pipe sections of FIG. 9.

FIGS. 9ba and 9bb are fragmentary cross-sectional views illustrating the coating of coupled adjacent pipe sections in the coating assembly of FIG. 9a.

FIG. 9c is a fragmentary cross-sectional and schematic view illustrating the continued operation of the coating assembly for coating pipe sections of FIG. 9a.

FIG. 10 is a fragmentary cross-sectional and schematic view illustrating the continued operation of the assembly for coupling pipe sections of FIG. 9.

FIG. 10a is a fragmentary cross-sectional and schematic view illustrating the operation of the actuator of FIG. 10.

FIG. 10b is a fragmentary cross-sectional and schematic view illustrating the continued operation of the actuator of FIG. 10a.

FIG. 11 is a fragmentary cross-sectional and schematic view illustrating the insertion of pipe sections processed by the assembly for coupling pipe sections into the pipeline.

FIG. 12 is a fragmentary cross-sectional and schematic view illustrating the continued insertion of pipe sections processed by the assembly for coupling pipe sections into the pipeline.

FIG. 12a is a fragmentary cross-sectional illustration of an embodiment of the nose provided on the end-most pipe section.

FIG. 13 is a fragmentary cross-sectional and schematic view illustrating the continued insertion of pipe sections processed by the assembly for coupling pipe sections into the pipeline.

FIG. 14 is a fragmentary cross-sectional and schematic view illustrating the coupling of an expansion device to an end of the coupled pipe sections.

FIG. 15 is a fragmentary cross-sectional and schematic view illustrating the operation of the expansion device of FIG. 14.

FIG. 16 is a fragmentary cross-sectional and schematic view illustrating the continued operation of the expansion device of FIG. 15.

FIG. 17 is a fragmentary cross-sectional and schematic view illustrating the continued operation of the expansion device of FIG. 16.

FIG. 18 is a fragmentary cross-sectional and schematic view illustrating the continued operation of the expansion device of FIG. 17.

FIG. 18a is a cross-sectional illustrating the radial expansion and plastic deformation of the pipe sections within the pipeline of FIG. 18.

FIG. 19 is a fragmentary cross-sectional and schematic view illustrating the coupling of an end plate to an end of the radially expanded and plastically deformed pipe sections of FIG. 18.

FIG. 20 is a fragmentary cross-sectional and schematic view illustrating the coupling of an end plate and pump to another end of the radially expanded and plastically deformed pipe sections of FIG. 18.

FIG. 21 is a fragmentary cross-sectional and schematic view illustrating the coupling of a transitionary pipe section between an end of the radially expanded and plastically deformed pipe sections and another portion of the pipeline.

FIG. 22 is a fragmentary cross-sectional and schematic view illustrating the coupling of a transitionary pipe section between another end of the radially expanded and plastically deformed pipe sections and another portion of the pipeline.

FIG. 23 is a fragmentary cross-sectional and schematic view illustrating the covering of the pipeline of FIG. 21 with earthen material.

FIG. 24 is a fragmentary cross-sectional and schematic view illustrating the covering of the pipeline of FIG. 22 with earthen material.

FIG. 25a is an illustration of a pipe section.

FIG. 25b is a cross-sectional view of the pipe section of FIG. 25a.

FIG. 26 is a cross-sectional view of a radially expanded and plastically deformed pipe section positioned within a pipe section.

FIG. 27a is an illustration of a pipe section.

FIG. 27b is a cross-sectional view of the pipe section of FIG. 27a.

FIG. 28 is a fragmentary cross-sectional and schematic view illustrating an expansion device.

FIG. 29 is a fragmentary cross-sectional and schematic view illustrating an expansion device.

FIG. 30 is a fragmentary cross-sectional and schematic view illustrating an expansion device.

FIG. 31 is a fragmentary cross-sectional and schematic view illustrating an expansion device.

FIG. 32 is a fragmentary cross-sectional and schematic view illustrating an expansion device.

FIG. 33 is a fragmentary cross-sectional and schematic view illustrating an expansion device.

FIG. 34 is a fragmentary cross-sectional and schematic view illustrating an expansion device.

FIG. 35 is a fragmentary cross-sectional and schematic view illustrating an expansion device.

FIGS. 36a and 36b are fragmentary cross-sectional and schematic view illustrating the operation of an expansion device.

FIGS. 37a and 37b are fragmentary cross-sectional and schematic view illustrating the operation of an expansion device.

FIG. 38 is a fragmentary cross-sectional and schematic view illustrating an actuator.

FIG. 39 is a fragmentary cross-sectional and schematic view illustrating an actuator.

FIGS. 40, 40a, 40b, and 40c are fragmentary cross-sectional and schematic views of methods of reducing contact friction between the pipe sections and the pipeline.

FIG. 41 is a fragmentary view of bending one or more pipe sections.

FIGS. 42a and 42b are fragmentary cross-sectional and schematic views of a smart pig.

FIGS. 43a, 43b, 43c and 43d are fragmentary cross-sectional and schematic views of the operation of an expansion device.

FIG. 44 is a cross-sectional view of a pipe section.

FIGS. 45a, 45b, 45c and 45d are fragmentary cross-sectional and schematic views of the operation of a hydroforming expansion device.

FIGS. 46a and 46b are fragmentary cross-sectional and schematic views of the operation of an explosive expansion device.

FIG. 47 is a fragmentary cross-sectional and schematic views of a pipe section that provides an indication of the near completion of the radial expansion and plastic deformation of the pipe sections.

FIG. 48 is a fragmentary cross-sectional and schematic views of a system for inserting pipe sections into the pipeline using fluid pressure.

FIG. 49 is a fragmentary cross-sectional and schematic views of a system for inserting pipe sections into the pipeline using a tractor.

FIG. 50 is a fragmentary cross-sectional view of a multi-layered pipeline repair liner.

FIG. 51 is a fragmentary cross-sectional and schematic view of a system for inserting seamless pipe into the pipeline.

FIG. 52 is a fragmentary cross-sectional and schematic view of a system for heating the pipeline.

FIG. 53 is a fragmentary cross-sectional and schematic view of a system for radially expanding and plastically deforming both ends of the pipe sections.

FIG. 54 is a fragmentary cross-sectional and schematic views of a relative geometry of the radially expanded and plastically deformed pipe section and another section of a pipeline.

FIG. 55 is an illustration of an exemplary embodiment of a computer model used to generate exemplary experimental results.

FIG. 56 is a graphical illustration of exemplary experimental results generated using the computer model of FIG. 55.

FIG. 57 is a graphical illustration of exemplary experimental results generated using the computer model of FIG. 55.

FIG. 58a is an illustration of an exemplary embodiment of a computer model used to generate exemplary experimental results.

FIG. 58b is an illustration of an exemplary embodiment of a computer model used to generate exemplary experimental results.

FIG. 58c is an illustration of an exemplary embodiment of a computer model used to generate exemplary experimental results.

FIGS. 59a, 59b, and 59c are illustrations of an exemplary embodiment of the repeated radial expansion and plastic deformation of a pipe section within a pipeline.

FIGS. 60a and 60b are illustrations of an exemplary embodiment of the radial expansion and plastic deformation of a pipe section and a surrounding pipeline.

FIG. 61 is an illustration of an exemplary embodiment of the radial expansion and plastic deformation of a pipe section including an outer coating material.

FIG. 62 is an illustration of several exemplary embodiments of tubular assemblies each including tubular members coupled end to end by welded connections.

### DETAILED DESCRIPTION OF THE ILLUSTRATIVE EMBODIMENTS

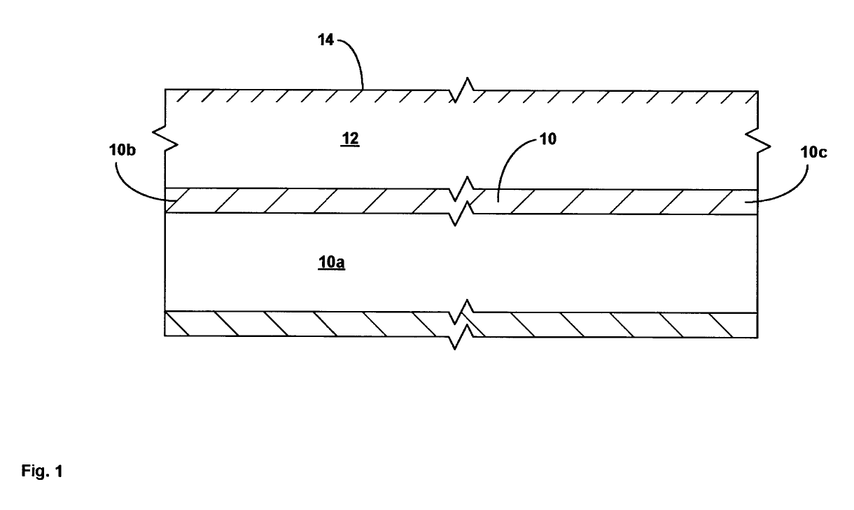

Referring to FIG. 1, a pipeline 10 that defines a passageway 10a traverses a subterranean formation 12. The pipeline 10 further includes a first end 10b and a second end 10c that is separated from the first end. In an exemplary embodiment, the pipeline 10 is positioned below the surface 14 of the Earth. In an exemplary embodiment, the pipeline 10 may include one or more defects that may necessitate repair of the pipeline by, for example, lining the interior of the pipeline with a tubular member.

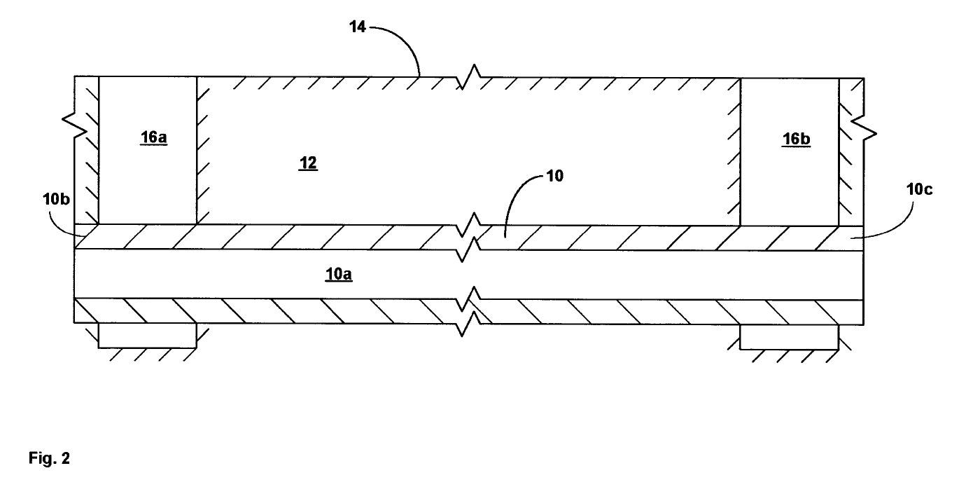

Referring to FIG. 2, in an exemplary embodiment, in order to facilitate the repair of the pipeline 10, the first and second ends, 10b and 10c, respectively, of the pipeline may be exposed by removing earthen material proximate the first and second ends. As a result, trenches, 16a and 16b, are provided proximate the first and second ends, 10b and 10c, respectively, of the pipeline 10. As a result, the first and second ends, 10b and 10c, respectively, of the pipeline 10 may be accessed from the surface 14.

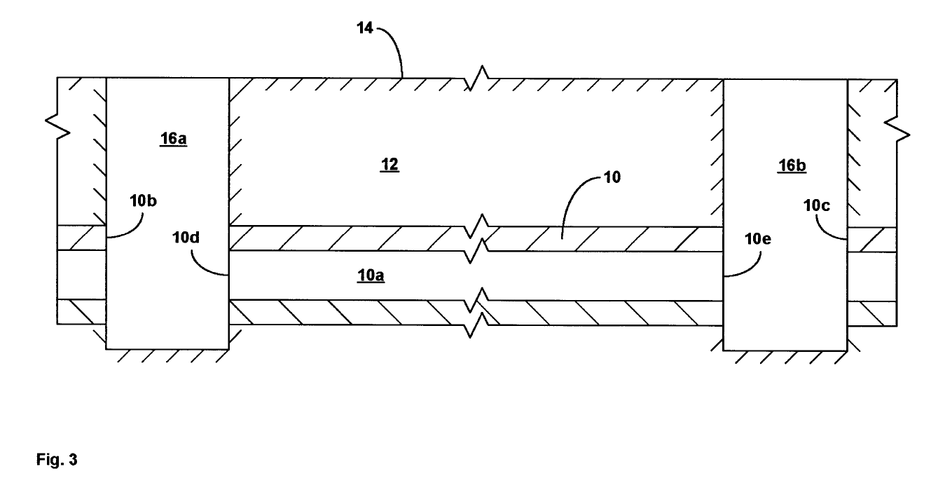

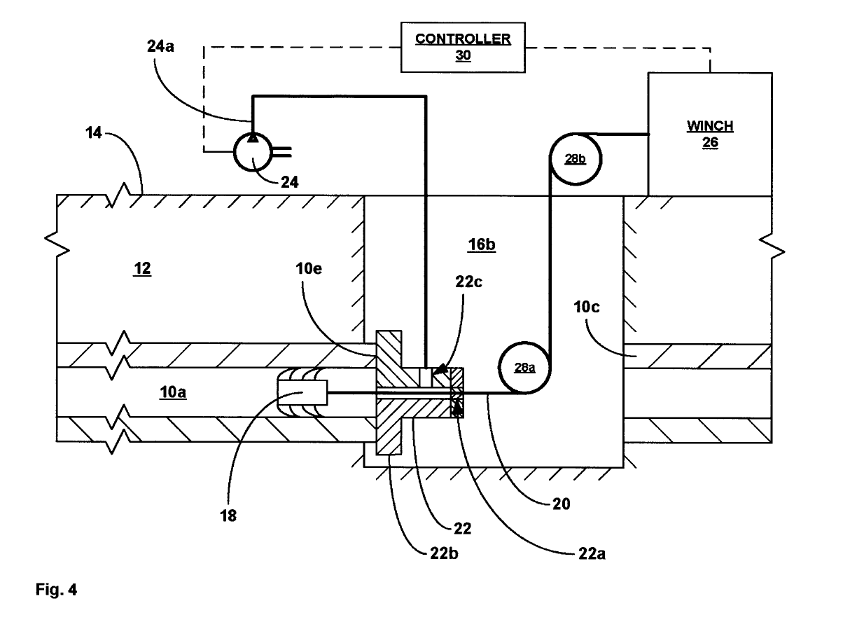

Referring to FIG. 3, in an exemplary embodiment, portions of the first and second ends, 10b and 10c, respectively, of the pipeline 10 may then be removed by, for example, machining away the portions in a convention manner. As a result, the interior passageway 10a of the pipeline 10 may be accessed through the resulting open ends, 10d and 10e, of the first and second ends, 10b and 10c, respectively, of the pipeline.

Referring to FIG. 4, in an exemplary embodiment, a conventional pig 18 may then be positioned within the passageway 10a of the pipeline 10 through the open end 10e of the pipeline. As will be recognized by persons having ordinary skill in the art, pigs are commonly inserted into and then pumped through pipelines to perform task such as, for example, cleaning the interior of the pipelines. In an exemplary embodiment, the pig 18 sealingly engages the interior surface of the passageway 10a of the pipeline. An end of a tow line 20 may then be coupled to an end of the pig 18 by passing the end of the tow line through a passageway 22a defined in an end plate 22. In an exemplary embodiment, a portion of the interior surface of the passageway 22a of the end plate 22 sealingly engages the tow line 20. In an exemplary embodiment, the end plate 22 further includes an exterior flange 22b and a transverse passageway 22c that is operably coupled to the passageway 22a. In an exemplary embodiment, after coupling the end of the tow line 20 to the end of the pig 18, the exterior flange 22b of the end plate 22 is coupled to the open end 10e of pipeline 10, and an outlet 24a of a conventional pump 24 is operably coupled to the passageway 22c of the end plate in a conventional manner. The other end of the tow line 20 may then be operably coupled to a conventional winch 26 in a conventional manner using, for example, one or more pulleys, 28a and 28b. The pump 24 and winch 26 may be operably coupled to a conventional programmable controller 30.

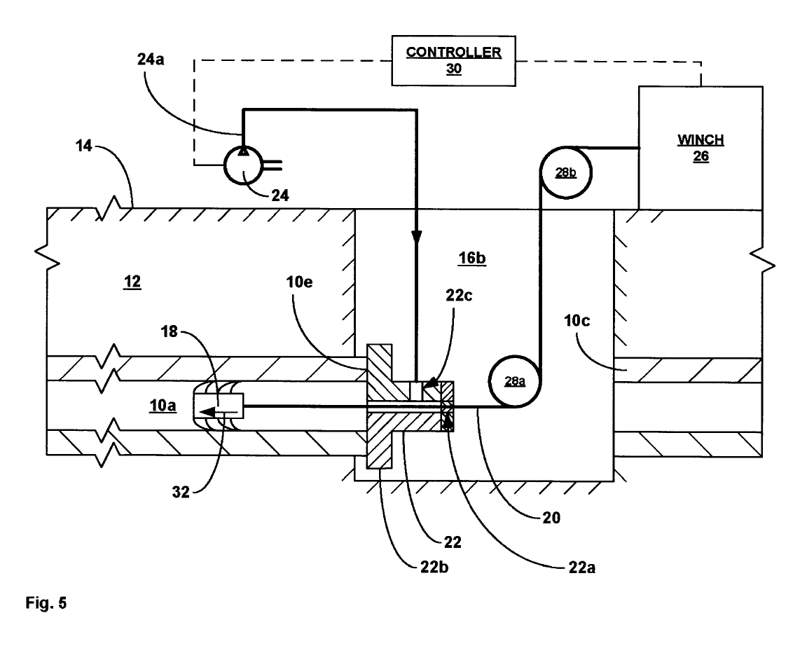

Referring to FIG. 5, in an exemplary embodiment, the controller 30 may then operate the pump 24 such that fluidic materials are discharged out of the outlet 24a of the pump and injected into the passageway 22c of the end plate 22 while the winch 26 is operated by the controller to permit movement of the tow line 20. As a result, the passageway 22a of the end plate and the interior of the passageway 10a of the pipeline on one side of the pig 18 are pressurized. As a result, the pig 18, and the end of the tow line 20 that is coupled to the end of the pig, may be displaced in a direction 32 away from the open end 10e of the pipeline and towards the open end 10d of the pipeline.

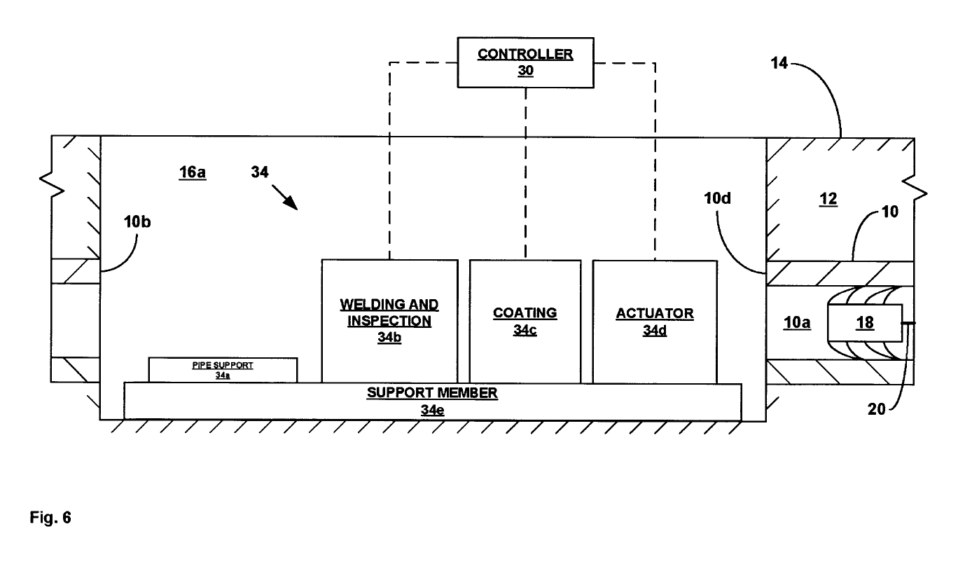

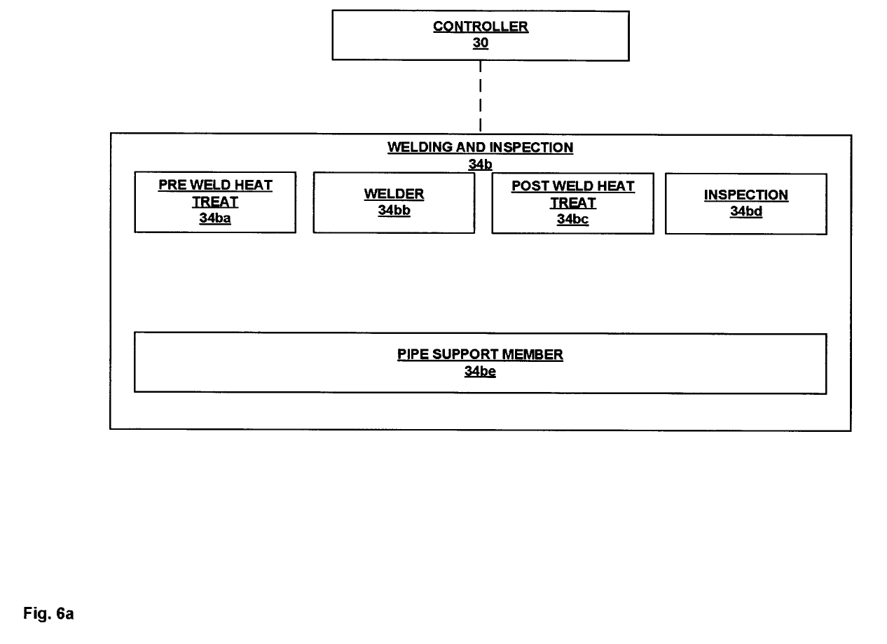

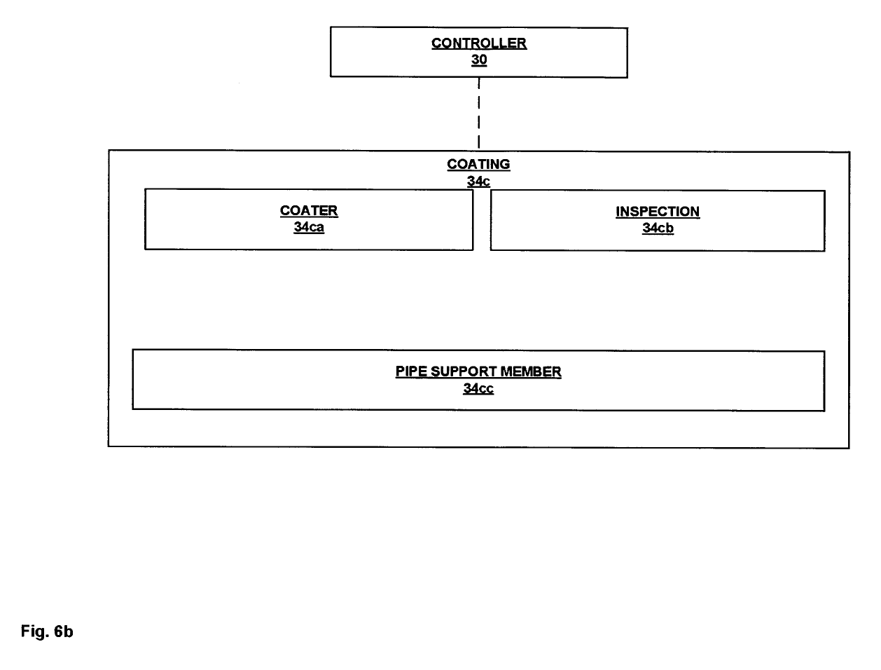

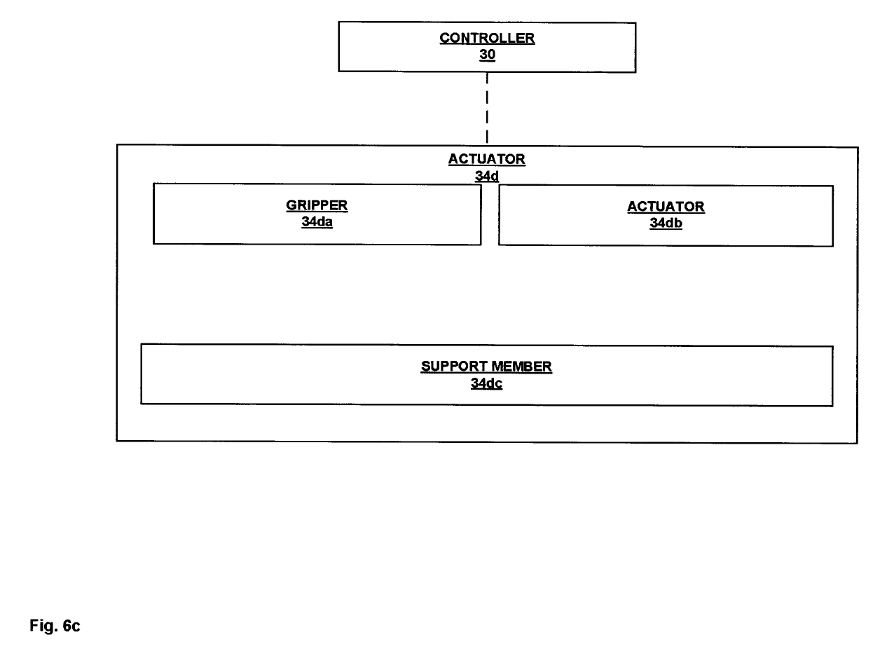

Referring to FIG. 6, in an exemplary embodiment, after displacing the pig 18, and the end of the tow line 20 that is coupled to the end of the pig, to a position within the passageway 10a of the pipeline 10 proximate the open end 10d, the end plate 22 may be removed and a pipe section processing apparatus 34 may be placed within the trench 16a proximate the open end of the pipeline. In an exemplary embodiment, the apparatus 34 includes a conventional pipe section support 34a, a welding and inspection assembly 34b, a coating assembly 34c, and an actuator 34d that are each coupled to a support member 34e and the controller 30.

Referring to FIG. 6a, in an exemplary embodiment, the welding and inspection assembly 34b includes a conventional pre-welding heat treatment device 34ba, a conventional pipe section welder device 34bb, a conventional post-welding heat treatment device 34bc, a conventional weld inspection device 34bd, and a conventional pipe section support member 34be. In an exemplary embodiment, the conventional pre-welding heat treatment device 34ba is adapted to provide heat treatment of a pipe section in a conventional manner and, may, for example, include one or more conventional devices for heat treating metallic pipe sections. In an exemplary embodiment, the conventional pipe section welder device 34bb is adapted to weld together end portions of metallic pipe sections and may, for example, include one or more conventional devices for welding together end portions of metallic pipe sections. In an exemplary embodiment, the pipe section welder device 34bb may include one or more aspects of conventional friction stir welding. In an exemplary embodiment, the conventional post-welding heat treatment device 34bc is adapted to provide heat treatment of welded together pipe sections in a conventional manner and, may, for example, include one or more conventional devices for heat treating welded together metallic pipe sections. In an exemplary embodiment, the conventional weld inspection device 34bd is adapted to inspect welded together metallic pipe sections and, may, for example, include one or more conventional devices for inspecting welded together metallic pipe sections such as x-ray, ultrasonic, and other non-destructive inspection devices. In an exemplary embodiment, the conventional pipe support member 34be is adapted to convey and support metallic pipe sections as they are processed by the pre-welding heat treatment device 34ba, pipe section welder device 34bb, post-welding heat treatment device 34bc, and weld inspection device 34bd. In an exemplary embodiment, the welding and inspection assembly 34b may include one or more elements of one or more of the conventional commercially available welding devices commercially available from TubeFuse.

In an exemplary embodiment, one or more elements of conventional coupling methods that do not include welding may be used in addition to, or instead of, the conventional weld inspection device 34bd in the welding and inspection assembly 34b.

Referring to FIG. 6b, in an exemplary embodiment, the coating assembly 34c includes a conventional pipe section coating device 34ca, a conventional pipe section coating inspection device 34cb, and a conventional pipe section support member 34cc. In an exemplary embodiment, the conventional pipe section coating device 34ca is adapted to apply a coating material to the exterior surface of a pipe section in a conventional manner and, may, for example, include one or more conventional devices for applying a coating material to pipe sections. In an exemplary embodiment, the conventional pipe section coating inspection device 34cb is adapted to inspect coated pipe sections and, may, for example, include one or more conventional devices for inspecting coated pipe sections. In an exemplary embodiment, the conventional pipe support member 34cc is adapted to convey and support metallic pipe sections as they are processed by the pipe section coating device 34ca and the conventional pipe section coating inspection device 34cb.

Referring to FIG. 6c, in an exemplary embodiment, the actuator assembly 34d includes a conventional pipe section gripper device 34da, a conventional pipe section actuator device 34db, and a conventional pipe section support member 34dc. In an exemplary embodiment, the conventional pipe section gripper device 34da is adapted to grip pipe sections in a conventional manner and, may, for example, include one or more conventional devices for gripping pipe sections. In an exemplary embodiment, the conventional pipe section actuator device 34db is adapted to displace pipe sections in a longitudinal direction out of an end of the actuator assembly 34d and, may, for example, include one or more conventional devices for displacing pipe sections in a longitudinal direction. In an exemplary embodiment, the conventional pipe support member 34dc is adapted to convey and support metallic pipe sections as they are processed by the pipe section gripper device 34da and a conventional pipe section actuator device 34db.

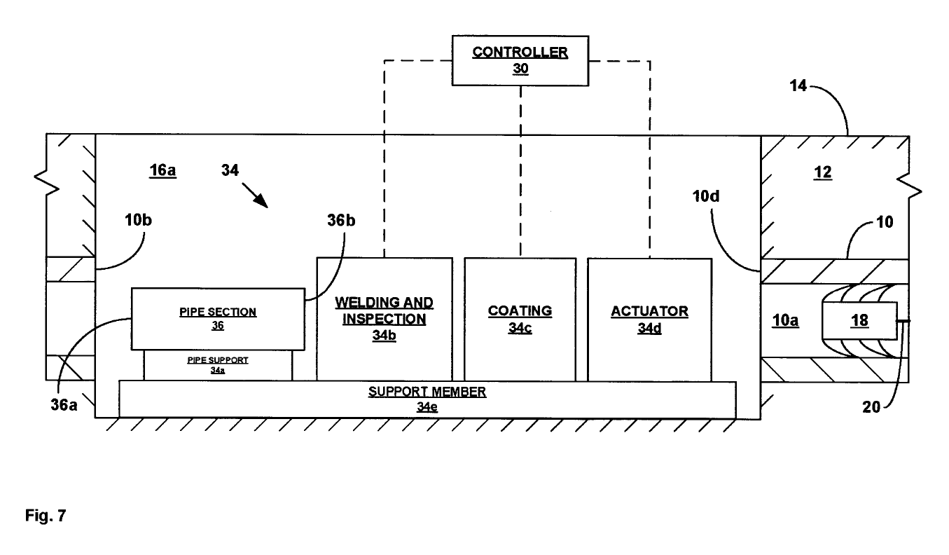

Referring to FIG. 7, in an exemplary embodiment, a pipe section 36 may then be positioned on the pipe section support 34a of the apparatus 34. In an exemplary embodiment, each pipe section 36 includes a first end 36a and a second end 36b and is fabricated from a metallic material.

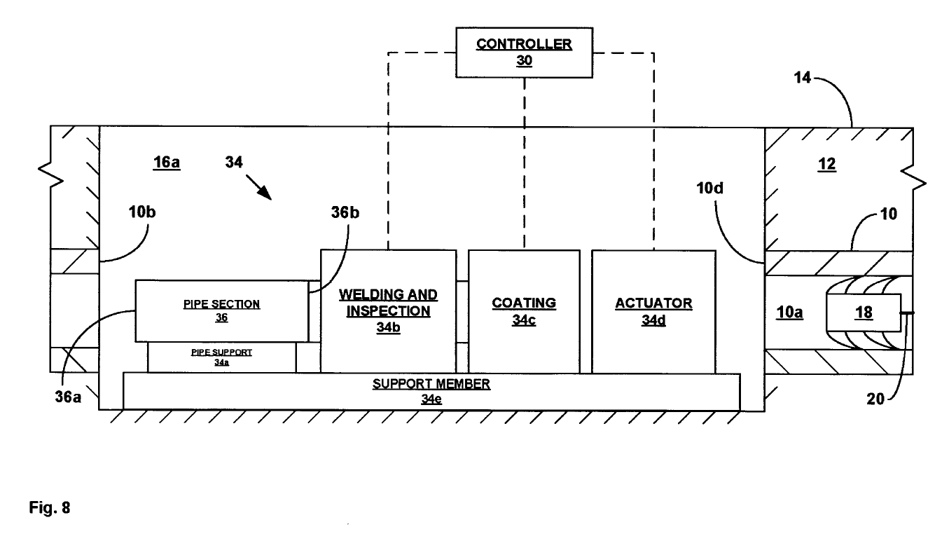

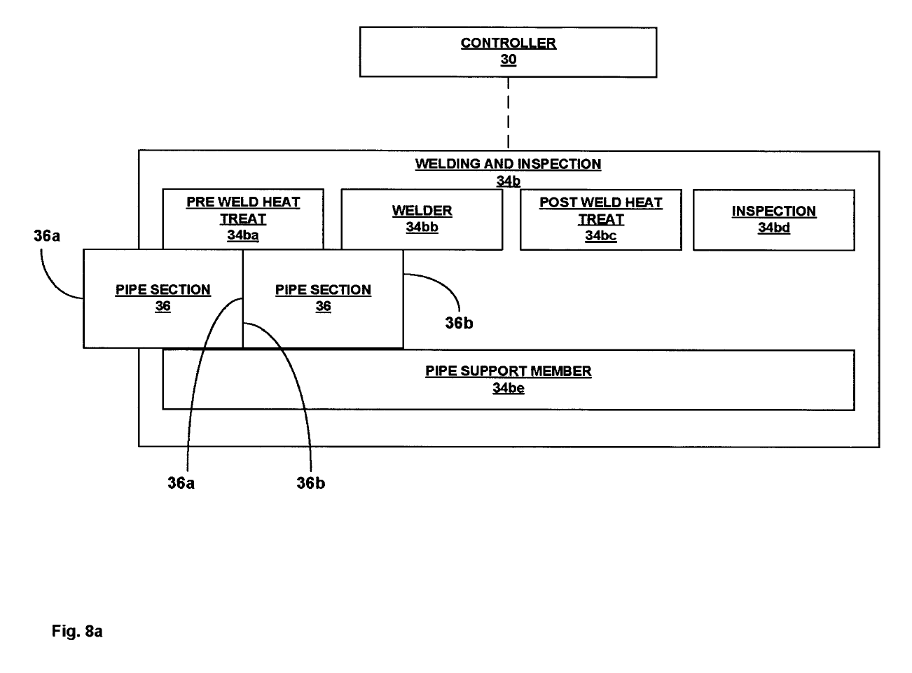

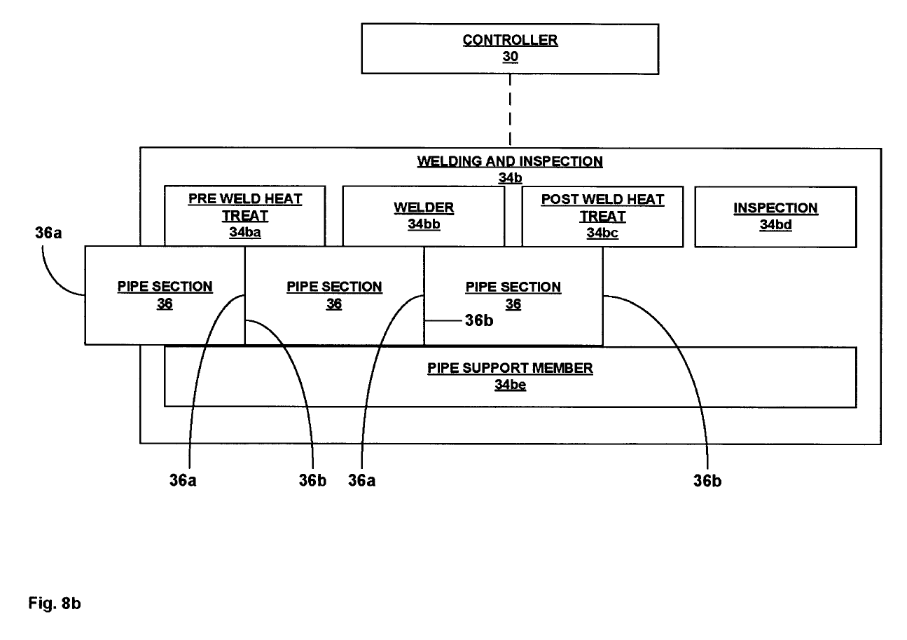

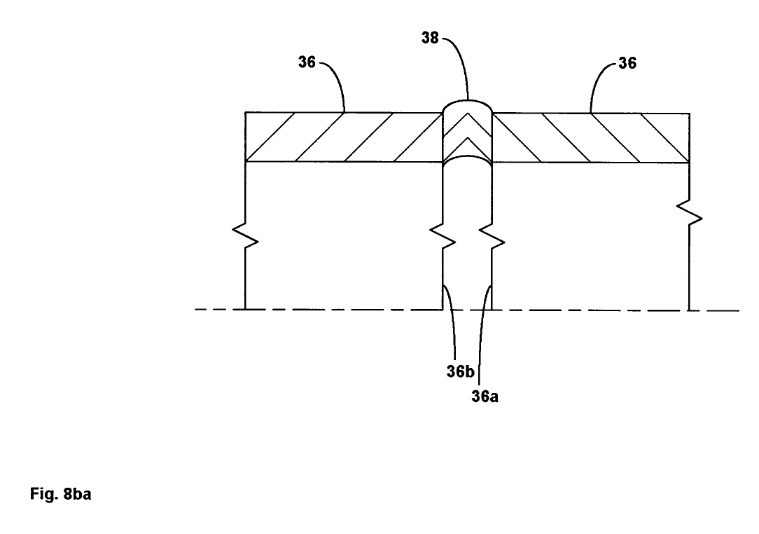

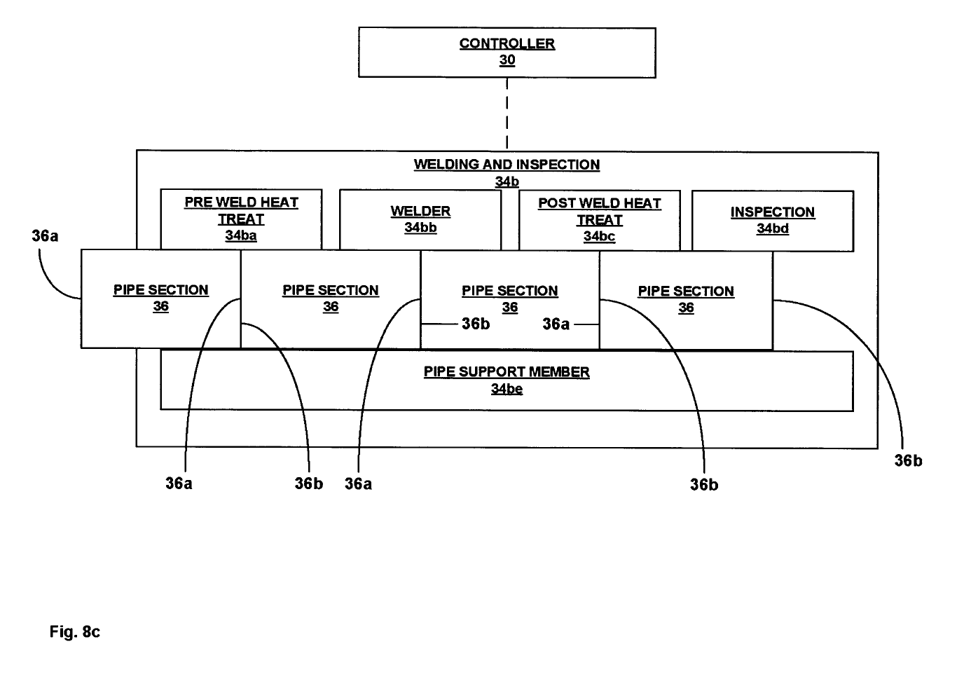

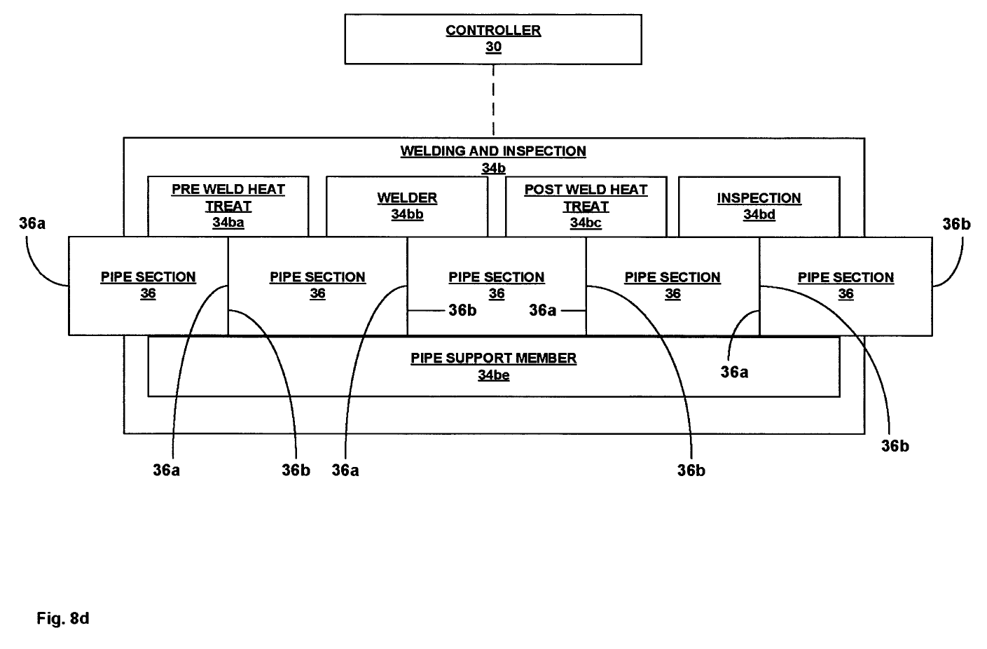

Referring to FIGS. 8 and 8a, 8b, 8ba, 8c, and 8d, in an exemplary embodiment, the initial pipe section 36 may then be moved into the welding and inspection assembly 34b and additional pipe sections 36 may then be sequentially positioned onto the pipe section support 34a of the apparatus 34 and also sequentially moved into the welding and inspection assembly. In this manner, the pipe sections 36 may then be processed by the welding and inspection assembly 34b.

As illustrated in FIG. 8a, in an exemplary embodiment, within the welding and inspection assembly 34b, the first and second ends, 36a and 36b, of the pipe sections 36 may be initially heat treated in a conventional manner by the pre-welding heat treatment device 34ba in order to provide enhanced material properties within the first and second ends of the pipe sections prior to welding the first and second ends of adjacent pipe sections to one another in the pipe section welder device 34bb.

As illustrated in FIG. 8b, in an exemplary embodiment, within the welding and inspection assembly 34b, once adjacent pipe sections 36 are positioned within the pipe section welder device 34bb, the first and second ends, 36a and 36b, of the adjacent pipe sections are welded to one another in a conventional manner. In an exemplary embodiment, as illustrated in FIG. 8ba, as a result of the welding operation, the entire circumference of the first and second ends, 36a and 36b, of the adjacent pipe sections are welded to one another forming a continuous circumferential weld 38.

As illustrated in FIG. 8c, in an exemplary embodiment, within the welding and inspection assembly 34b, after the first and second ends, 36a and 36b, of the adjacent pipe sections are welded to one another in the pipe section welder device 34bb, the first and second ends of the welded together adjacent pipe sections, including the weld 38, are then heat treated in the post-welding heat treatment device 34bc in order to provide enhanced material properties within the first and second ends of the pipe sections, including the weld 38, after welding the first and second ends of adjacent pipe sections to one another in the pipe section welder device 34bb.

As illustrated in FIG. 8d, in an exemplary embodiment, within the welding and inspection assembly 34b, after the first and second ends, 36a and 36b, of the adjacent pipe sections are heat treated in the post-welding heat treatment device 34bc, the first and second ends of the pipe sections, including the weld 38, are inspected in the weld inspection device 34bd.

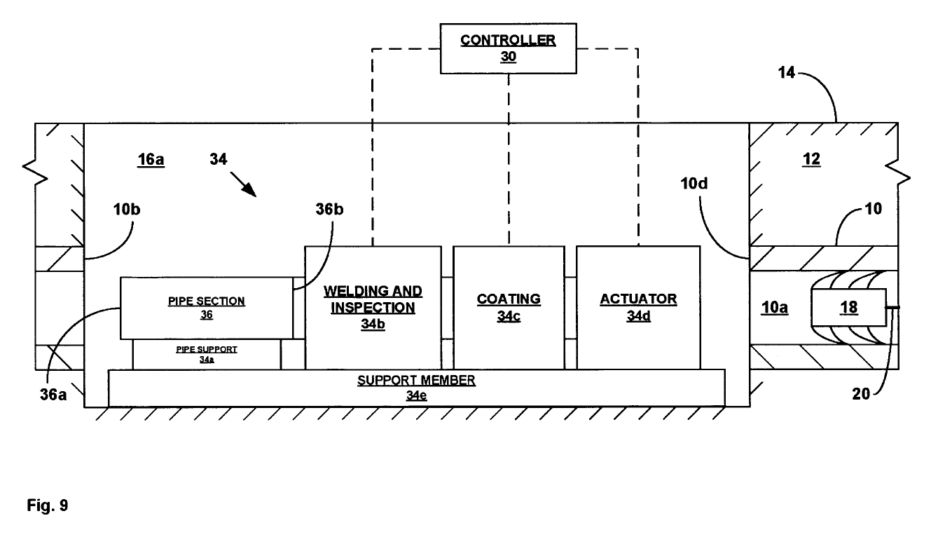

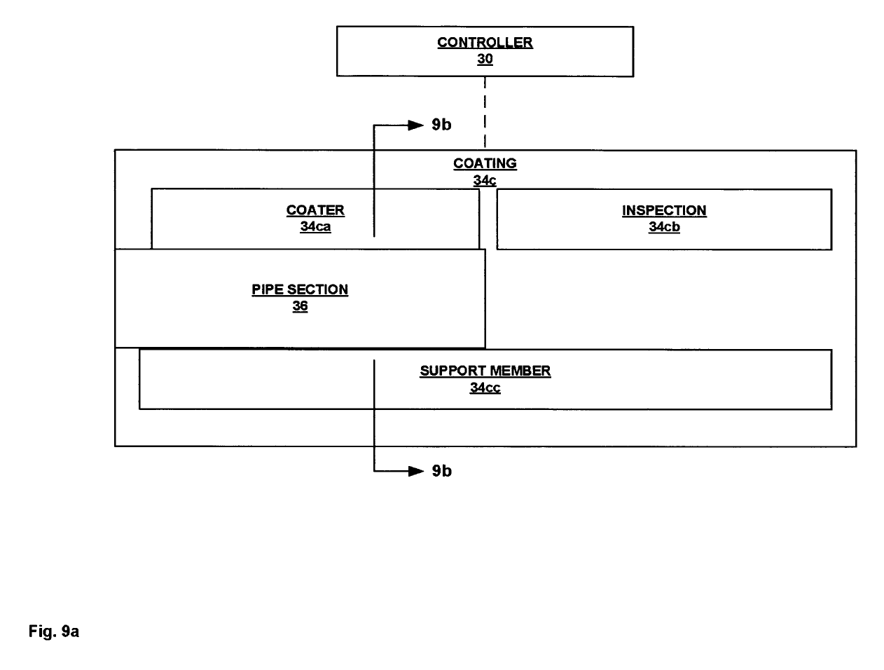

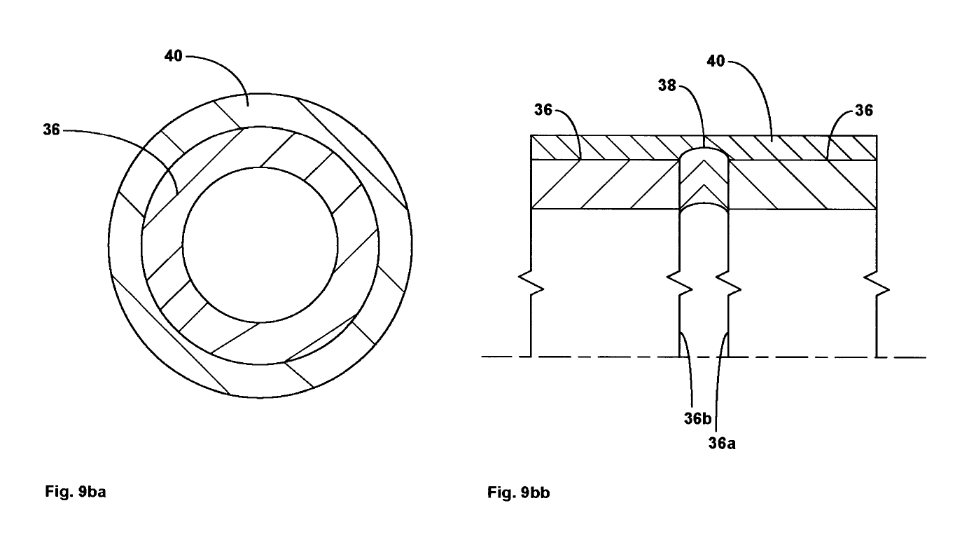

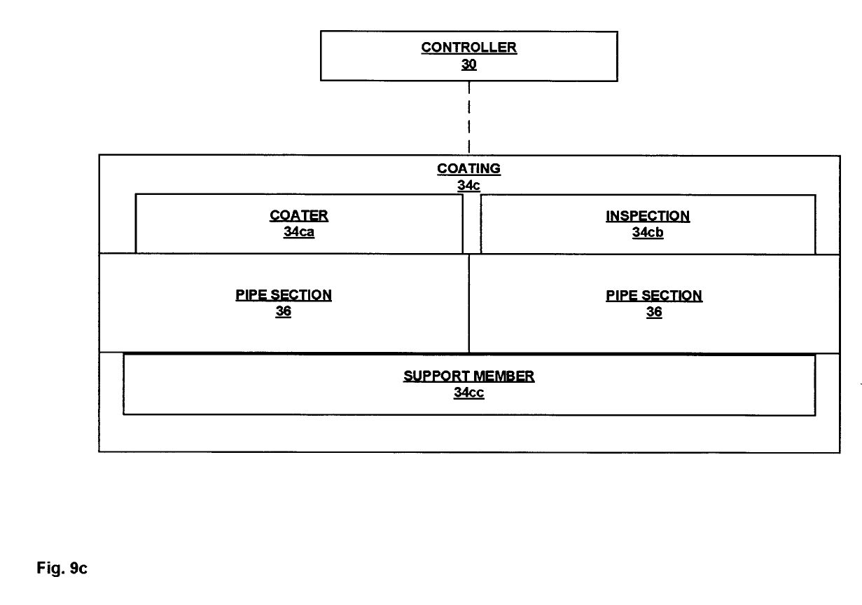

Referring to FIGS. 9, 9a, 9ba, 9bb and 9c, in an exemplary embodiment, further additional pipe sections 36 may then be sequentially positioned onto the pipe section support 34a of the apparatus 34 as pipe sections processed by the welding and inspection assembly 34b are then processed by the coating assembly 34c. In this manner, the pipe sections 36 may then be sequentially processed by the welding and inspection assembly 34b and the coating assembly 34c.

As illustrated in FIGS. 9a, 9ba and 9bb, in an exemplary embodiment, within the coating assembly 34c, the exterior surfaces of pipe sections 36 and welds 38 are coated with an exterior coating layer 40 by the coating device 34ca. In an exemplary embodiment, the layer 40 is adapted to protect the exterior surfaces of the pipe sections 36 and welds 38 and reduce contact friction between the pipe sections and welds and the interior surface of the pipeline 10.

In an exemplary embodiment, the layer 40 comprises a conventional abradable coating material that may provide, for example, corrosion protection and/or wear resistance.

In an exemplary embodiment, the layer 40 comprises a plurality of layers of an abradable and/or lubricating coating material.

In an exemplary embodiment, the layer 40 comprises a conventional self-healing layer of material such that any damage to the layer caused by, for example, abrasion or scratches, is automatically healed.

In an exemplary embodiment, the layer 40 is a conventional environmentally friendly layer.

As illustrated in FIG. 9c, in an exemplary embodiment, within the coating assembly 34c, after the pipe section 36 and welds 38 are coated with the layer 40 in the coating device 34ca, the layer is inspected in the coating inspection device 34cb.

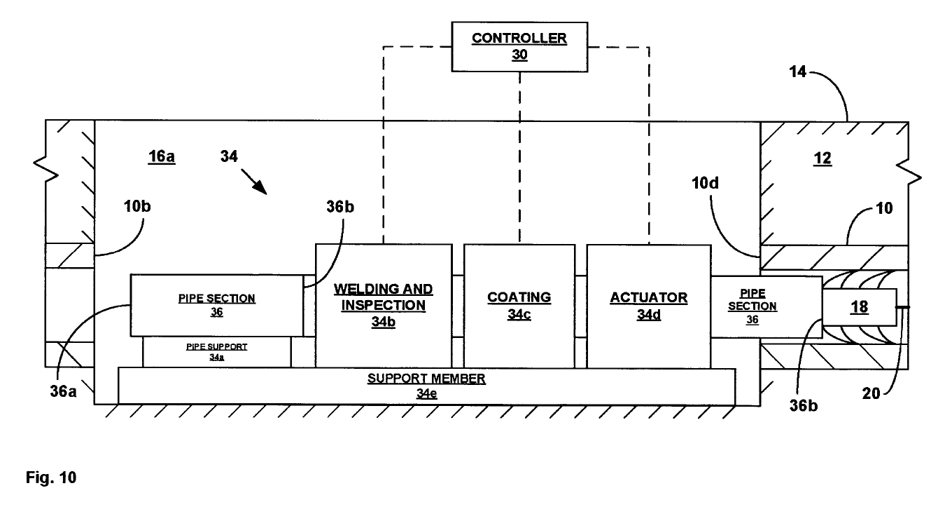

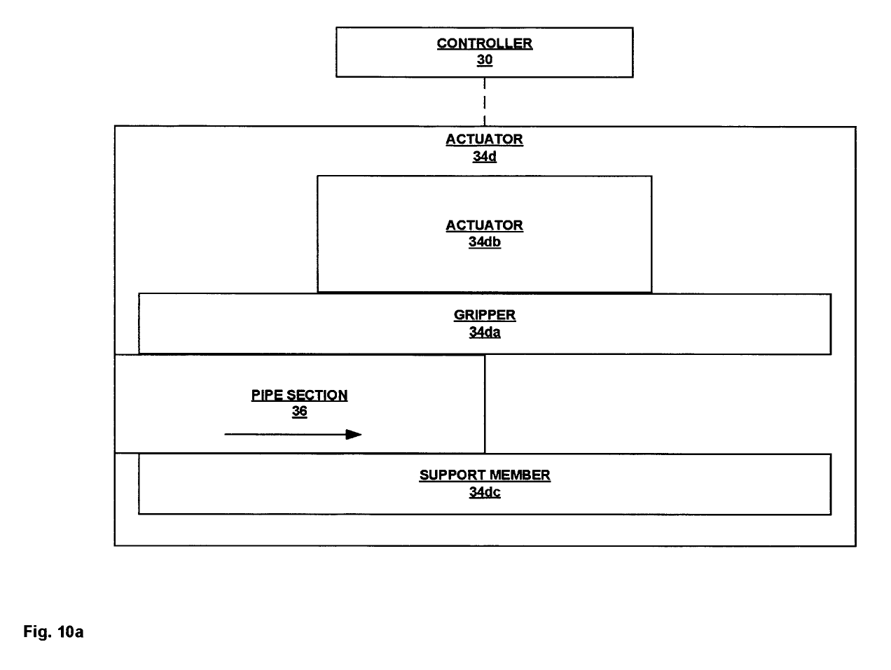

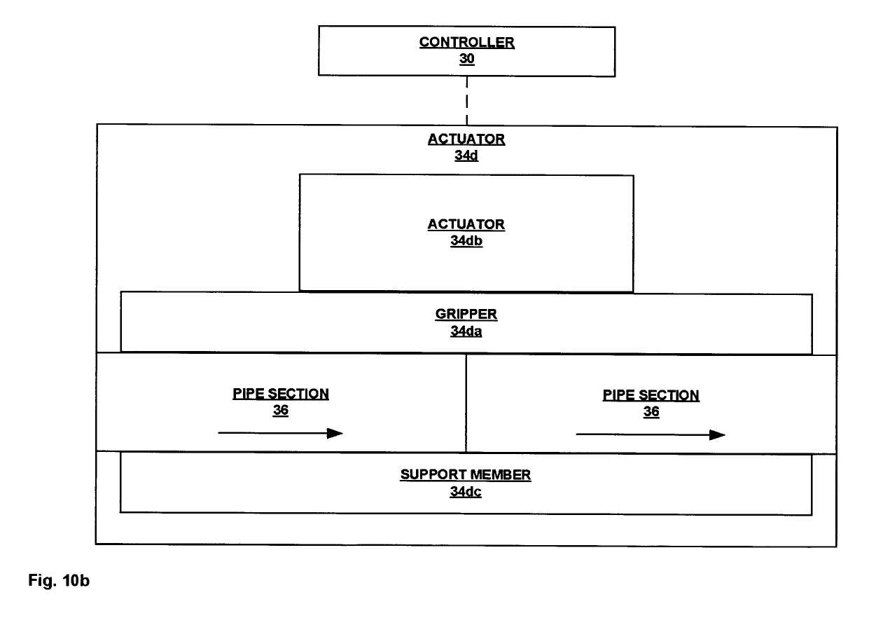

Referring to FIGS. 10, 10a, and 10b, in an exemplary embodiment, further additional pipe sections 36 may then be sequentially positioned onto the pipe section support 34a of the apparatus 34 as pipe sections processed by the welding and inspection assembly 34b and the coating assembly 34c are then processed by the actuator assembly 34d. In this manner, the pipe sections 36 may then be sequentially processed by the welding and inspection assembly 34b, the coating assembly 34c, and the actuator assembly 34d.

As illustrated in FIGS. 10a and 10b, in an exemplary embodiment, within the actuator assembly 34d, the gripper 34da grips the pipe sections 36 and then the actuator 34db displaces the pipe sections 36 in a longitudinal direction out of the actuator 34d. Thus, the actuator assembly 34d also pulls the welded together pipe sections 36 through the end of the welding and inspection assembly 34b and the coating assembly 34c and thereby controls the rate at which pipe sections 36 and welds 38 are processed.

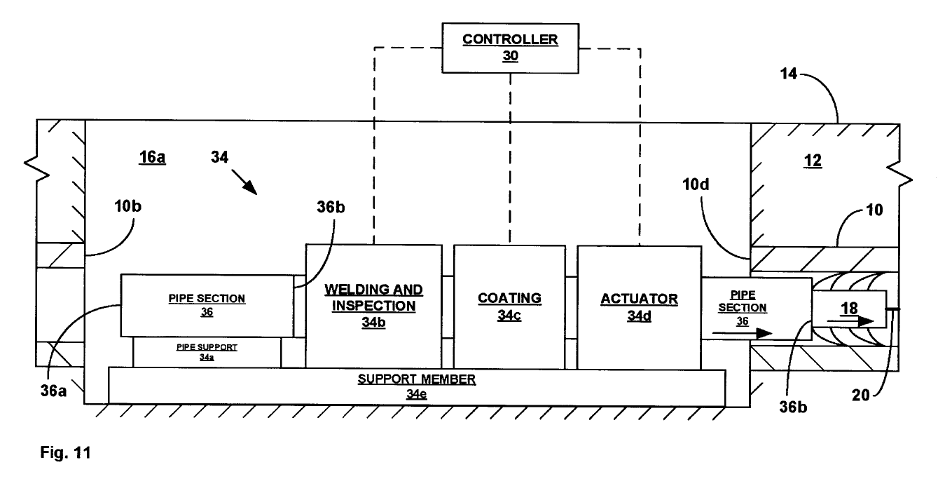

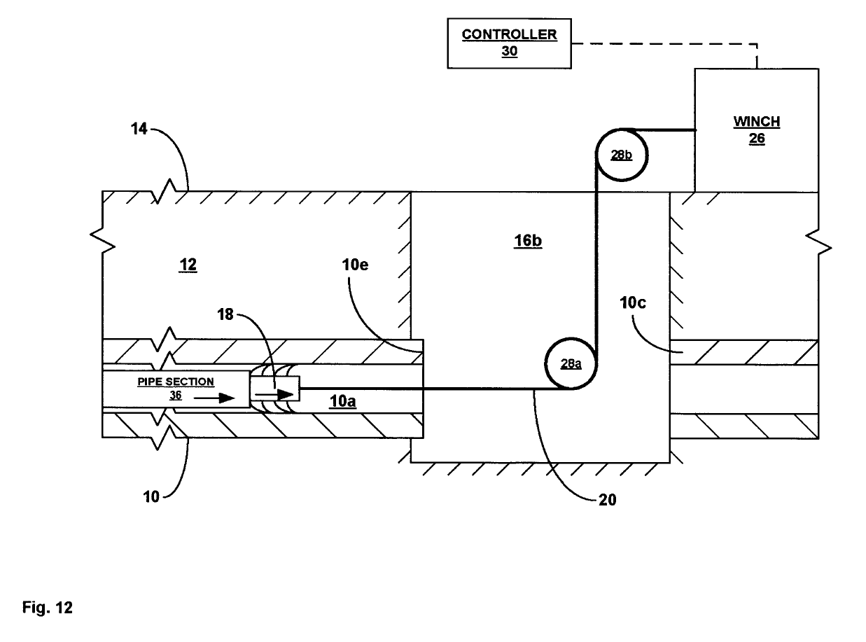

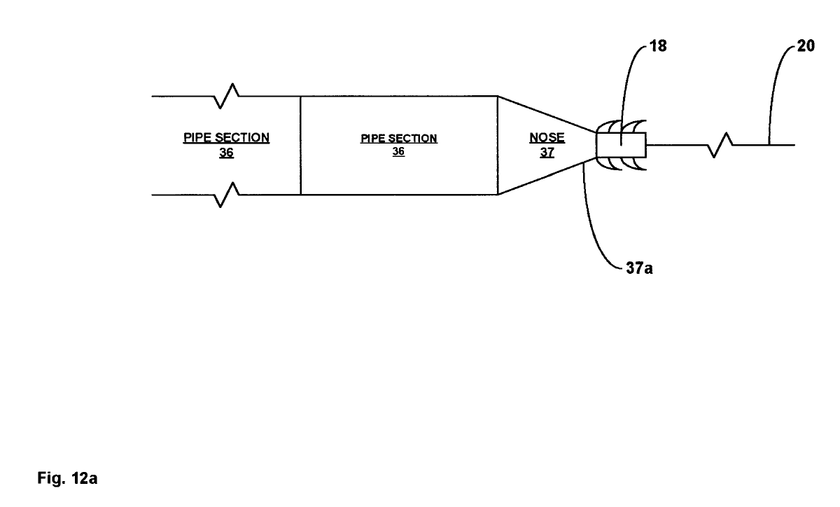

Referring to FIGS. 11 and 12, in an exemplary embodiment, the continued operation of the actuator assembly 34d pushes the welded together pipe sections 36 into and through the passageway 10a of the pipeline 10 until an end 36b of a pipe section 36 engages and couples to an end of the pig 18. Continued operation of the actuator assembly 34d then continues to push the welded together pipe sections 36 into and through the passageway 10a. In an exemplary embodiment, in combination with the operation of the actuator assembly 34d, the winch 26 is operated to pull the pig 18 through the passageway 10a of the pipeline 10. As a result of the operation of the winch 26, the welded together pipe sections 36 are pulled through the passageway 10a of the pipeline 10. Thus, in an exemplary embodiment, by operation of the actuator assembly 34d and the winch 26, the welded together pipe sections 36 are pushed and pulled through the passageway 10a of the pipeline 10.

In an exemplary embodiment, as illustrated in FIG. 12a, the pipe section 36 that is coupled to the pig 18 includes a nose 37 having a first end that is coupled to an end of the pipe section and another tapered end 37a that is coupled to the pig. In an exemplary embodiment, the tapered end 37a of the nose 37 includes a lubricant supply for lubricating the annular space between nose 37 and/or the pipe sections 36 and the pipeline 10. In an exemplary embodiment, during operation, the nose 37 reinforces the structure of one or more of the pipe sections 36 and thereby substantially prevents one or more of the pipe sections 36 from being deformed to, for example, an oval outer profile.

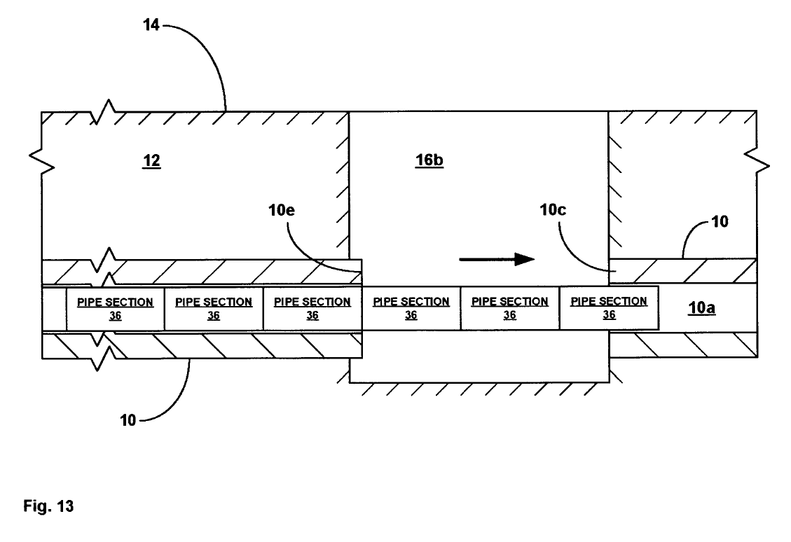

Referring to FIG. 13, in an exemplary embodiment, the continued operation of the actuator assembly 34d and the winch 26 displaces the pipe sections 36 out of the end 10e of the pipeline and into the trench 16b. In an exemplary embodiment, the pig 18 may then be decoupled from an end of one of the pipe sections 36 and removed from the trench 16b. Subsequent continued operation of the actuator assembly 34d may then displace at least a portion of the pipe sections 36 into an open end of the second end 10c of the pipeline 10.

In an exemplary embodiment, the insertion and placement of the pipe sections 36 within the pipeline may include one or more aspects of the conventional methods of sliplining and/or swagelining.

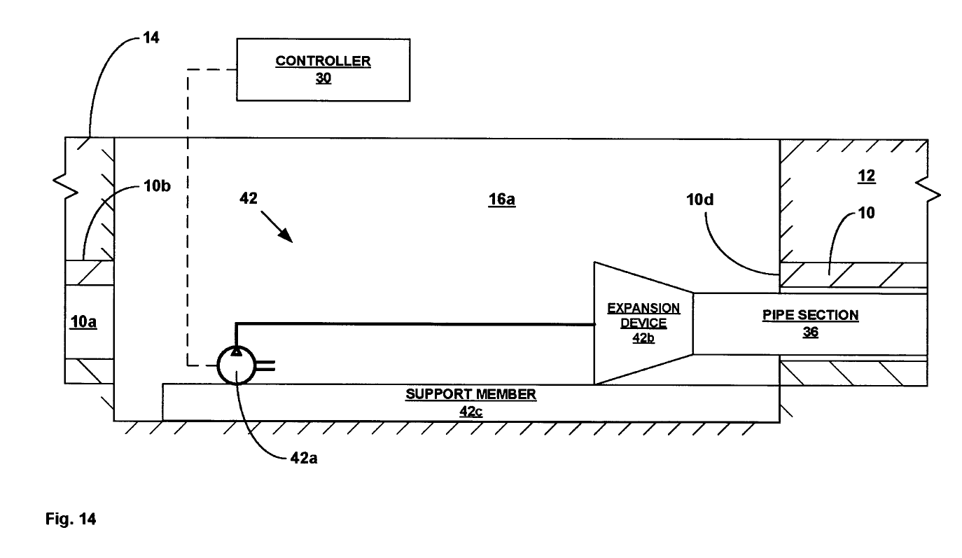

Referring to FIGS. 14 and 15, in an exemplary embodiment, after the pipe sections 36 have been positioned within the entirety of the length of the passageway 10a of the pipeline 10 between the trenches, 16a and 16b, the apparatus 34 may be removed from the trench 16a and an expansion system 42 may be positioned within the trench proximate the open end 10d of the pipeline. In an exemplary embodiment, the expansion system 42 includes a pump 42a that is operably coupled to an expansion device 42b and the controller 30. In an exemplary embodiment, the pump 42a and expansion device 42b are mounted upon a support member 42c.

In an exemplary embodiment, the expansion device 42b includes a tubular launcher 42ba that defines a chamber 42baa having a first tubular portion 42bab, a second tubular portion 42bac, and an intermediate tapered tubular portion 42bad. In an exemplary embodiment, an end of the first tubular portion 42bab of the tubular launcher 42ba of the expansion device 42b is coupled to an end plate 42bb that defines a passage 42bc and an end of the second tubular portion 42bac of the tubular launcher 42ba of the expansion device 42b is coupled to an end of one of the pipe sections 36. In an exemplary embodiment, each pipe section 36 defines a passageway 36c. In an exemplary embodiment, an outlet of the pump 42a is operably coupled to the passage 42bc of the end plate 42bb of the expansion device 42b. In an exemplary embodiment, an expansion cone 42bc that includes a tapered exterior surface 42bca is positioned within the chamber 42baa and mates with the interior surfaces of the tubular launcher 42ba. In an exemplary embodiment, the interface between the expansion cone 42bc and the interior surfaces of the tubular launcher 42ba is not fluid tight in order to facilitate lubrication of the interface.

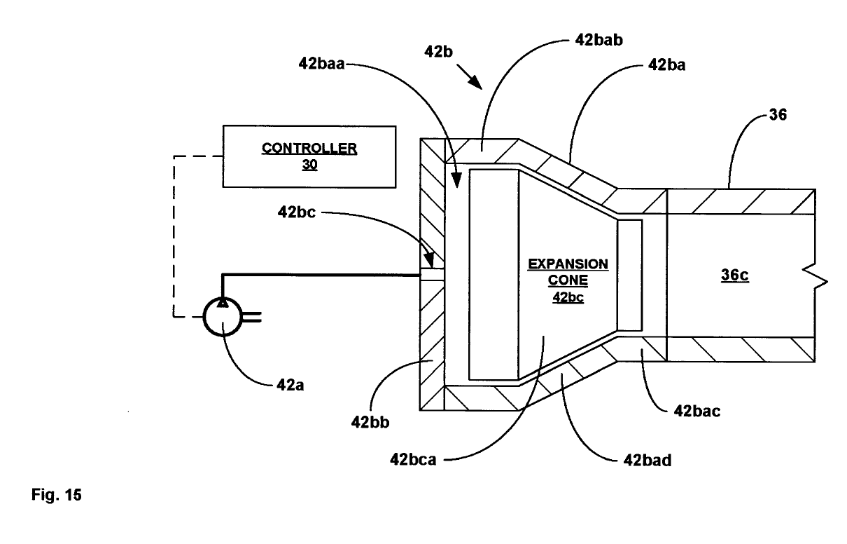

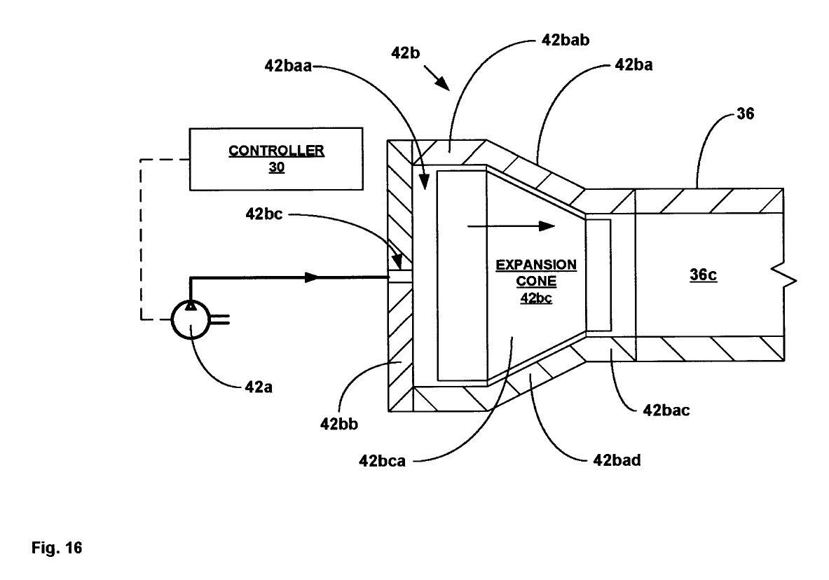

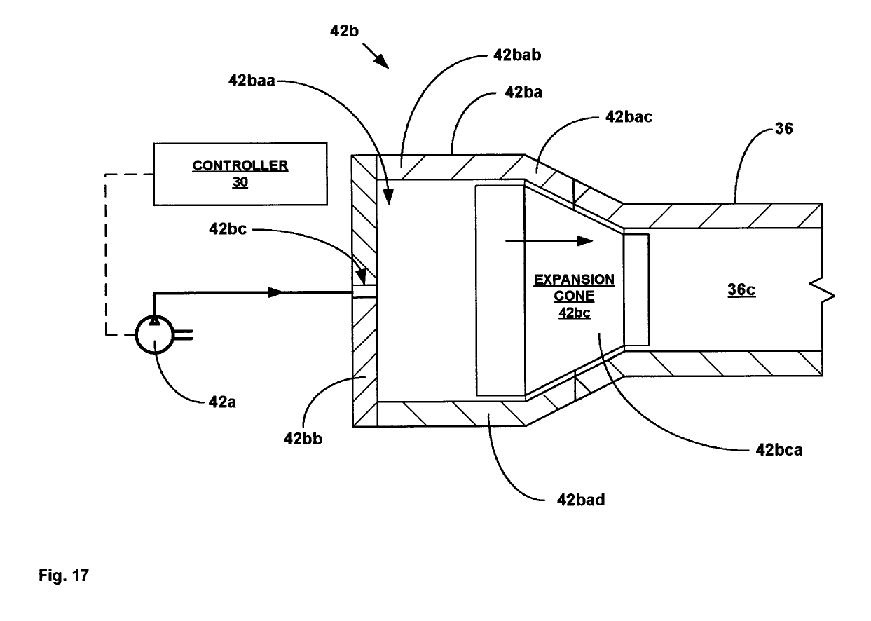

Referring to FIGS. 16 and 17, in an exemplary embodiment, the pump 42a may then be operated by the controller 30 to inject fluidic materials into the chamber 42baa of the tubular launcher 42ba of the expansion device 42b. As a result, the expansion cone 42bc may be displaced longitudinally relative to the end plate 42bb thereby causing the tapered external surface 42bca of the expansion cone to engage and thereby radially expand and plastically deform the tapered tubular portion 42bad and second tubular portion 42bac of the tubular launcher 42ba. In an exemplary embodiment, continued injection of the fluidic materials into the chamber 42baa will then further displace the expansion cone 42bc in a longitudinal direction thereby causing the expansion cone to radially expand and plastically deform one or more of the pipe sections 36.

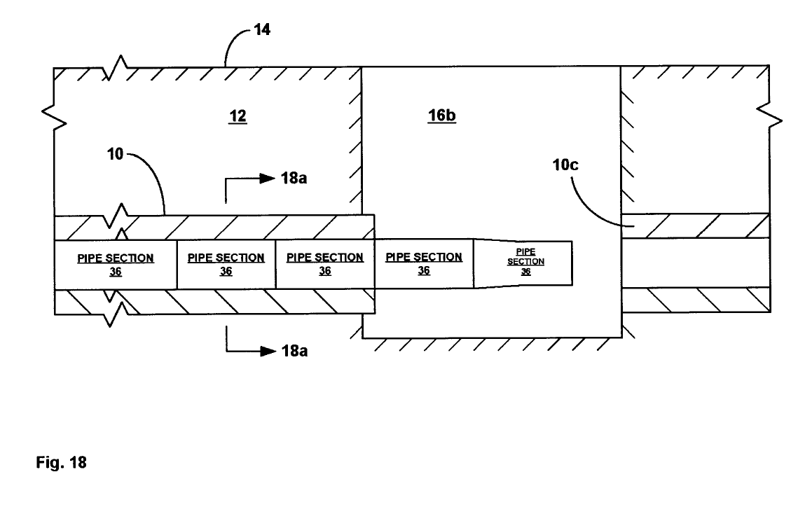

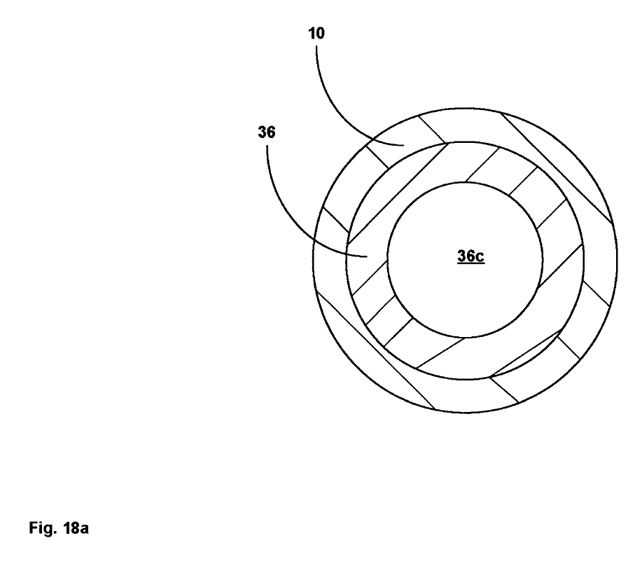

Referring to FIGS. 18 and 18a, in an exemplary embodiment, continued injection of the fluidic materials into the chamber 42baa will then further displace the expansion cone 42bc thereby causing the expansion cone to radially expand and plastically deform all of the pipe sections 36 positioned within the pipeline 10. In an exemplary embodiment, each pipe section 36 is expanded into contact with the surrounding portion of the pipeline 10. In an exemplary embodiment, at least a portion of the surrounding pipeline 10 is radially expanded and elastically and/or plastically deformed by the radial expansion and plastic deformation of the pipe sections 36.

In an exemplary embodiment, the radial expansion and plastic deformation of the pipe sections 36 into engagement with the pipeline 10 results in a resulting pipeline assembly, including the combination of the pipeline and the radially expanded and plastically deformed pipe sections, having a capacity to convey fluidic materials such as, for example, natural gas and/or fuel oil, at increased operating pressures and/or flow rates versus the pipeline 10 by itself. In this manner, the present exemplary embodiments provide a methodology for up-rating preexisting underground pipelines to convey fluidic materials at increased flow rates and/or operating pressures. In an exemplary embodiment, the up-rating of the pipeline 10 may be provided with or without any radial deformation of the pipeline.

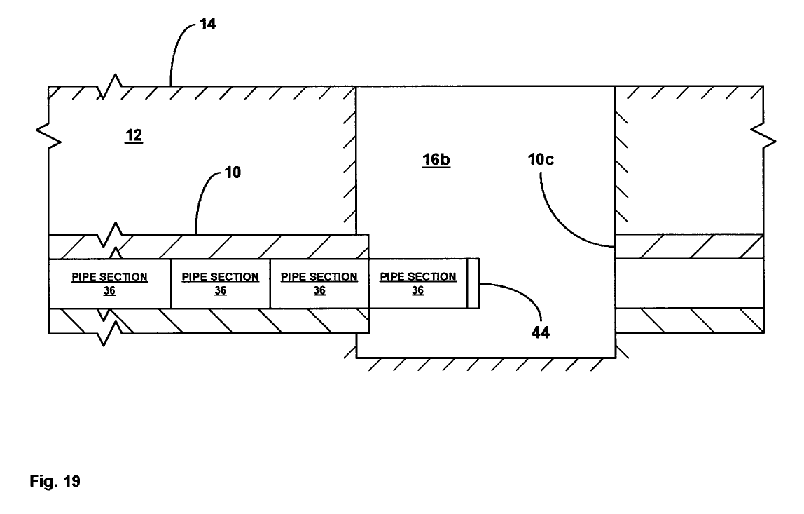

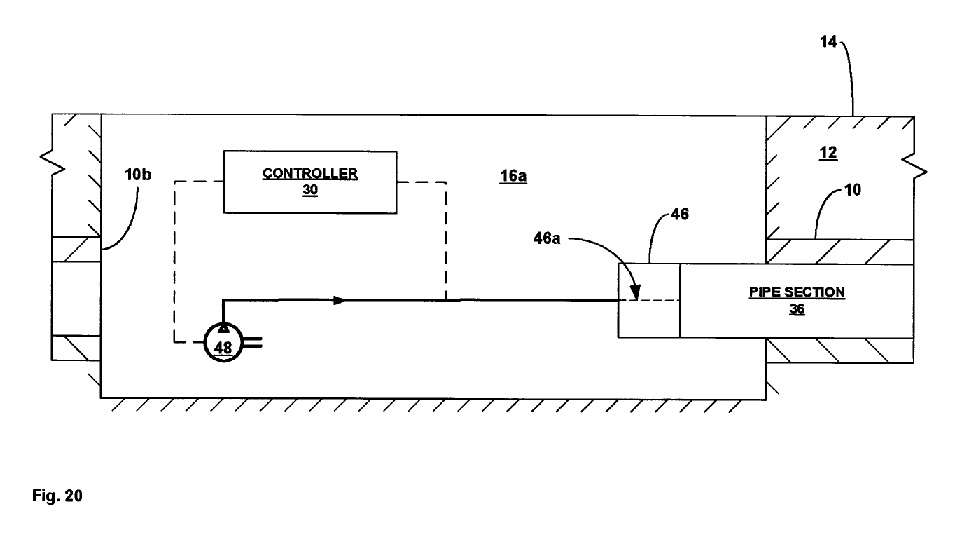

Referring to FIGS. 19 and 20, in an exemplary embodiment, after all of the pipe sections 36 positioned within the pipeline 10 have been radially expanded and plastically deformed, the expansion cone 42bc may be removed from the pipe sections, the expansion system 42 may be decoupled from the pipe sections 36 and removed from the trench 16a, an end plate 44 may be coupled to a radially expanded end of a pipe section 36 within the trench 16b, and an end plate 46 that defines a longitudinal passage 46a may be coupled to a radially expanded end of a pipe section within the trench 16a.

In an exemplary embodiment, an outlet of a pump 48 that is operably coupled to the controller 30 may then be operably coupled to the passage 46a of the end plate 46. In an exemplary embodiment, the pump 48 may then be operated to inject fluidic materials into the pipe sections 36 to thereby pressurize the pipe sections. In an exemplary embodiment, during the pressurization of the interior of the pipe sections 36, the operating pressure is monitored by the controller 30 to thereby determine the integrity and condition of the pipe sections.

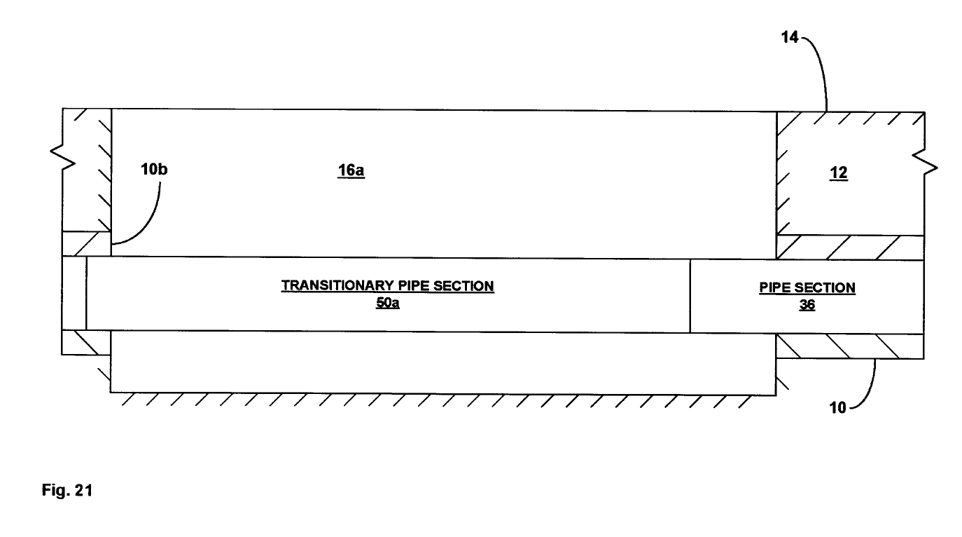

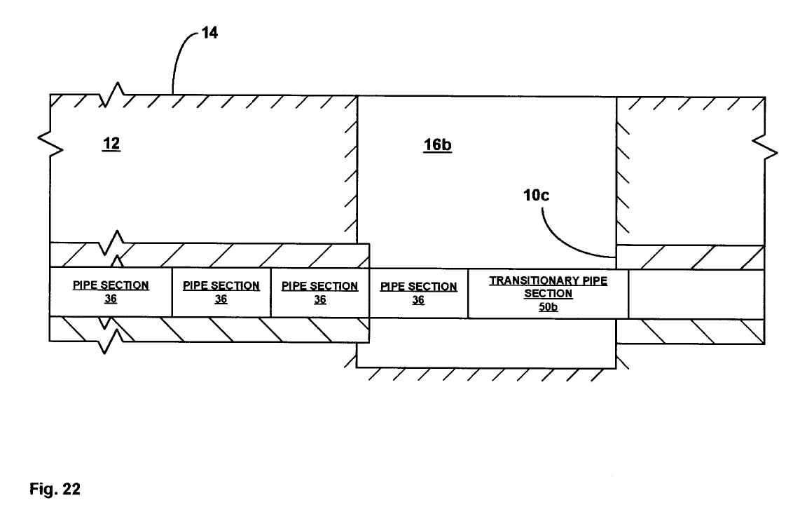

Referring to FIGS. 21 and 22, after completing the pressure testing of the pipe sections 36, the end plates, 46 and 48, may be removed from the ends of the corresponding pipe sections. In an exemplary embodiment, after removing the end plates, 46 and 48, from the ends of the corresponding pipe sections, transitionary pipe sections, 50a and 50b, may be installed in a conventional manner between the ends of the radially expanded and plastically deformed ends of the pipe sections 36 and the open ends, 10b and 10c, respectively, of the pipeline 10. As a result, fluidic materials may then be transported through the pipeline 10, radially expanded pipe sections 36, and the transitionary pipe sections, 50a and 50b.

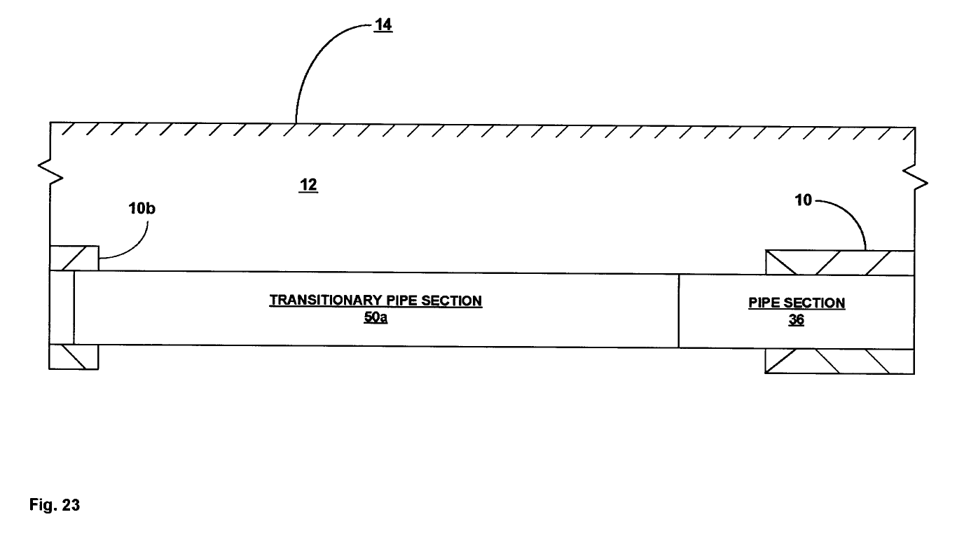

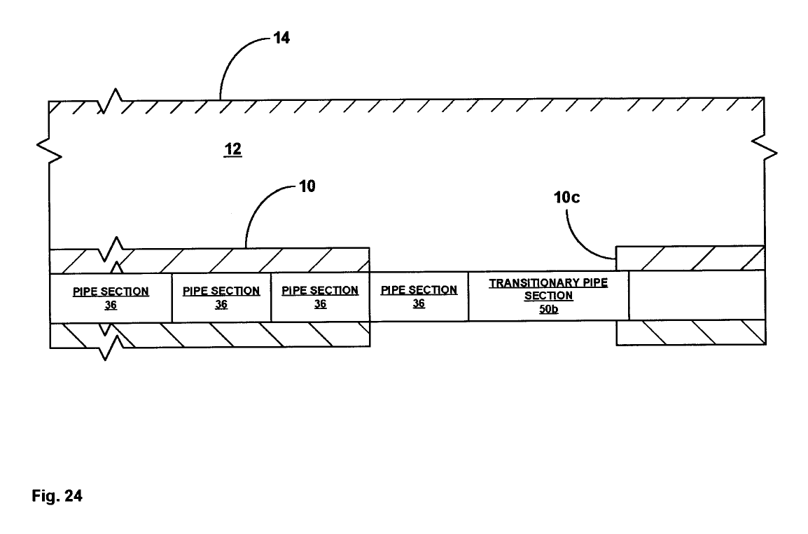

Referring to FIGS. 23 and 24, in an exemplary embodiment, after installing the transitionary pipe sections, 50a and 50b, the trenches, 16a and 16b, may be filled with earthen material thereby burying the radially expanded pipe sections 36 and the transitionary pipe sections, 50a and 50b, within the respective trenches beneath the surface 14 of the Earth.

Thus, the operational steps of FIGS. 1-24 result in a methodology for repairing the pipeline 10.

In an exemplary embodiment, one or more of the pipe sections 36 may be fabricated from other materials such as, for example, plastics and/or composite materials and the apparatus 34 may be modified using combinations of conventional joining systems for joining metallic, plastic and/or composite materials to one another.

In an exemplary embodiment, one or more portions of the pipeline 10 may be uncovered and then pipe sections 36 may be inserted into the pipeline and processed using one or more of the operational steps of the method of FIGS. 1-24.

Referring to FIGS. 25a and 25b, in an exemplary embodiment, pipe sections 2500 that include a corrugated cross section 2500a may be employed in place of, or in addition to, one or more of the pipe sections 36 in the method of FIGS. 1-24 above. In an exemplary embodiment, the expansion forces required to radially expand the pipe sections 2500 may be substantially less than the expansion forces required to radially expand the pipe sections 36. Thus, use of the pipe section 2500 in the method of FIGS. 1-24 above may result in reduced overall expansion forces and thereby may save time and money.

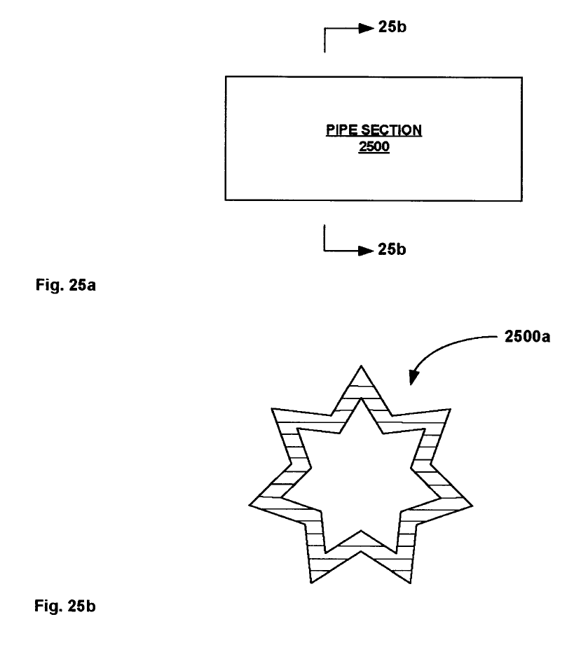

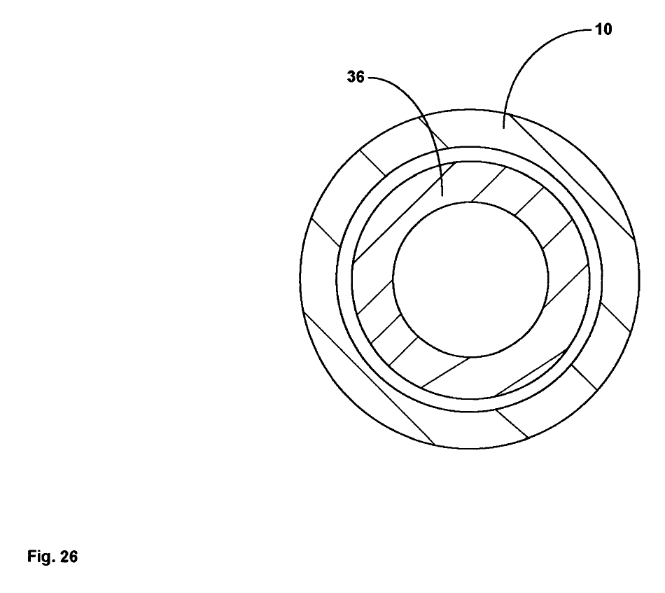

Referring to FIG. 26, in an exemplary embodiment, in the method of FIGS. 1-24 above, one or more portions of one or more of the pipe sections 36 may not be radially expanded and plastically deformed. In addition, referring to FIG. 26, in an exemplary embodiment, in the method of FIGS. 1-24 above, one or more portions of one or more of the pipe sections 36 may not be radially expanded and plastically deformed into engagement with the surrounding portions of the pipeline 10.

Referring to FIGS. 27 and 27a, in an exemplary embodiment, pipe sections 2700 that include one or more outer sealing layers 2700a may be employed in place of, or in addition to, one or more of the pipe sections 36 in the method of FIGS. 1-24 above. In an exemplary embodiment, one or more of the outer sealing layers 2700a may, for example, seal the interface between the pipe section 2700 and the corresponding outer portion of the pipeline 10. In an exemplary embodiment, one or more of the outer sealing layers 2700a may, for example, provide cathodic protection of the pipe section 2700 and/or the corresponding outer portion of the pipeline 10.

In an exemplary embodiment, following the radial expansion and plastic deformation of the pipe sections 36 within the pipeline 10, at least a portion of the one or more of the pipe sections form a metal to metal seal with at least a portion of the pipeline.

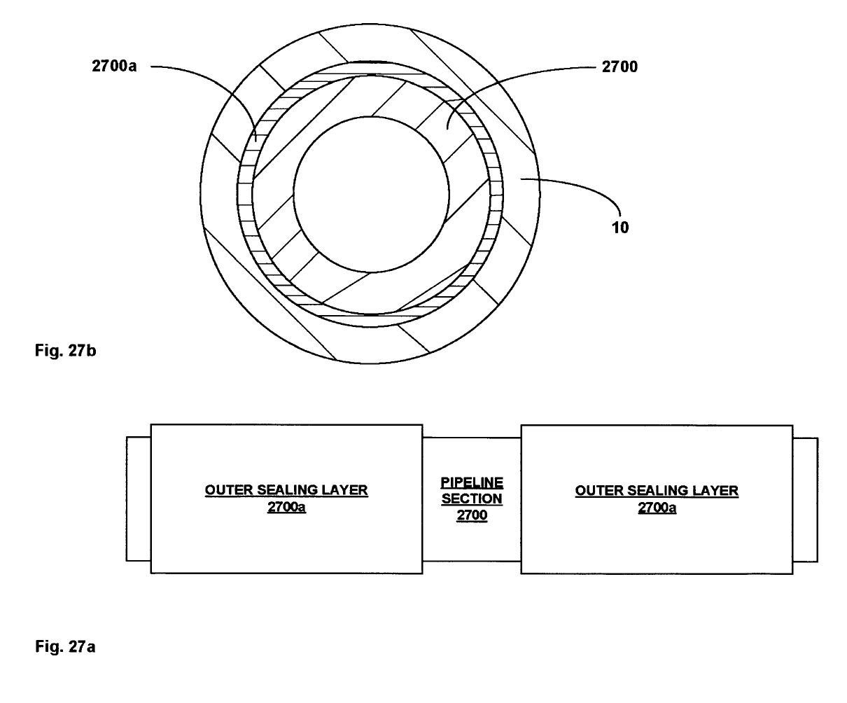

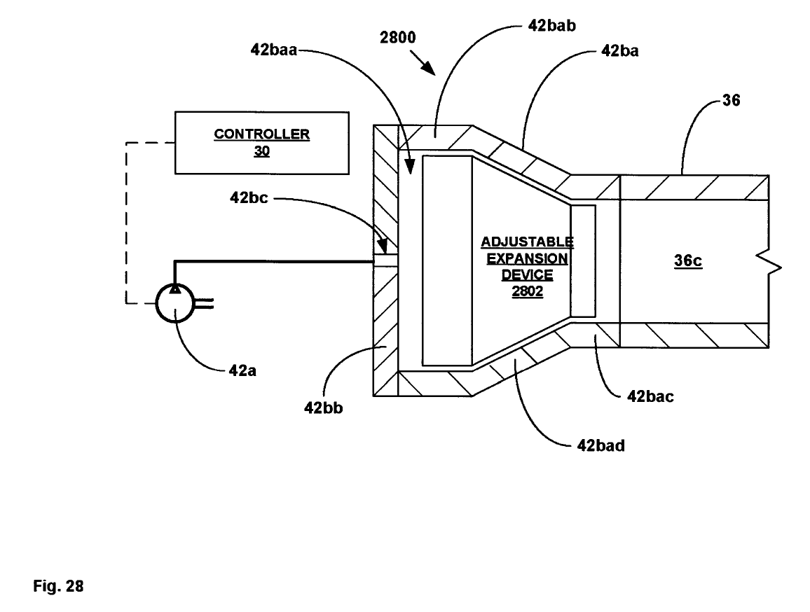

Referring to FIG. 28, in an exemplary embodiment, an expansion device 2800 may be used in the method of FIGS. 1-24 above that is substantially identical to the expansion device 42b with the exception of the use of an adjustable expansion device 2802 instead of the expansion cone 42bc. In an exemplary embodiment, the adjustable expansion device 2802 is a conventional adjustable expansion device and/or one or more of the adjustable expansion devices included in one or more of the applications and patents incorporated by reference into the present application.

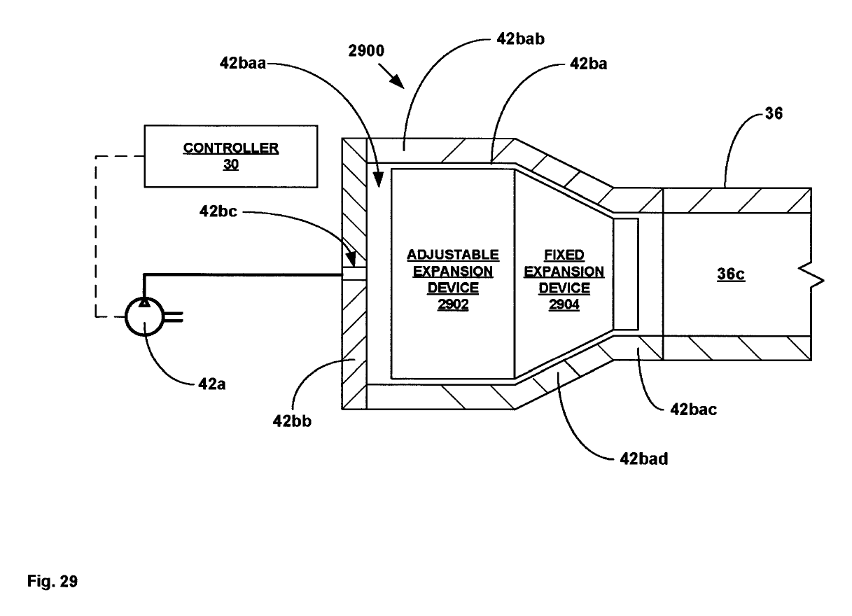

Referring to FIG. 29, in an exemplary embodiment, an expansion device 2900 may be used in the method of FIGS. 1-24 above that is substantially identical to the expansion device 42b with the exception of the use of an adjustable expansion device 2902 and a fixed expansion device 2904 instead of the expansion cone 42bc. In an exemplary embodiment, the adjustable expansion device 2902 is a conventional adjustable expansion device and/or one or more of the adjustable expansion devices included in one or more of the applications and patents incorporated by reference into the present application. In an exemplary embodiment, the fixed expansion device 2904 is a conventional adjustable expansion device and/or one or more of the adjustable expansion devices included in one or more of the applications and patents incorporated by reference into the present application.

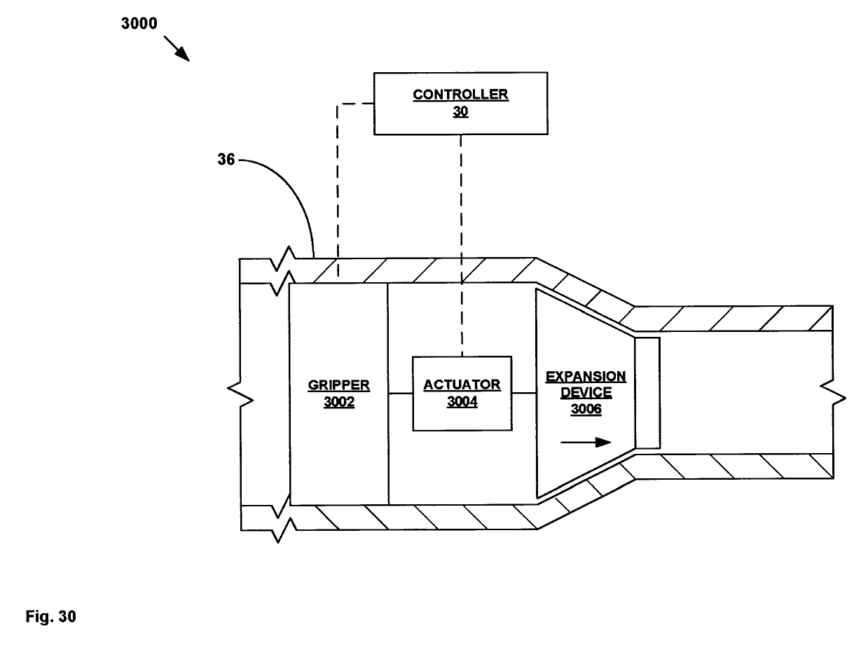

Referring to FIG. 30, in an exemplary embodiment, an expansion device 3000 may be used in the method of FIGS. 1-24 that includes a gripper 3002 for controllably gripping an interior surface of the pipe sections 36 that is coupled to an end of an actuator 3004. In an exemplary embodiment, another end of the actuator 3004 is coupled to an expansion device 3006.

In an exemplary embodiment, during operation of the expansion device 3000, the gripper 3002 engages the internal surfaces of a radially expanded and plastically deformed pipe section 36 and the actuator 3004 operates to displace the expansion device 3006 in a longitudinal direction away from the gripper thereby radially expanding and plastically deforming the pipe section 36. In an exemplary embodiment, the gripper 3002 is a conventional gripping device and/or one or more of the gripping devices included in one or more of the applications and patents incorporated by reference into the present application. In an exemplary embodiment, the actuator 3004 is a conventional actuator and/or one or more of the actuators included in one or more of the applications and patents incorporated by reference into the present application. In an exemplary embodiment, the expansion device 3006 is a conventional expansion device and/or one or more of the expansion devices included in one or more of the applications and patents incorporated by reference into the present application.

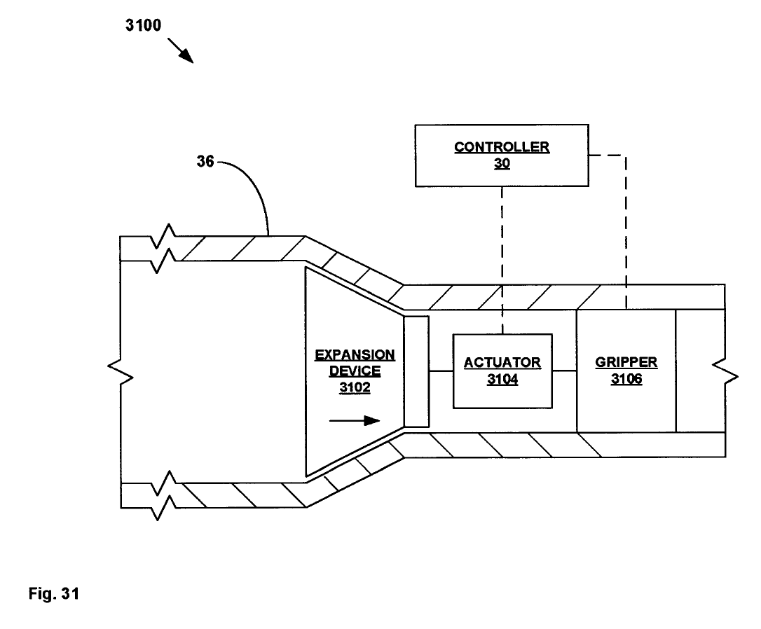

Referring to FIG. 31, in an exemplary embodiment, an expansion device 3100 may be used in the method of FIGS. 1-24 that includes an expansion device 3102, an actuator 3104, and a gripper 3106.

In an exemplary embodiment, during operation of the expansion device 3100, the gripper 3106 engages the internal surfaces of a pipe section 36 and the actuator 3104 operates to displace the expansion device 3102 in a longitudinal towards from the gripper thereby radially expanding and plastically deforming the pipe section 36. In an exemplary embodiment, the expansion device 3102 is a conventional expansion device and/or one or more of the expansion devices included in one or more of the applications and patents incorporated by reference into the present application. In an exemplary embodiment, the actuator 3104 is a conventional actuator and/or one or more of the actuators included in one or more of the applications and patents incorporated by reference into the present application. In an exemplary embodiment, the gripper 3106 is a conventional gripping device and/or one or more of the gripping devices included in one or more of the applications and patents incorporated by reference into the present application.

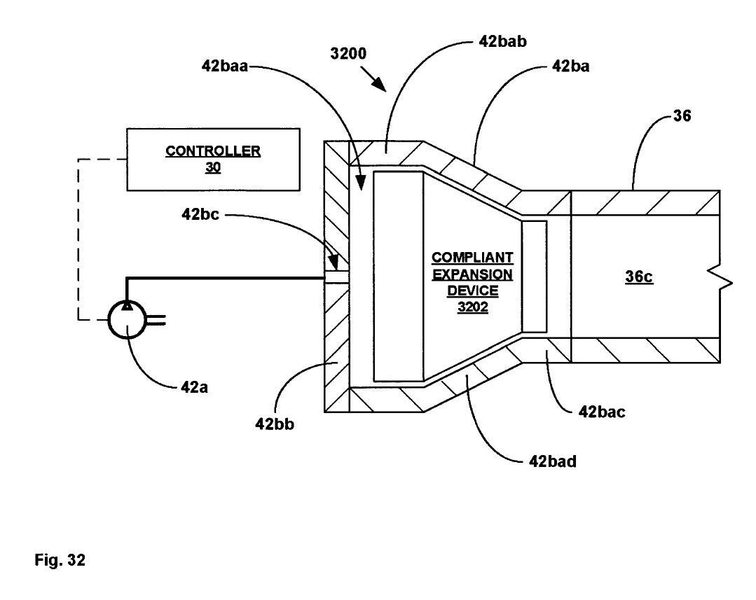

Referring to FIG. 32, in an exemplary embodiment, an expansion device 3200 may be used in the method of FIGS. 1-24 above that is substantially identical to the expansion device 42b with the exception of the use of a compliant expansion device 3202 instead of the expansion cone 42bc. In an exemplary embodiment, the compliant expansion device 3202 is a conventional compliant expansion device and/or one or more of the adjustable expansion devices included in one or more of the applications and patents incorporated by reference into the present application.

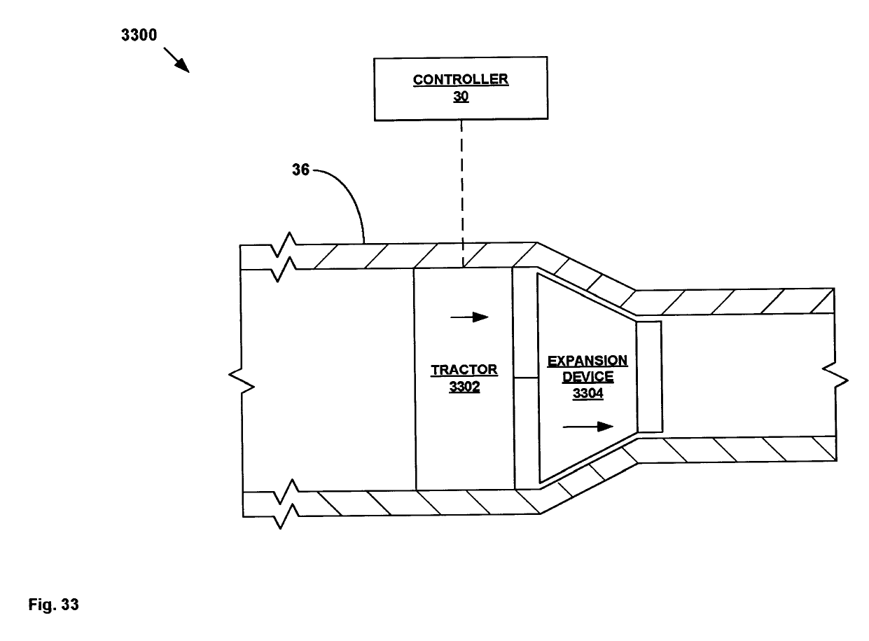

Referring to FIG. 33, in an exemplary embodiment, an expansion device 3300 may be used in the method of FIGS. 1-24 that includes a tractor 3302 and an expansion device 3304.

In an exemplary embodiment, during operation of the expansion device 3300, the tractor 3302 drives along the interior of the pipe sections 36. As a result, the expansion device 3304 coupled to the tractor 3302 is pushed by the tractor within the pipe sections in a longitudinal direction thereby radially expanding and plastically deforming the pipe section 36. In an exemplary embodiment, the tractor 3302 is a conventional tractor and/or one or more of the tractors included in one or more of the applications and patents incorporated by reference into the present application. In an exemplary embodiment, the expansion device 3304 is a conventional expansion device and/or one or more of the expansion devices included in one or more of the applications and patents incorporated by reference into the present application.

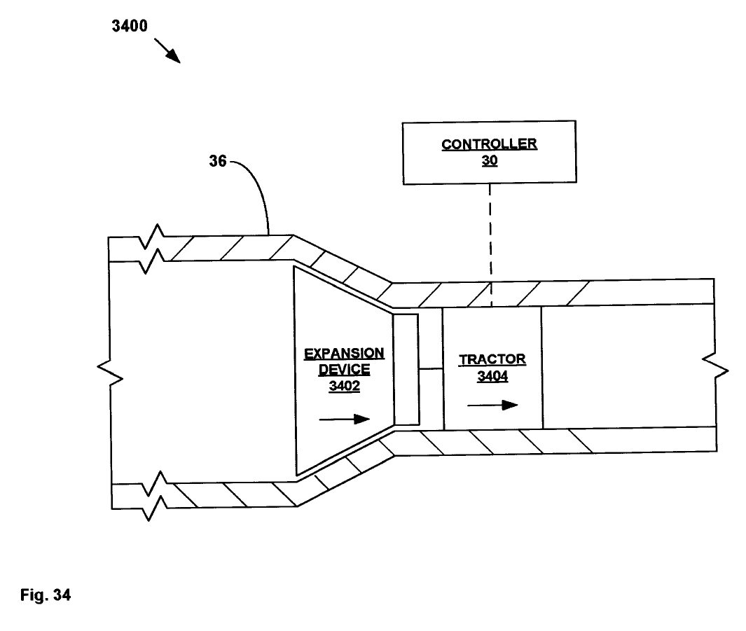

Referring to FIG. 34, in an exemplary embodiment, an expansion device 3400 may be used in the method of FIGS. 1-24 that includes an expansion device 3402 and a tractor 3404.

In an exemplary embodiment, during operation of the expansion device 3400, the tractor 3402 drives along the interior of the pipe sections 36. As a result, the expansion device 3402 coupled to the tractor 3404 is pulled by the tractor within the pipe sections in a longitudinal direction thereby radially expanding and plastically deforming the pipe section 36. In an exemplary embodiment, the expansion device 3402 is a conventional expansion device and/or one or more of the expansion devices included in one or more of the applications and patents incorporated by reference into the present application. In an exemplary embodiment, the tractor 3404 is a conventional tractor and/or one or more of the tractors included in one or more of the applications and patents incorporated by reference into the present application.

Referring to FIG. 35, in an exemplary embodiment, an expansion device 3500 may be used in the method of FIGS. 1-24 that includes a pump 3502 and an expansion device 3504.

In an exemplary embodiment, during operation of the expansion device 3500, the interior portion of the pipe section 36 is at least partially filled with a fluidic material and the pump 3502 is operated to discharge fluidic materials in a longitudinal direction away from the pump. As a result, the expansion device 3504 coupled to the pump 3502 is pushed through the pipe section 36 in a longitudinal direction thereby radially expanding and plastically deforming the pipe section 36. In an exemplary embodiment, the expansion device 3504 is a conventional pump and/or one or more of the expansion devices included in one or more of the applications and patents incorporated by reference into the present application.

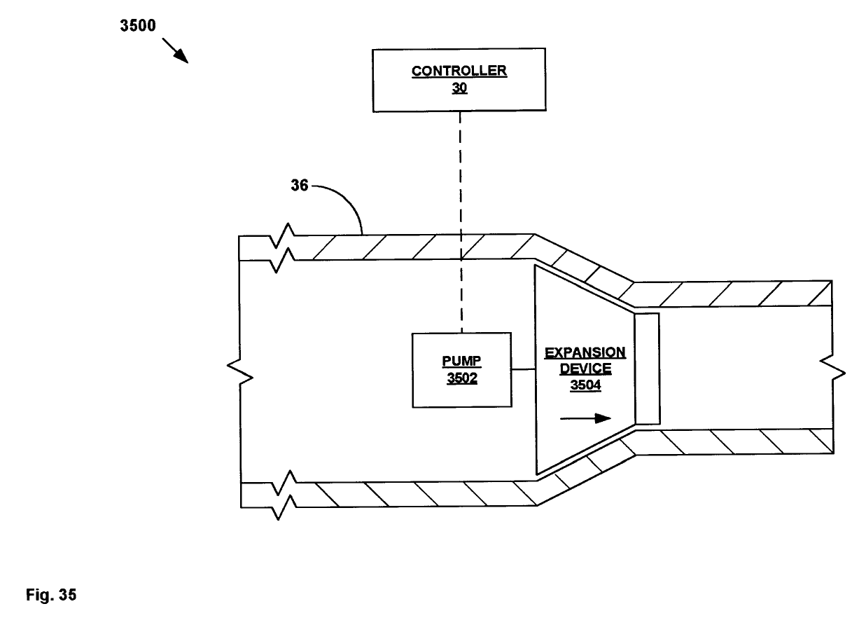

Referring to FIGS. 36a and 36b, in an exemplary embodiment, an expansion device 3600 may be used in the method of FIGS. 1-24 that includes a vibration device 3602 coupled to an expansion device 3604.

In an exemplary embodiment, during operation of the expansion device 3600, the vibration device 3602 is operated while the expansion device 3604 is displaced in a longitudinal direction within the pipe sections 36. As a result, the expansion device 3604 radially expands and plastically deforms the pipe section 36. Furthermore, in an exemplary embodiment, the expansion device 3604 also radially expands and plastically deforms defects 3704 within the pipeline 10 such as, for example, collapsed portions of the pipeline. In an exemplary embodiment, the vibration device 3602 is a conventional vibration device and/or one or more of the vibration devices included in one or more of the applications and patents incorporated by reference into the present application. In an exemplary embodiment, the expansion device 3604 is a conventional expansion device and/or one or more of the expansion devices included in one or more of the applications and patents incorporated by reference into the present application.

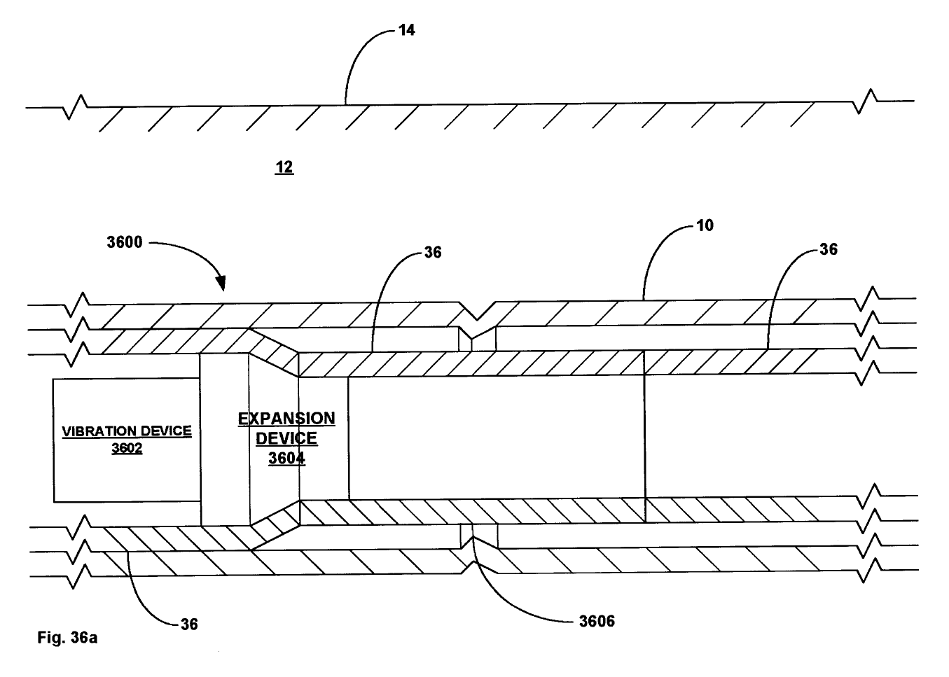

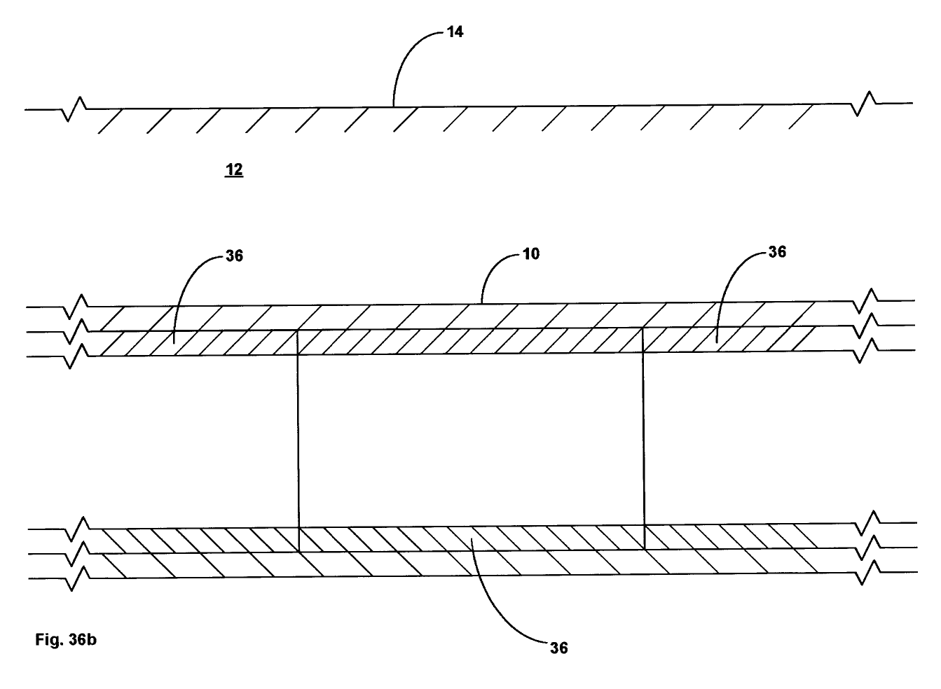

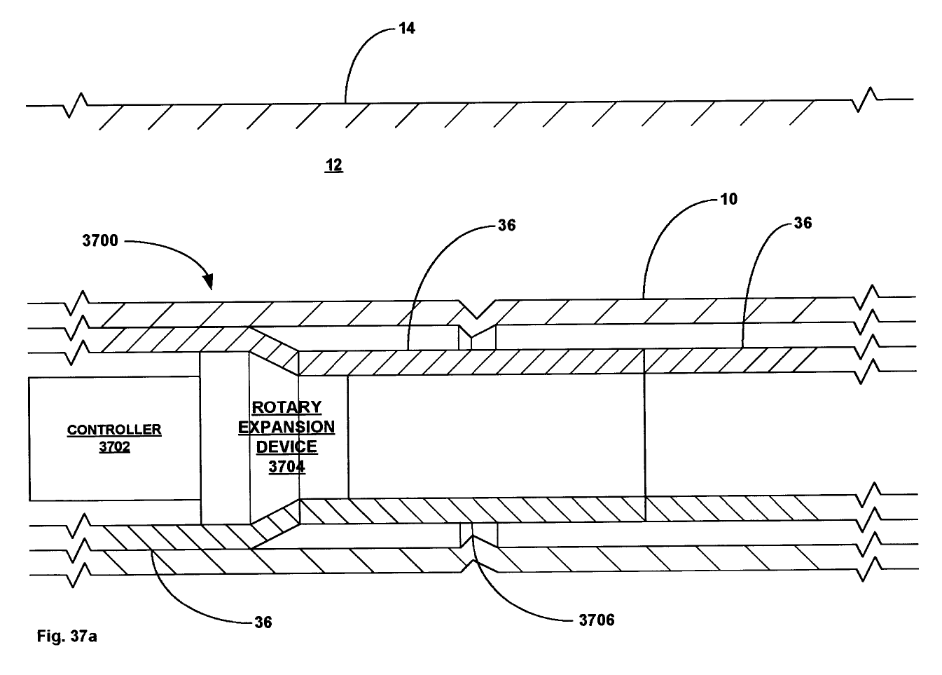

Referring to FIGS. 37a and 37b, in an exemplary embodiment, an expansion device 3700 may be used in the method of FIGS. 1-24 that includes a controller 3702 coupled to a rotary expansion device 3704.

In an exemplary embodiment, during operation of the expansion device 3700, the controller 3702 is operated to rotate and longitudinally displace the rotary expansion device 3704 within the pipe sections 36. As a result, the rotary expansion device 3704 radially expands and plastically deforms the pipe section 36. Furthermore, in an exemplary embodiment, the expansion device 3704 also radially expands and plastically deforms defects 3706 within the pipeline 10 such as, for example, collapsed portions of the pipeline. In an exemplary embodiment, the controller 3702 is a conventional controller and/or one or more of the controller devices included in one or more of the applications and patents incorporated by reference into the present application. In an exemplary embodiment, the rotary expansion device 3704 is a conventional expansion device and/or one or more of the rotary expansion devices included in one or more of the applications and patents incorporated by reference into the present application.

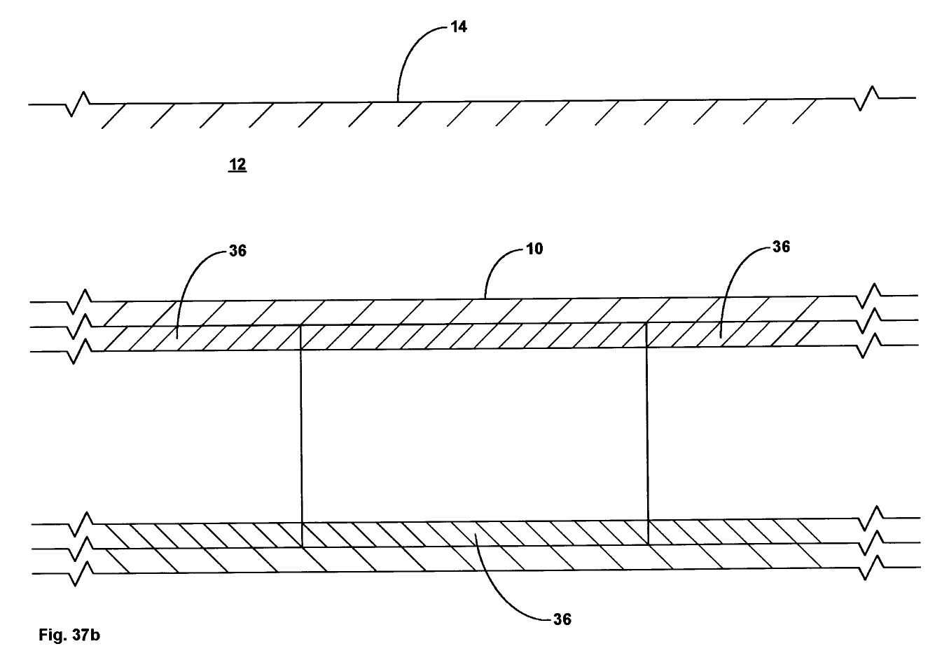

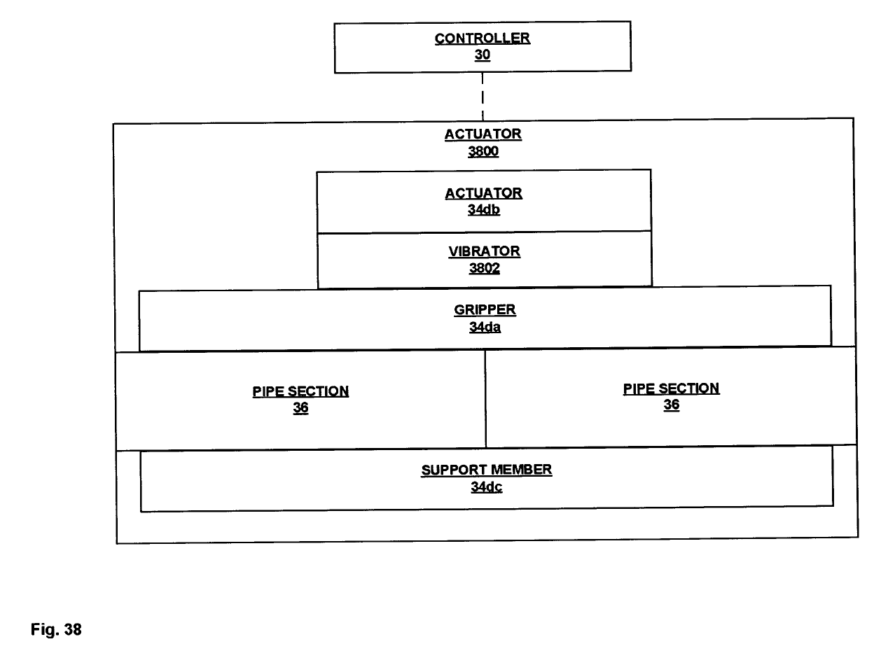

Referring to FIG. 38, in an exemplary embodiment of an actuator 3800 is substantially identical to the actuator 34d with the addition of a vibration source 3802 that is operably coupled to the gripper 34da. In an exemplary embodiment, the actuator 3800 may be substituted for, or used in addition to, the actuator 34d in the method of FIGS. 1-24 described above. In an exemplary embodiment, during the operation of the actuator 3800, the vibration source 3802 injects vibratory energy into the pipe sections 36 thereby reducing the level of contact friction between the pipe sections and the pipeline 10.

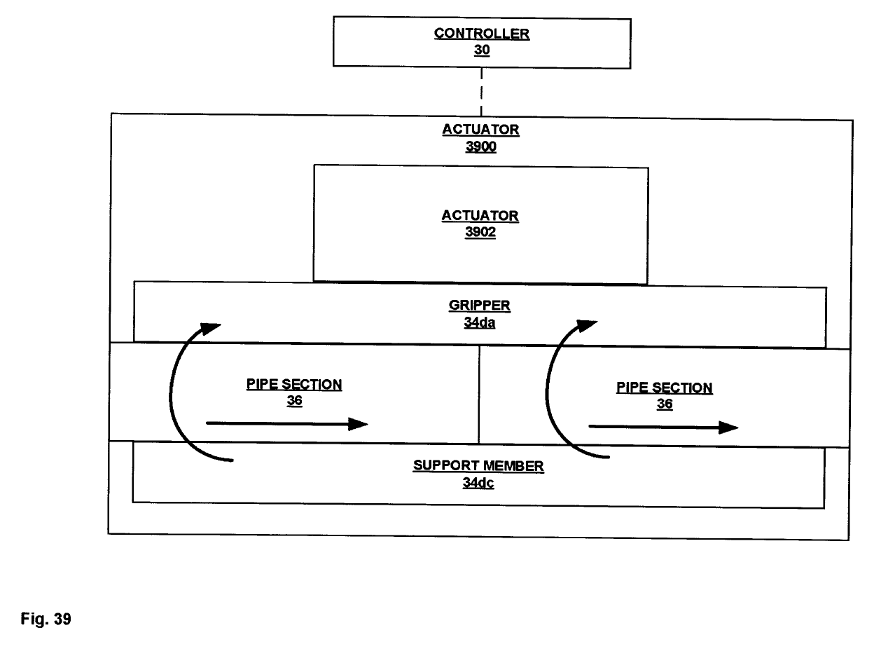

Referring to FIG. 39, in an exemplary embodiment of an actuator 3900 is substantially identical to the actuator 34d with the substitution of an actuator 3902 that may impart longitudinal and rotational displacement to the pipe sections 36. In an exemplary embodiment, the actuator 3900 may be substituted for, or used in addition to, the actuator 34d in the method of FIGS. 1-24 described above. In an exemplary embodiment, during the operation of the actuator 3900, the actuator 3902 imparts longitudinal and rotational displacement to the pipe sections 36 thereby reducing the level of contact friction between the pipe sections and the pipeline 10.

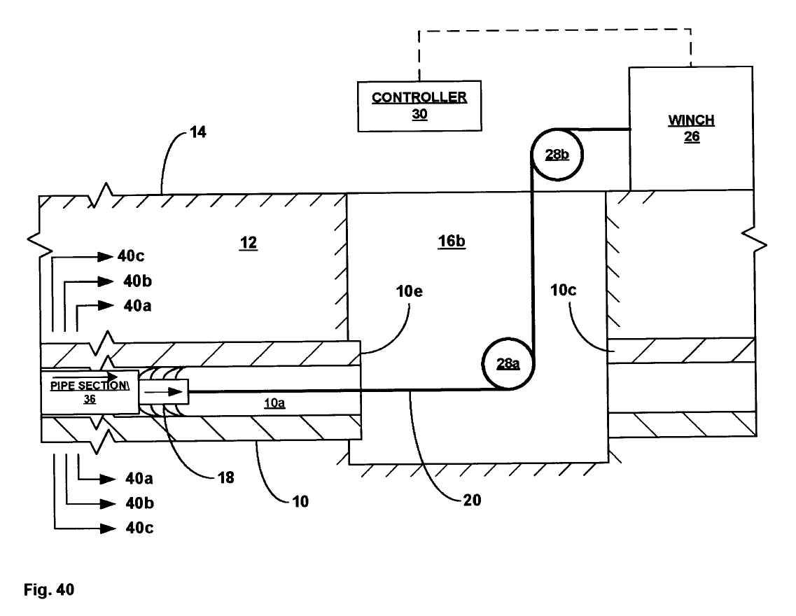

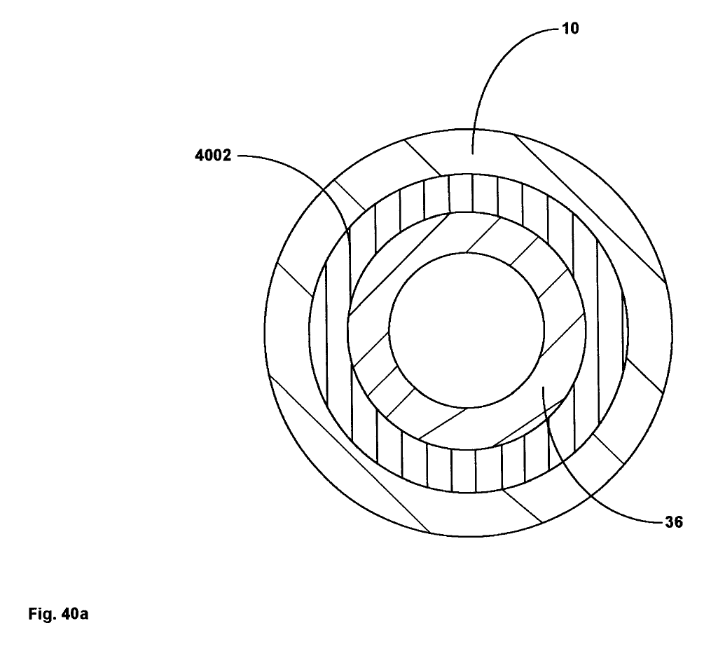

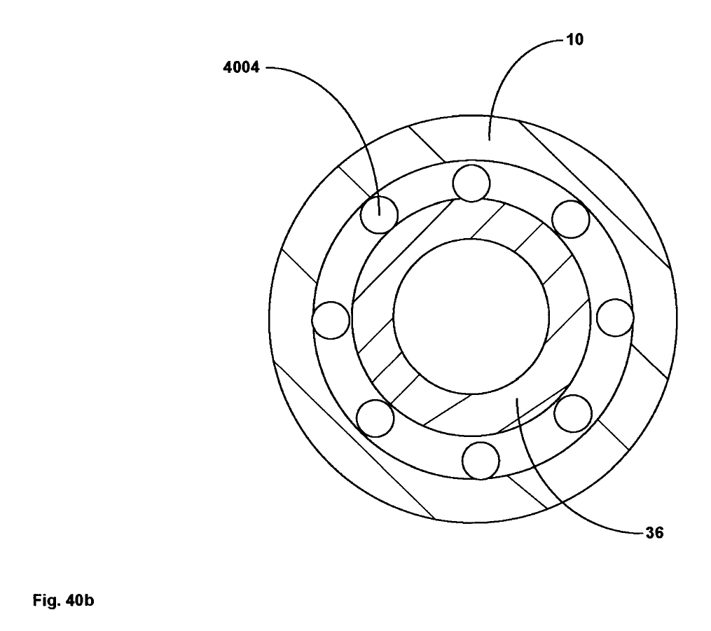

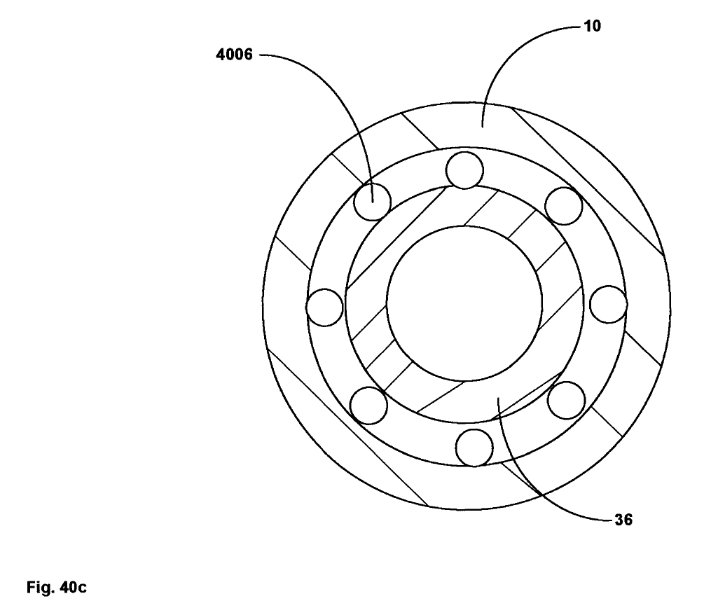

Referring to FIGS. 40, 40a, 40b, and 40c, in an exemplary embodiment, during operation of the method of FIGS. 1-24 described above, the interface between the pipe sections 36 and the pipeline 10 is filled with one or more of the following: a) a fluidic material 4002, b) a spider support 4004, and/or c) a dissolvable bearing material 4006.

In an exemplary embodiment, use of the fluidic material 4002 within the interface between the pipe sections 36 and the pipeline 10, permits the pipe sections to be floated through the pipeline thereby reducing contact friction between the pipe sections and the pipeline. In an exemplary embodiment, once the pipe sections 36 are positioned to their desired final positions, the fluidic material 4002 may be drained out of the interior of the pipeline 10.

In an exemplary embodiment, the spider support 4006 includes bearing surfaces for supporting the pipe sections 36 away from the interior surface of the pipeline 10. In this manner, contact friction between the pipe sections 36 and the pipeline 10 may be reduced. In an exemplary embodiment, the spider support 4004 may be, for example, a conventional spider support structure. In an exemplary embodiment, once the pipe sections 36 are positioned to their desired final positions, the spider support 4006 may be removed from the interior of the pipeline 10.

In an exemplary embodiment, the bearing material 4008 provides bearing surfaces for supporting the pipe sections 36 away from the interior surface of the pipeline 10. In this manner, contact friction between the pipe sections 36 and the pipeline 10 may be reduced. In an exemplary embodiment, the bearing material 4008 may be, for example, a dissolvable bearing material such as ice.

Referring to FIG. 41, in an exemplary embodiment, during operation of the method of FIGS. 1-24 described above, one or more of the pipe sections 36d may be bent about a radius of curvature R while being positioned within the pipeline 10, prior to be being radially expanded and plastically deformed. In an exemplary embodiment, the bending of the pipe section 36d results in a plastic deformation of the pipe section 36b.

In an exemplary experimental embodiment, pipe sections 36d were bent about a radius and then radially expanded and plastically deformed without any failure of the pipe section. This was an unexpected result.

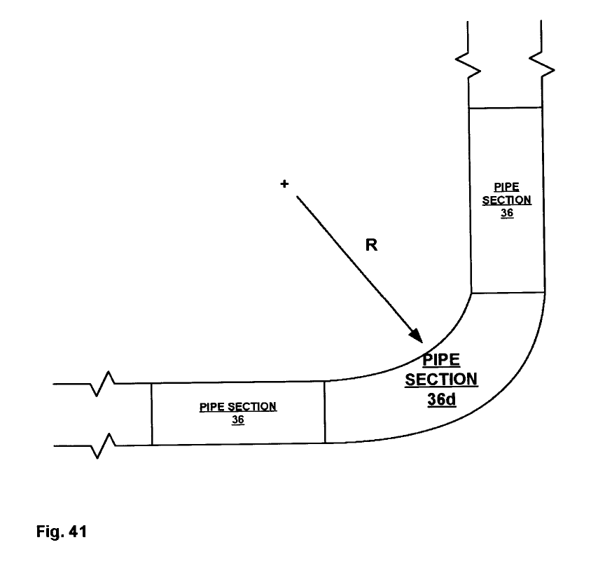

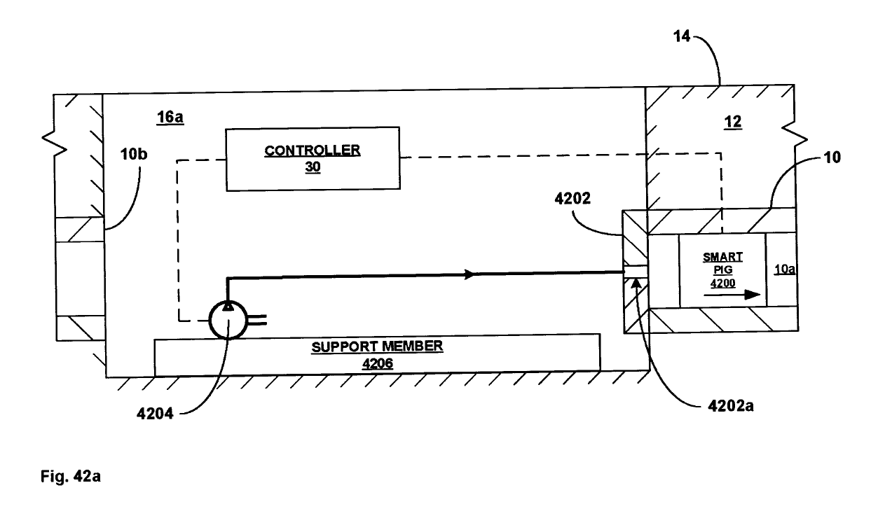

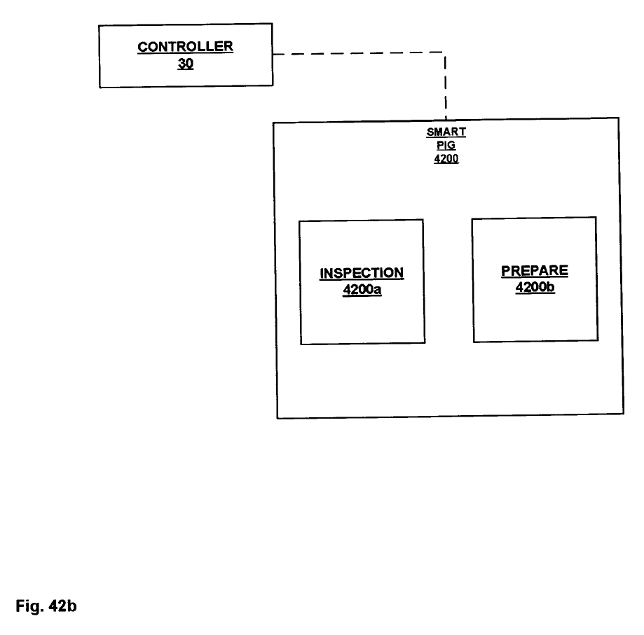

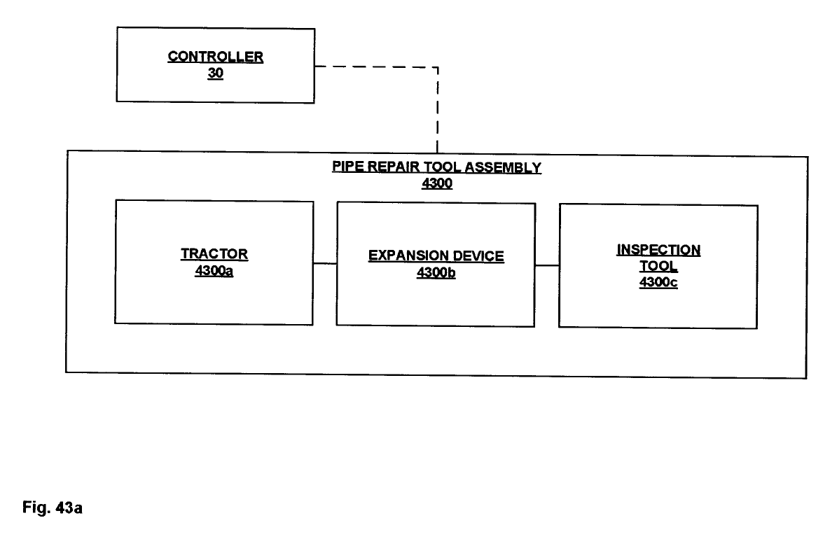

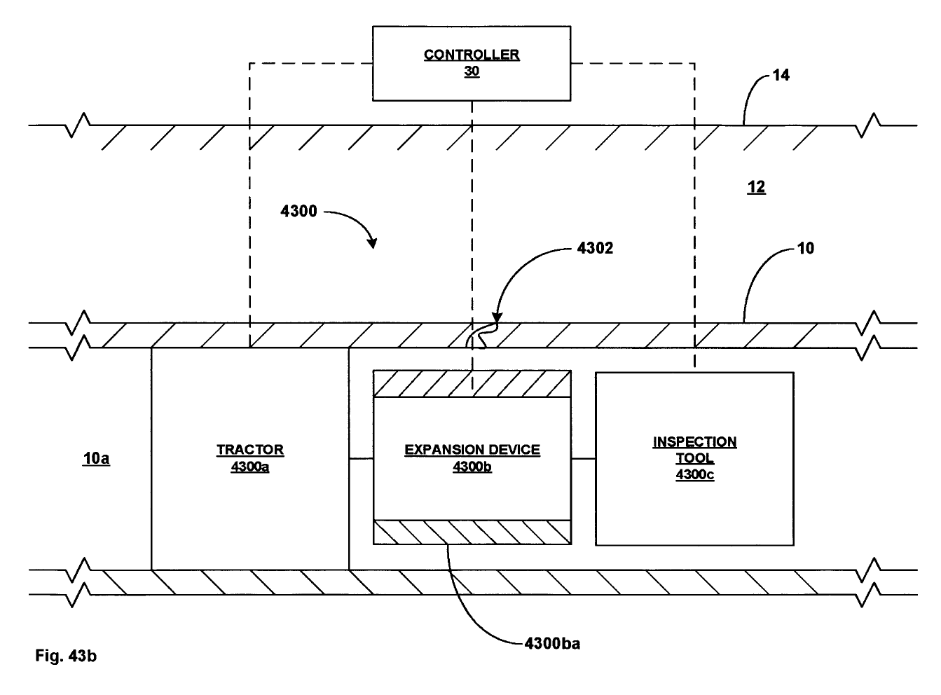

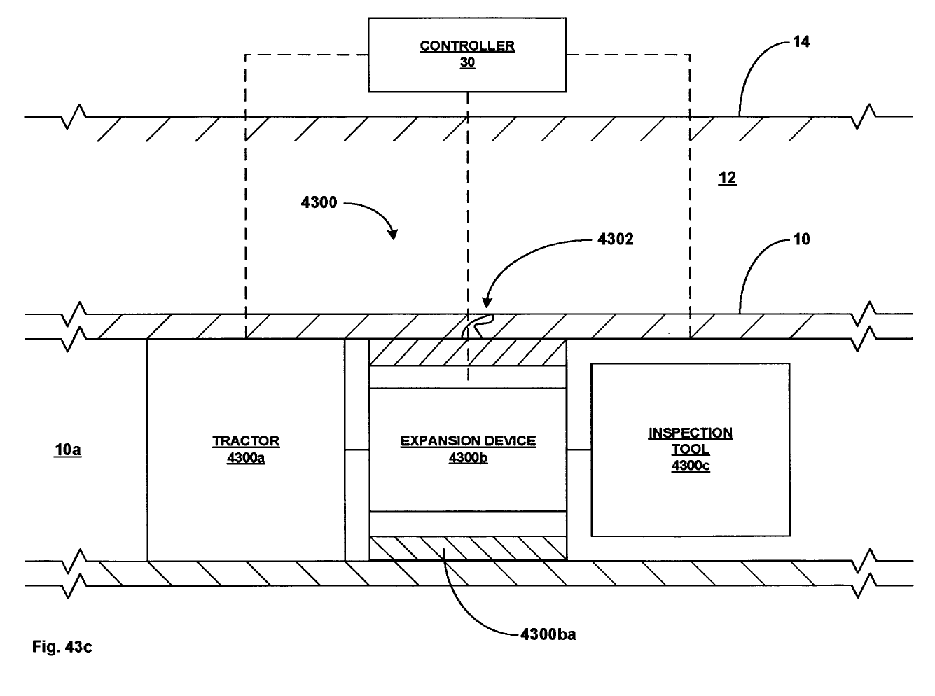

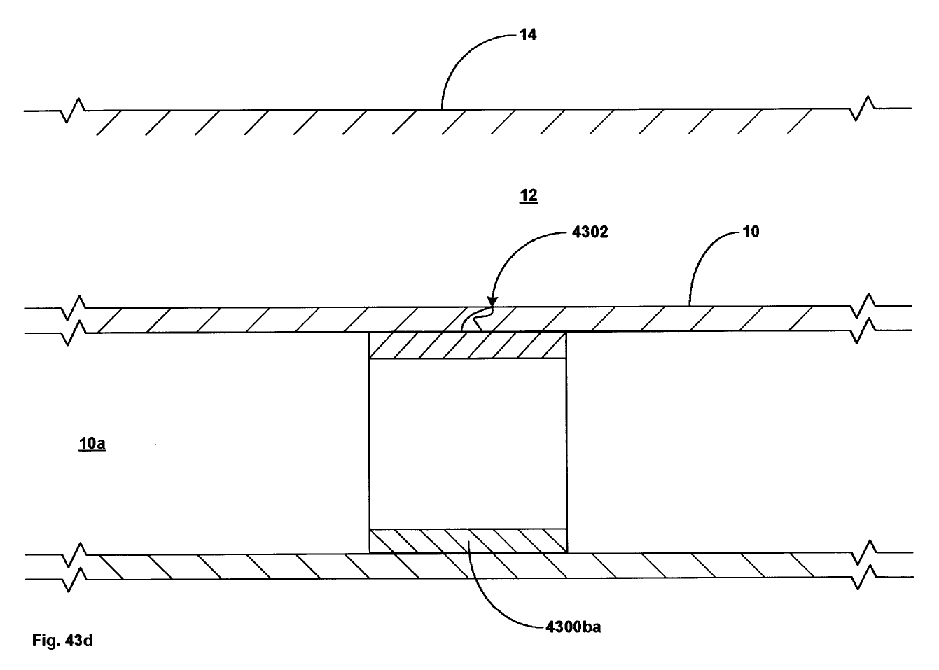

Referring to FIGS. 42a and 43b, in an exemplary embodiment, during operation of the method of FIGS. 1-24 described above, a smart pig 4200 may be pumped through the pipeline 10 prior to placing the pipe sections 36 within the pipeline in order to inspect the pipeline.

In particular, as illustrated in FIG. 42a, the pig 4200 may be inserted into an end of the pipe sections 36 that extend into the trench 16a and an end plate 4202 that defines a passage 4202a coupled the end of the pipe sections. A pump 4204, mounted upon a support member 4206, may then be positioned within the trench 16a and the outlet of the pump operably coupled to the passage 4202a of the end plate 4202. The pump 4204, under the control of the controller 30, may then be operated to displace the pig 4200 through the pipeline 10.

In an exemplary embodiment, as illustrated in FIG. 42b, the pig 4200 includes an inspection tool 4200a and a pipe preparation tool 4200b. In an exemplary embodiment, during operation of the pig 4200, under the control of the controller 30, the inspection tool 4200a inspects the pipeline 10 and the preparation tool 4200b prepares the interior surface of the pipeline for subsequent insertion of the pipe sections 36. In an exemplary embodiment, the inspection tool 4200a may include a conventional pipe inspection tool and the pipe preparation tool 4200b may include a conventional pipe preparation tool.

Referring to FIGS. 43a, 43b, 43c, and 43d, an exemplary embodiment of a pipe repair tool 4300 includes a tractor 4300a, an expansion device 4300b, and an inspection tool 4300c. In an exemplary embodiment, the tractor 4300a is adapted to move the tool 4300 through the interior of the pipeline 10 and may, for example, include a conventional tractor device. In an exemplary embodiment, the expansion device 4300b includes a tubular liner 4300ba and is adapted to radially expand and plastically deform the tubular liner 4300ba into engagement with a portion of the pipeline 10. In an exemplary embodiment, the inspection tool 4300c is adapted to inspect the pipeline 10 and locate defects 4302 in the pipeline.

In an exemplary embodiment, during operation of the tool 4300, under the control of the controller 30, the tractor 4300a moves the tool through the pipeline 10. While the tool 4300 is moved through the pipeline 10, the inspection tool 4300c identifies and locates defects 4302 in the pipeline. The expansion tool 4300b is then positioned proximate the located defects 4302 and is operated to radially expand and plastically deform the tubular liner 4300ba into engagement with the pipeline 10 in opposing relation to the defect. In this manner, defects 4302 within the pipeline 10 may be repaired.

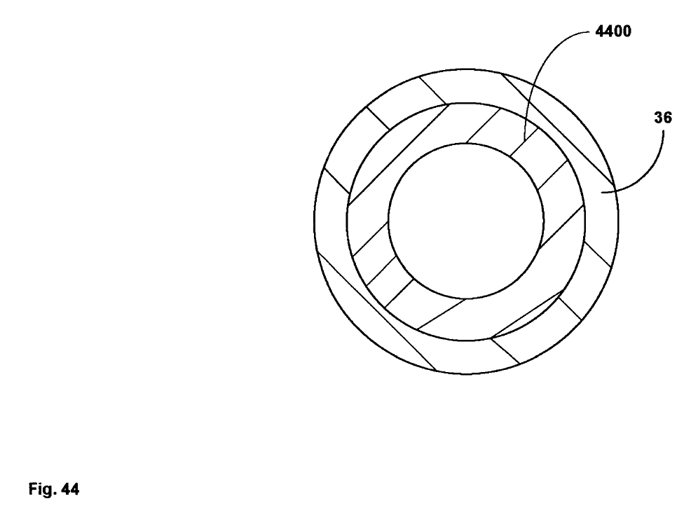

Referring to FIG. 44, in an exemplary embodiment, during operation of the method of FIGS. 1-24 described above, one or more of the pipe sections 36 may include an interior coating 4400 of a lubricating material in order to reduce the required expansion forces during the radial expansion and plastic deformation of the pipe sections.

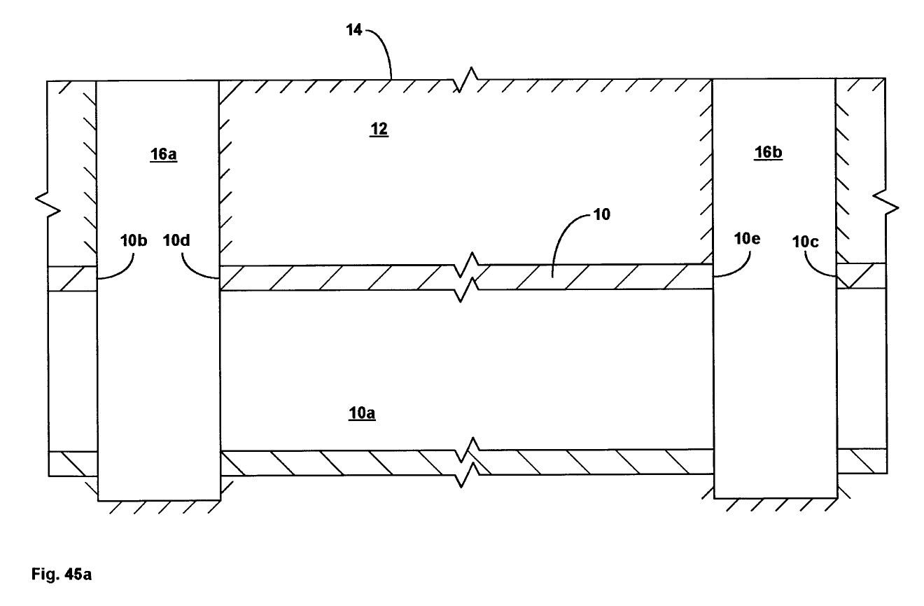

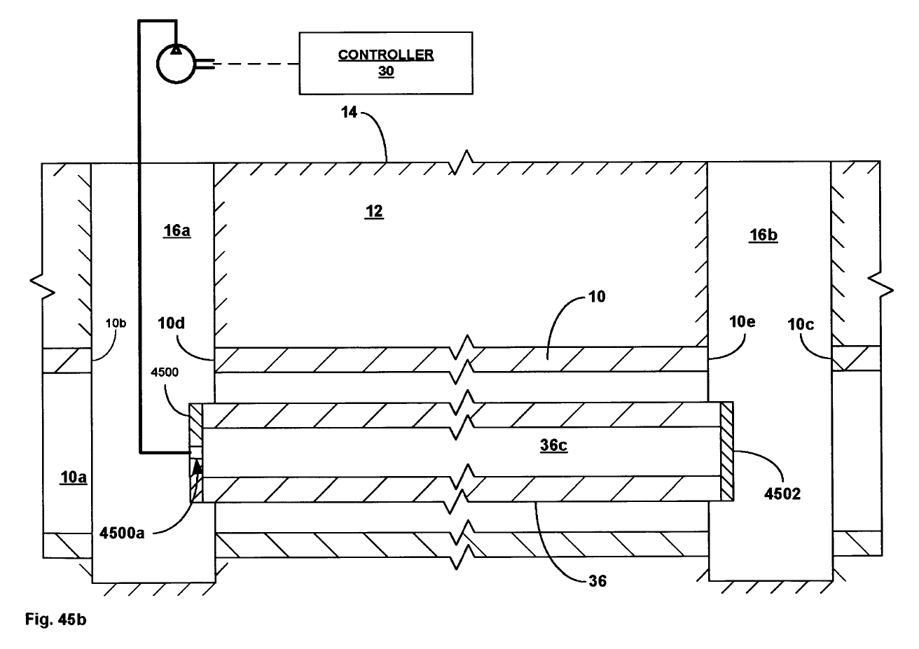

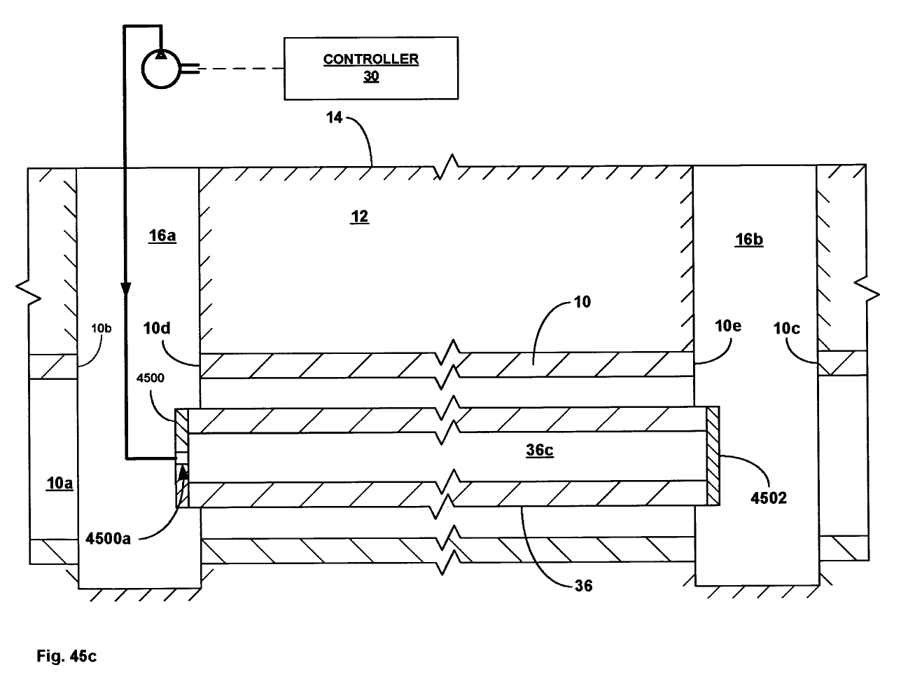

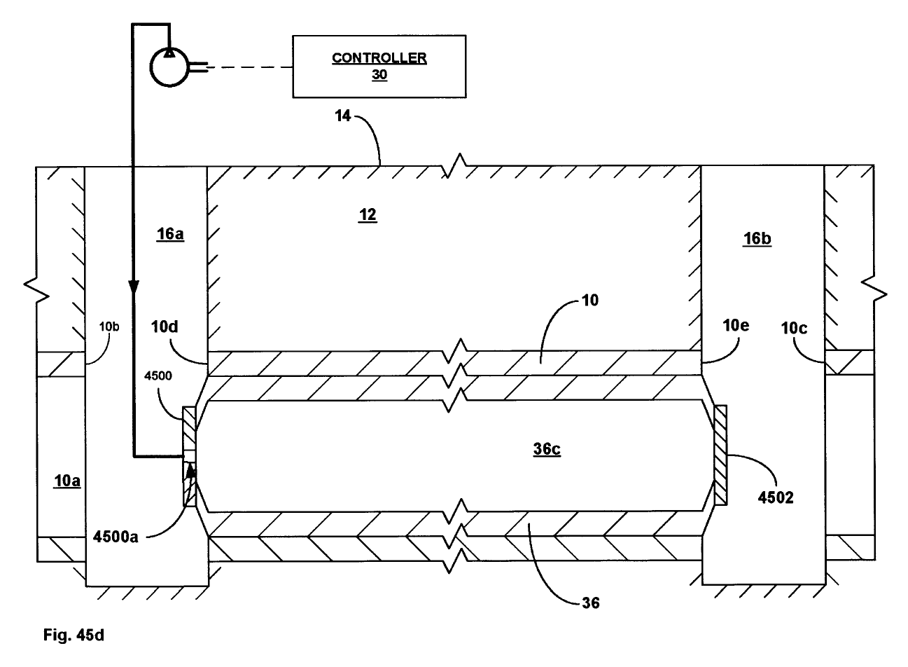

Referring to FIGS. 45a, 45b, 45c, and 45d, in an exemplary embodiment, during operation of the method of FIGS. 1-24 described above, after the pipe sections 36 are positioned within the pipeline 10, an end cap 4500 that defines a passage 4500a is coupled to an end of the pipe sections within the trench 16a and an end cap 4502 is coupled to an end of the pipe sections within the trench 16b. An outlet of a pump 4504 is then operably coupled to the passage 4500a of the end cap 4500.

In an exemplary embodiment, the pump 4504, under the control of the controller 30, is then operated to pressurize the interior 36c of the pipe sections 36 and thereby hydroform the pipe section thereby radially expanding and plastically deforming the pipe sections into engagement with the pipeline 10.

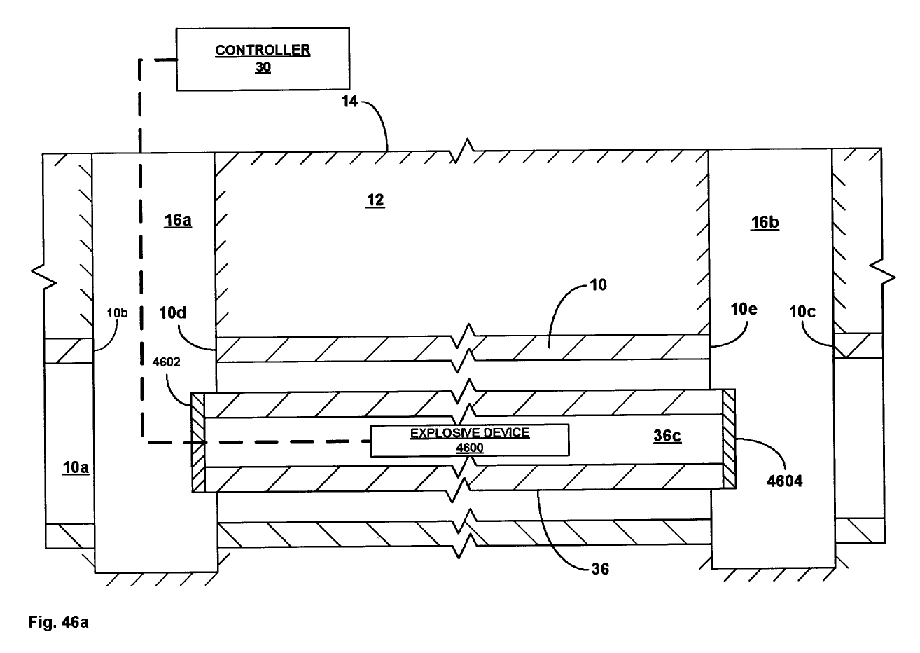

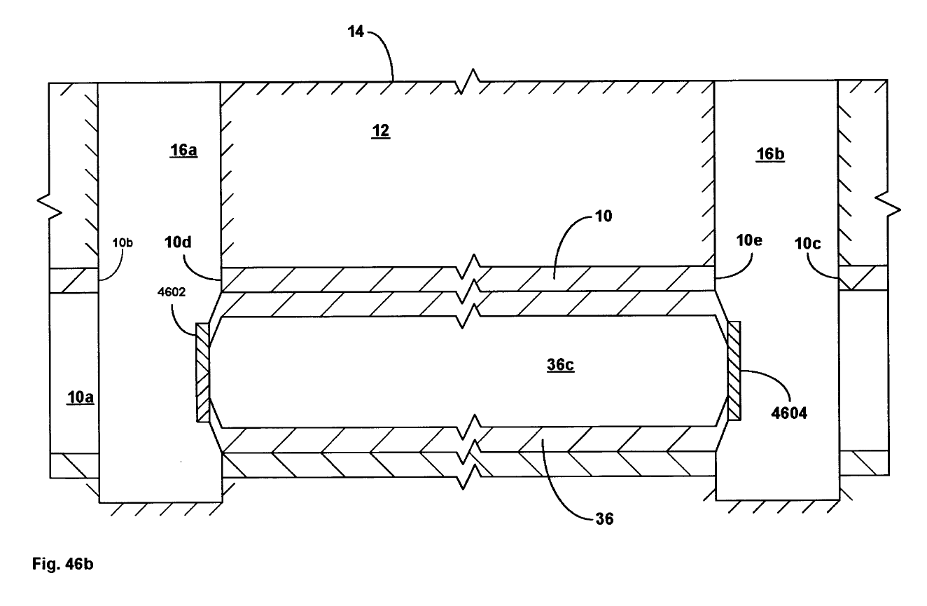

Referring to FIGS. 46a, 46b, 46c, and 46d, in an exemplary embodiment, during operation of the method of FIGS. 1-24 described above, after the pipe sections 36 are positioned within the pipeline 10, a conventional explosive device 4600 is positioned within the interior 36c of the pipe sections. End caps 4602 and 4604 are then coupled to the opposing ends of the pipe sections 36 within the trenches, 16a and 16b, respectively.

In an exemplary embodiment, the explosive device 4600, under the control of the controller 30, is then detonated within the interior 36c of the pipe sections 36 and thereby radially expands and plastically deforms the pipe sections into engagement with the pipeline 10.

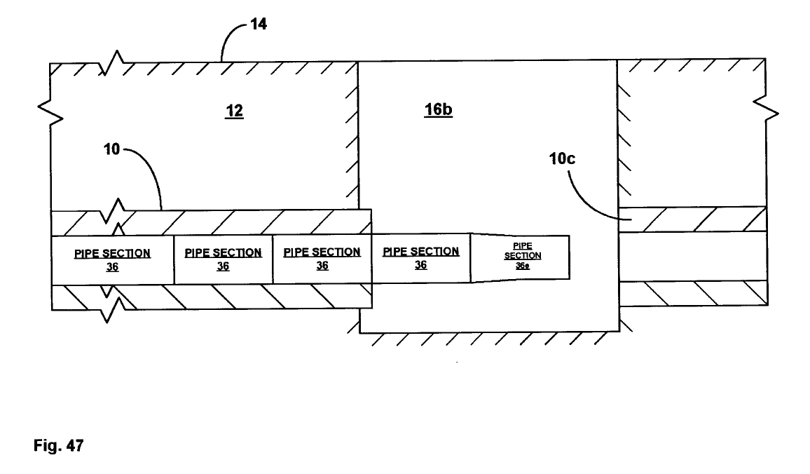

Referring FIG. 47, in an exemplary embodiment, during operation of the method of FIGS. 1-24 described above, during the radial expansion and plastic deformation of the pipe sections 36, at least one pipe section 36e within the trench 16b is adapted to provide an indication of the radial expansion and plastic deformation of pipe sections within the trench 16b. In an exemplary embodiment, the indication may be a visual indication and/or a pressure indication. For example, the pipe section 36e may be coated with a stress sensitive coating that changes color when strained. For example, the pipe section 36e may include one or more perforations such that a noticeable pressure drop may be observed when the pipe section 36 is radially expanded and plastically deformed.

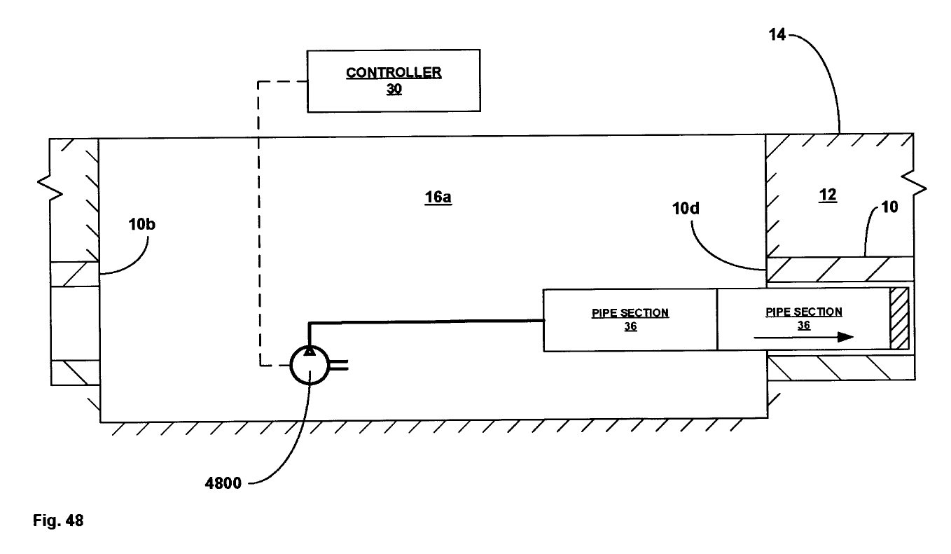

Referring FIG. 48, in an exemplary embodiment, during operation of the method of FIGS. 1-24 described above, during the insertion of the pipe sections 36 into the pipeline, an end plate 4800 is coupled to an end of the pipe sections 36 and outlet of a pump 4800, under the control of the controller 30, is operably directed into an open end of an end most one of the pipe sections extending into the trench 16a. In this manner, the fluid pressure directed into the open end of the end most of the pipe sections 36 within the trench 16a drives the pipe sections into the pipeline 10.

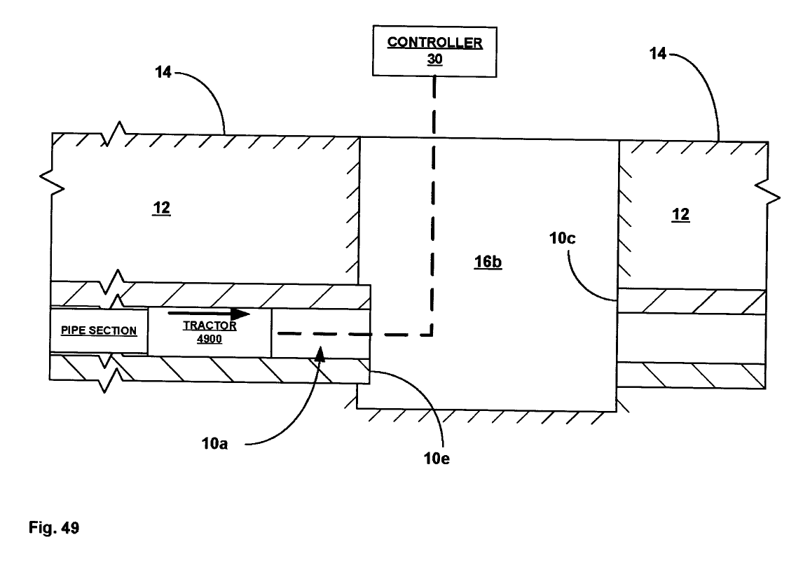

Referring FIG. 49, in an exemplary embodiment, during operation of the method of FIGS. 1-24 described above, during the insertion of the pipe sections 36 into the pipeline, an end of a conventional tractor 4900, under the control of the controller 30, is coupled to an end of the pipe sections 36 operated to pull the pipe sections through the interior of the pipeline 10.

Referring FIG. 50, in an exemplary embodiment, during operation of the method of FIGS. 1-24 described above, at least a portion of the pipeline 10 is lined with a plurality of pipe sections, 5002 and 5004, that are substantially identical to the pipe sections 36. In this manner, the pipeline 10 may be lined with a multi-layer liner whose collapse strength may thereby be adjusted by varying the number and type of liners installed within the pipeline.

In an exemplary embodiment, the radial expansion and plastic deformation of the pipe sections 5002 and 5004 into engagement with the pipeline 10 results in a resulting pipeline assembly, including the combination of the pipeline and the radially expanded and plastically deformed pipe sections, having a capacity to convey fluidic materials such as, for example, natural gas and/or fuel oil, at increased operating pressures and/or flow rates versus the pipeline 10 by itself. In this manner, the present exemplary embodiments provide a methodology for up-rating preexisting underground pipelines to convey fluidic materials at increased flow rates and/or operating pressures. In an exemplary embodiment, the up-rating of the pipeline 10 may be provided with or without any radial deformation of the pipeline.

Referring FIG. 51, in an exemplary embodiment, during operation of the method of FIGS. 1-24 described above, a coiled tubing 5100 may be installed in the pipeline 10 using a conventional pipe reel 5102 under the control of the controller 30. In this manner, a seamless liner may be used and thereby the need to weld together pipe sections may be eliminated.

In an exemplary embodiment, the tubing 5100 may be fabricated from one or more of the following: metallic materials, non-metallic materials, plastics, composites, ceramics, porous materials, non-porous materials, perforated materials, non-perforated materials, and/or hardenable fluidic materials.

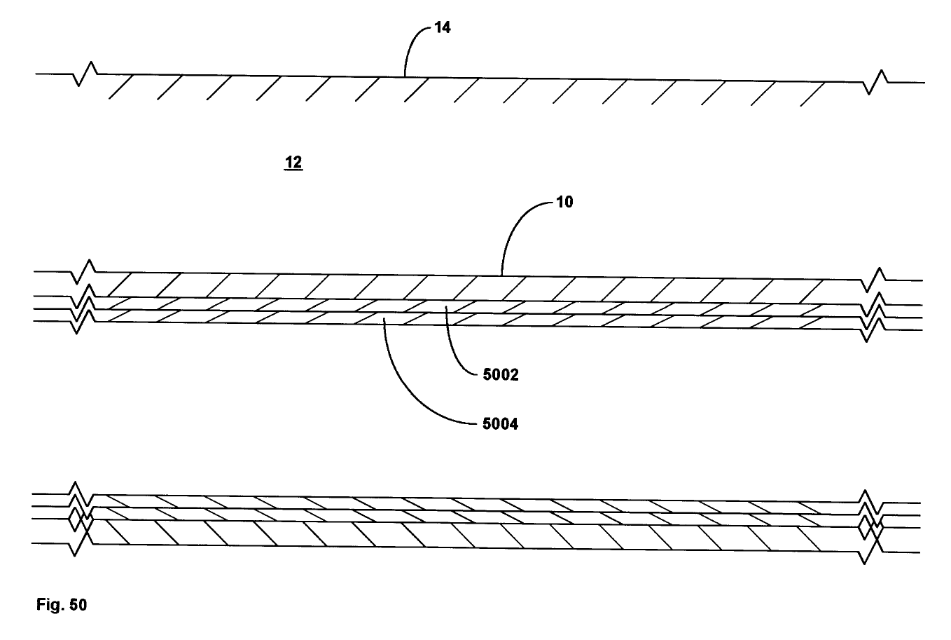

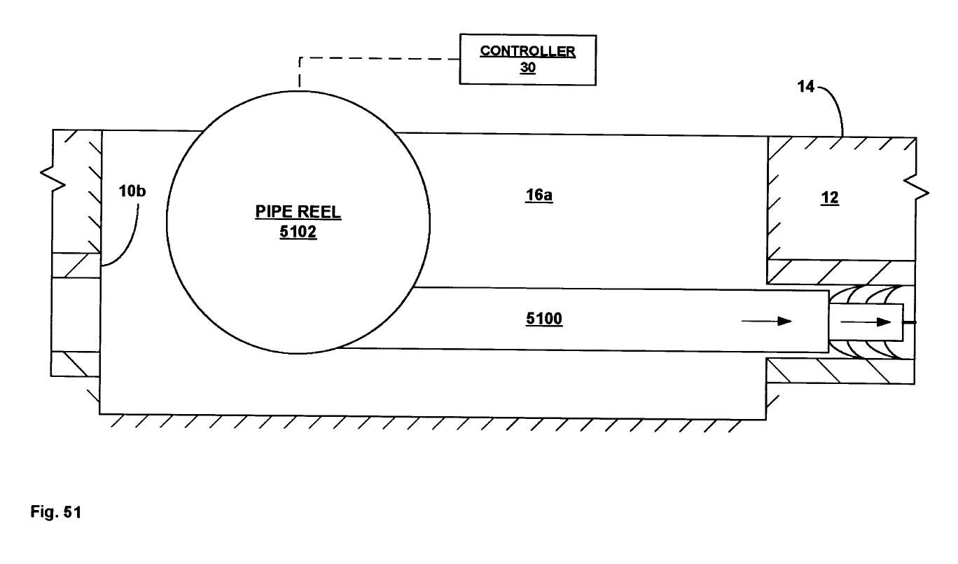

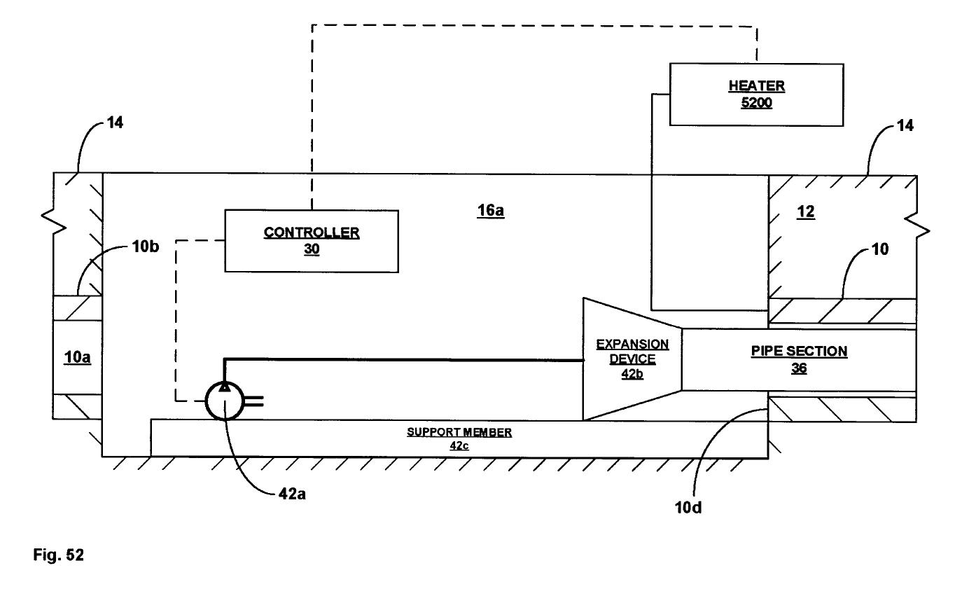

Referring FIG. 52, in an exemplary embodiment, during operation of the method of FIGS. 1-24 described above, a heater 5200 may be operated by the controller 30 to heat the pipeline 10 during the radial expansion and plastic deformation of the pipe sections 36. In an exemplary embodiment, upon the completion of the radial expansion and plastic deformation of the pipe sections 36, the operation of the heater 5200 may be stopped by the controller 30. As a result, during the radial expansion and plastic deformation of the pipe sections 36, the heated pipeline 10 will radially expand in size. Following the completion of the radial expansion and plastic deformation of the pipe sections 36, the pipeline 10 will then cool and thereby shrink. As a result, the joint between the pipeline 10 and the radially expanded and plastically deformed pipe sections 36 will be an interference fit.

In an exemplary embodiment, more generally, energy such as, for example, thermal energy, acoustic energy, or electrical energy may be injected into the pipeline 10 and/or the pipe sections 36 during the radial expansion and plastic deformation of the pipe sections in order to facilitate the radial expansion of the pipeline. In this manner, in an exemplary embodiment, an interference fit may be formed between the pipeline 10 and the pipe sections 36 such that the pipeline remaining in circumferential tension and the pipe sections remain in circumferential compression following the completion of the radial expansion process.

In an exemplary embodiment, the injection of the energy into the pipeline 10 may also facilitate the rupture of the pipeline during the radial expansion and plastic deformation of the pipe sections 36. In this manner, the amount of energy required to radially expand and plastically deform the pipe sections 36 may be reduced.

Referring FIG. 53, in an exemplary embodiment, during operation of the method of FIGS. 1-24 described above, the pipe sections 36 may be radially expanded at both ends.

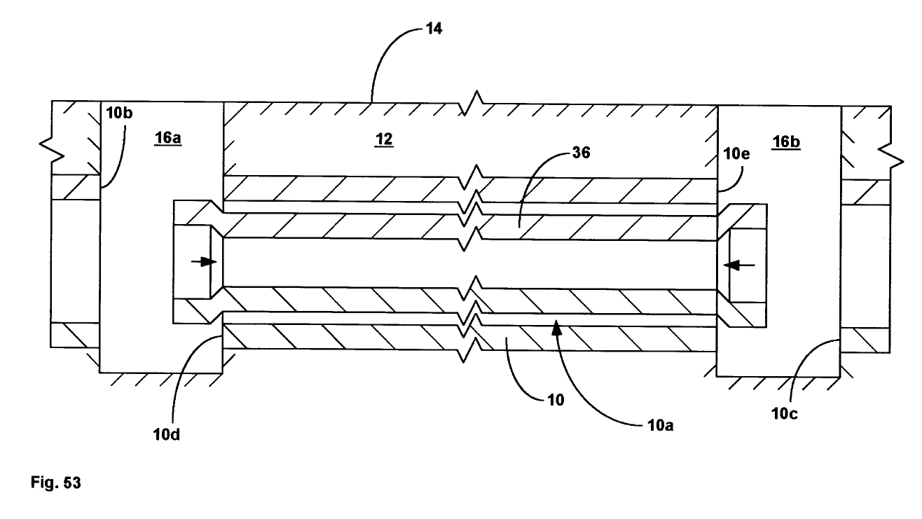

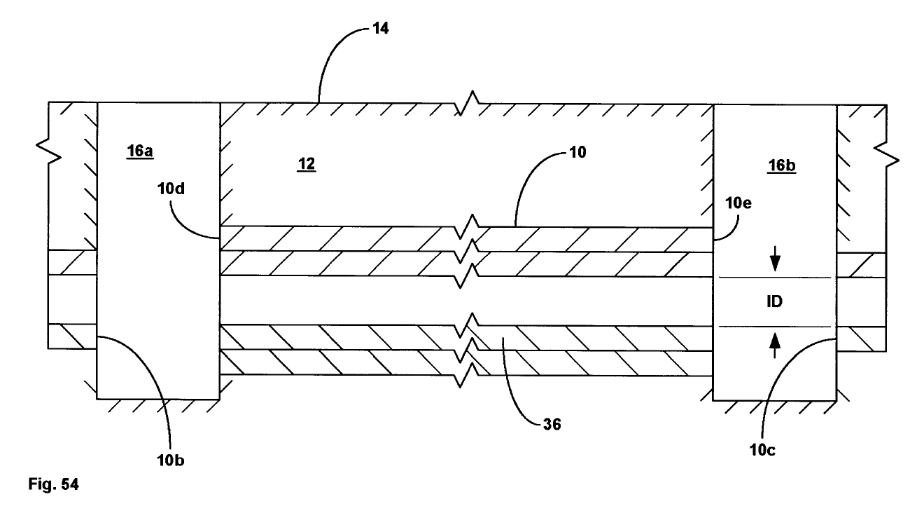

Referring to FIG. 54, in an exemplary embodiment, during operation of the method of FIGS. 1-24 described above, portions of the pipeline 10 between the trenches 16a and 16b is also radially expanded. In an exemplary embodiment, the inside diameter of the radially expanded pipe sections 36 is substantially equal to the inside diameter of the portions, 10b and 10c, of the pipeline 10. In this manner, the cross sectional area of the pipeline 10 following the repair is substantially equal to the cross sectional area of the pipeline prior to the repair.

In an exemplary embodiment, one or more of the pipe sections, 36 and/or 5100, may include perforations.

In an exemplary embodiment, one or more of the pipe sections, 36 and/or 5100, may include spirally wound elements.

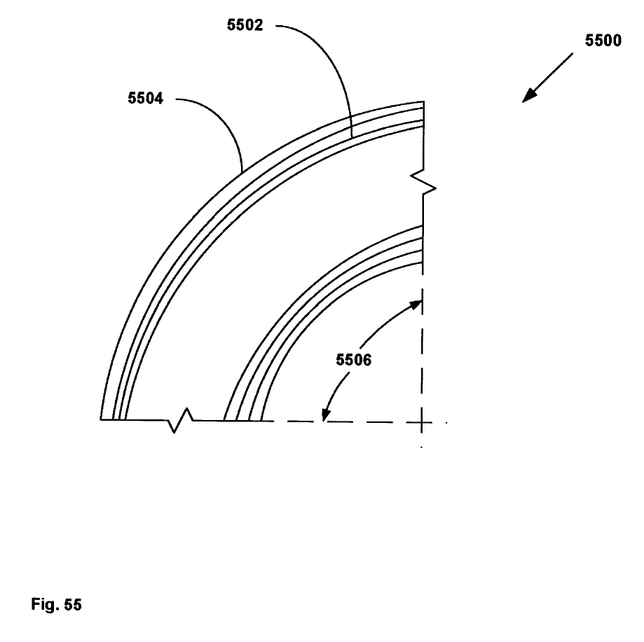

In an exemplary experimental embodiment, as illustrated in FIG. 55, three-dimensional (“3D”) finite element analyses (“FEA”) using a conventional FEA software program, that was predicative of actual experimental results, was performed using a model 5500 in which a tubular member 5502 was: 1) inserted into an outer tubular member 5504 having a bend radius 5506; and then 2) the tubular member 5502 was radially expanded and plastically deformed within the outer tubular member 5504 by displacing a solid expansion cone through the tubular member 5502 using fluid pressure that generated the following tabular results for model cases 5500A, 5500B, 5500C, 5500D, and 5500E:

| | | | | Friction Coefficient | | | |
|---|---|---|---|---|---|---|---|
| | | | | Between The | Friction Coefficient | | |
| | | | | Tubular Member 5502 | Between The Expansion | | |
| | | | | and the Tubular | Cone and the | | |
| | | | | Member 5504 | Tubular Member 5502 | Percent | |
| | | | | During Insertion | During The | Radial | |
| | | | | Of The Tubular | Displacement Of | Expansion | |
| | Insertion | Expansion | Expansion | Member 5502 | The Expansion Cone | Of The | Bend |
| Model | Force | Force | Pressure | Within the | Relative To the | Tubular Member | Radius |
| Case | (Kips) | (Kips) | (psi) | Tubular Member 5504 | Tubular Member 5502 | 5502 (%) | 5506 |
| 5500A | 54.1 | 393.4 | 3421 | 0.20 | 0.13 | 20.0 | 20 Degrees |
| 5500B | 38.8 | 299.0 | 2600 | 0.13 | 0.07 | 20.0 | 20 Degrees |
| 5500C | 71.9 | 321.5 | 2796 | 0.20 | 0.13 | 15.0 | 20 Degrees |
| 5500D | 30.8 | 393.4 | 3421 | 0.20 | 0.13 | 20.0 | 30 Degrees |
| 5500E | 128.7 | 854.3 | 7429 | 0.20 | 0.13 | 20.0 | 20 Degrees |

Case 5500A was the base case which simulated actual laboratory testing conditions. For case 5500A, the wall thickness of the tubular member 5500 was 0.307″. Due to the higher friction coefficients used in case 5500A, the predicted expansion forces and pressures were much higher than the laboratory test results.

Case 5500B was substantially identical to case 5500A except that the coefficient of friction between the expansion cone and the tubular member 5502 was reduced from 0.13 to 0.07. Case 5500B had lower friction coefficients than case 5500A. And, as expected, the expansion pressure and forces for case 5500B were much lower than for case 5500A. The laboratory test had an expansion pressure of 2030 psi compared to 2600 psi for case 5500B. The higher predicted pressure for case 5500B was also due to the addition of an outer layer of a subterranean formation that was simulated in case 5500B that added a restraining condition to the outer tubular member 5504 in case 5500B.

Case 5500C was substantially identical to case 5500A except that the diametrical clearance between the tubular members, 5500 and 5502, was reduced and the percentage of the radial expansion of the tubular member 5500 was reduced from 20% to 15%. Because case 5500C had a smaller diametrical clearance between the inner tubular member 5502 and the outer tubular member 5504, the possible percentage radial expansion ratio for the inner tubular member 5502 was lower. The expansion pressures and forces were also lower than for case 5500A.

Case 5500D was substantially identical to case 5500A, except that the bend radius 5506 of the tubular member 5504 was increased from 20 degrees to 30 degrees. Note that the expansion pressure and force for case 5500D was substantially the same as for case 5500A. This experimental result indicated that the dimension of the bend radius 5506 had no effect on the expansion pressure. This was an unexpected result.

Case 5500E was substantially identical to case 5500A, except that the wall thickness of the tubular member 5502 was increased from 0.307″ to 0.625″. Case 5500E had the highest insertion force and expansion pressure due to the thick wall thickness of the tubular member 5502.

Further graphical results for cases 5500A, 5500B, 5500C, 5500D, and 5500E are presented in FIGS. 56 and 57. Note that the expansion force for case 5500D was substantially the same as for case 5500A. This experimental result indicated that the dimension of the bend radius 5506 had no effect on the expansion pressure. This was an unexpected result.

Based upon the experimental results for cases 5500A, 5500B, 5500C, 5500D, and 5500E, the following observations can be made: the bend radius 5506 has an effect on the insertion force but does not affect the expansion force or pressure. This was an unexpected result. Furthermore, this indicates that the systems of the present illustrative embodiments may be operated to radially expand a given tubular member positioned within an outer tubular member using substantially constant expansion forces and/or pressures for any bend radius or combination of bend radiuses of the outer tubular member. In addition, the unexpected exemplary experimental results further indicated that the radial expansion and plastic deformation of the pipe section 36 within a pipeline 10 having one or more bend radiuses was both feasible and commercially viable.

In an exemplary experimental embodiment, three-dimensional (“3D”) finite element analyses (“FEA”) using a conventional FEA software program, that was predicative of actual experimental results, were performed using models 5800A and 5800B, each having an inner tubular member 5802 and an outer tubular member 5804 having the following properties:

Inner Tubular Member 5802

| Property | Value | Unit | Value | Unit |
|---|---|---|---|---|
| Outer diameter | 11.25 | in | 285.7 | mm |
| Inner diameter | 10 | in | 254.0 | mm |
| Linear weight | 64.43 | lb/ft | | |
| Wall thickness | 0.625 | in | 15.87 | mm |
| (Dlt) - ratio | 18 | — | — | — |
| Cross section area | 20.86 | in² | 13458 | mm² |
| Yield strength | 42 | ksi | 289 | MPa |
| Ultimate strength | 60 | ksi | 413 | MPa |

Outer Tubular Member 5804

| Property | Value | Unit | Value | Unit |
|---|---|---|---|---|
| Inner diameter | 12 | in | 304.8 | mm |
| Outer diameter | 12.78 | in | 305.5 | mm |
| Wall thickness | 0.394 | in | 10 | mm |
| Yield strength | 42 | ksi | 289 | MPa |
| Ultimate strength | 60 | ksi | 413 | MPa |
| Ultimate burst | 3820 | psi | 26 | MPa |

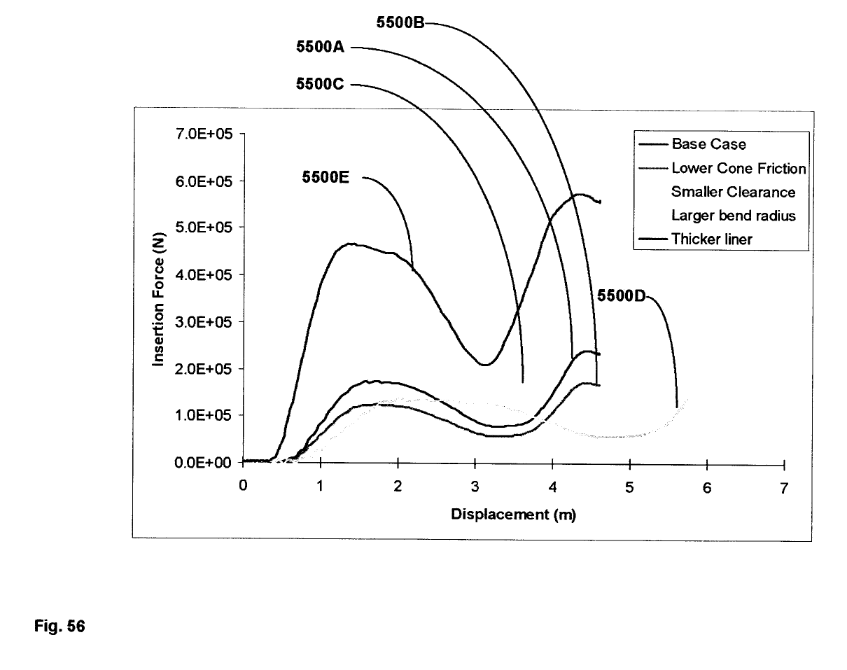

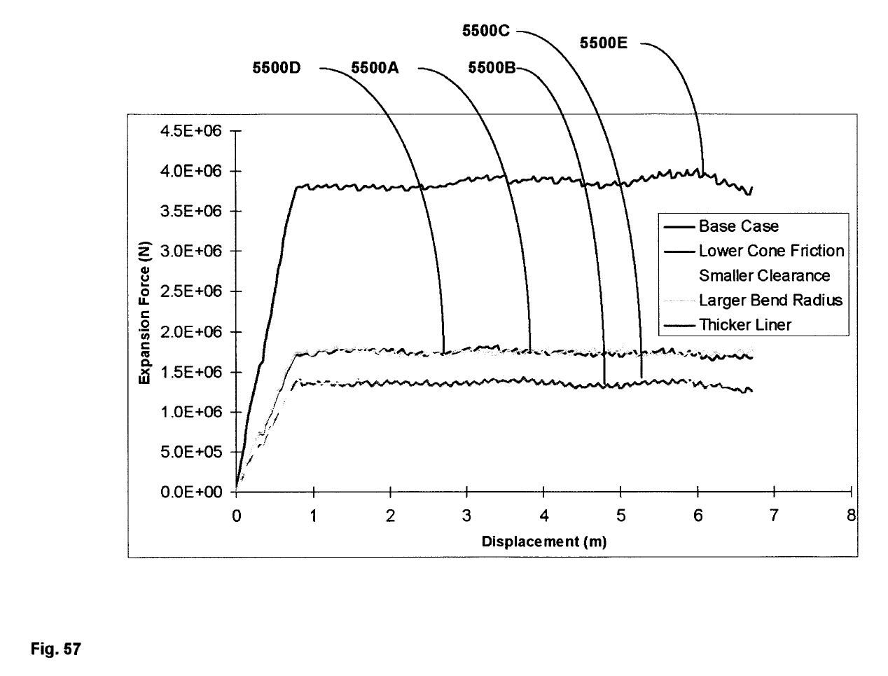

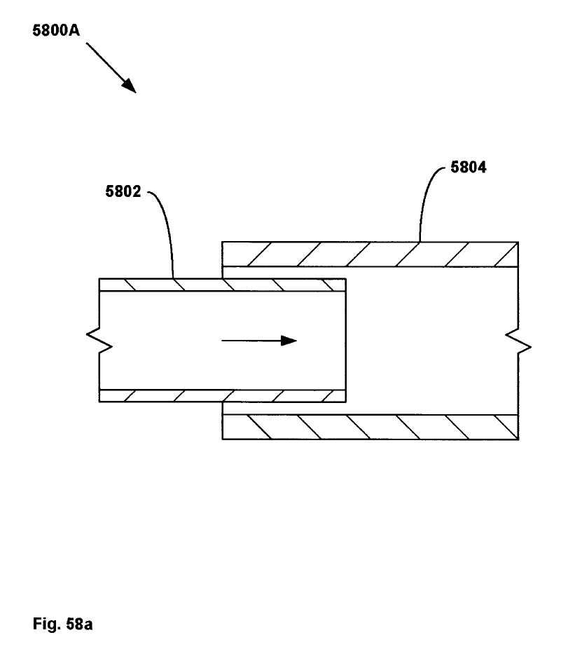

In a model 5800A, as illustrated in FIG. 58a, the inner tubular member 5802 was inserted into the outer tubular member 5804 in which the outer tubular member 5804 did not include any bend radius.

In model 5800B, as illustrated in FIG. 58b, the inner tubular member 5802 was inserted into the outer tubular member 5804 in which the outer tubular member 5804 included a curved portion 5804a. In the model 5800B, as illustrated in FIG. 58c, the curved portion 5804a of the outertubular member 5804 was approximately parabolic and includes a maximum radius of curvature of about 20 degrees.

In an exemplary embodiment, the model 5800A was experimentally tested with the following variations, which resulted in the following experimental results:

Model 5800A

| | | Floating the Inner | | |
|---|---|---|---|---|
| | Coefficient of | Tubular Member 5802 | | |
| | Friction Between | within the Outer | Wall | |
| | the Inner Tubular | Tubular Member 5804 | Thickness | |
| | Member 5802 | During the Insertion | of the | |
| Version | and the Outer | of the Inner Tubular | Inner Tubular | Insertion |
| of | Tubular Member | Member 5802 into the | Member 5802 | Force |
| Model | 5804 | Outer Tubular Member 5804 | (inches) | (klbf) |
| 5800A1 | 0.2 | No | ⅝ inches | 99.4 |
| 5800A2 | 0.3 | No | ⅝ inches | 149.1 |
| 5800A3 | 0.1 | No | ⅝ inches | 58.2 |
| 5800A4 | 0.2 | Yes | ⅝ inches | 39.0 |
| 5800A5 | 0.2 | No | ⅜ inches | 58.2 |

In an exemplary embodiment, the model 5800B was experimentally tested with the following variations, which resulted in the following experimental results:

Model 5800B

| | | Floating the Inner | | | |
|---|---|---|---|---|---|
| | | Tubular Member 5802 | | | |
| | Coefficient of | within the Outer | | Insertion | Insertion |
| | Friction Between | Tubular Member 5804 | | Force - | Force - |
| | the Inner Tubular | During the Insertion | Wall | excluding | including |
| | Member 5802 | of the Inner Tubular | Thickness | bends in | bends in |
| | and the Outer | Member 5802 into | of the Inner | the outer | the outer |
| Version | Tubular | the Outer Tubular | Tubular Member | Tubular Member | Tubular Member |
| of Model | Member 5804 | Member 5804 | 5802 (inches) | 5804 (klbf) | 5804 (klbf) |
| 5800B1 | 0.2 | No | +E,frac 5/8 inches | 57 | 225 |
| 5800B2 | 0.3 | No | +E,frac 5/8 inches | 86 | 281 |
| 5800B3 | 0.1 | No | +E,frac 5/8 inches | 29 | 169 |
| 5800B4 | 0.2 | Yes | +E,frac 5/8 inches | 22 | 190 |
| 5800B5 | 0.2 | No | +E,frac 3/8 inches | 33 | 201 |

As the exemplary test results above for models, 5800A and 5800B, indicate, lowering the coefficient of friction between the inner and outer tubulars, 5802 and 5804, respectively, reduced the required insertion forces, floating the inner tubular member 5802 using a fluidic material during the insertion unexpectedly significantly reduced the required insertion forces, and reducing the wall thickness of the inner tubular member 5802, which effectively increased the diametrical clearance between the inner and outer tubulars, 5802 and 5804, respectively, reduced the required insertion forces.

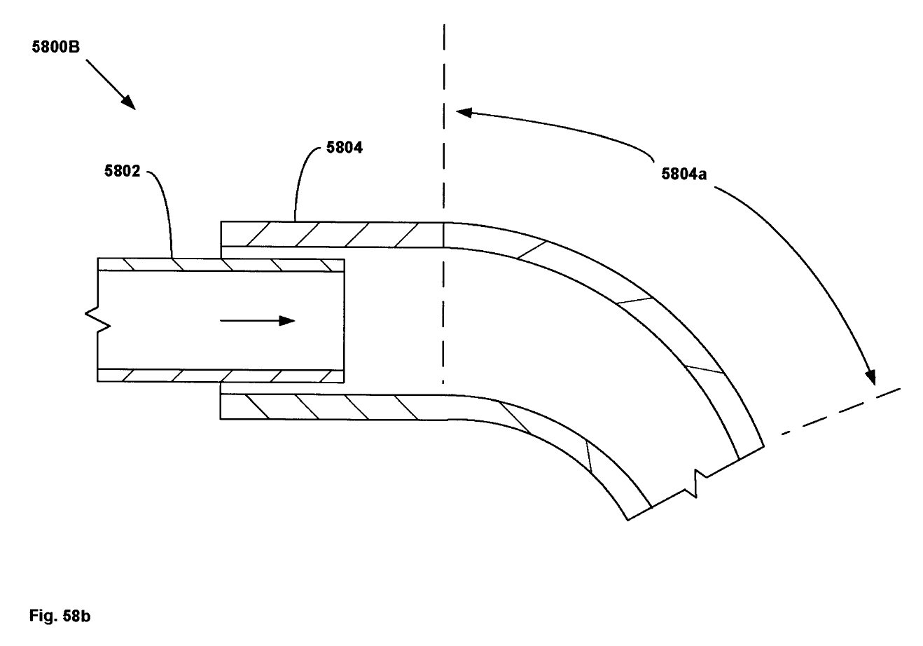

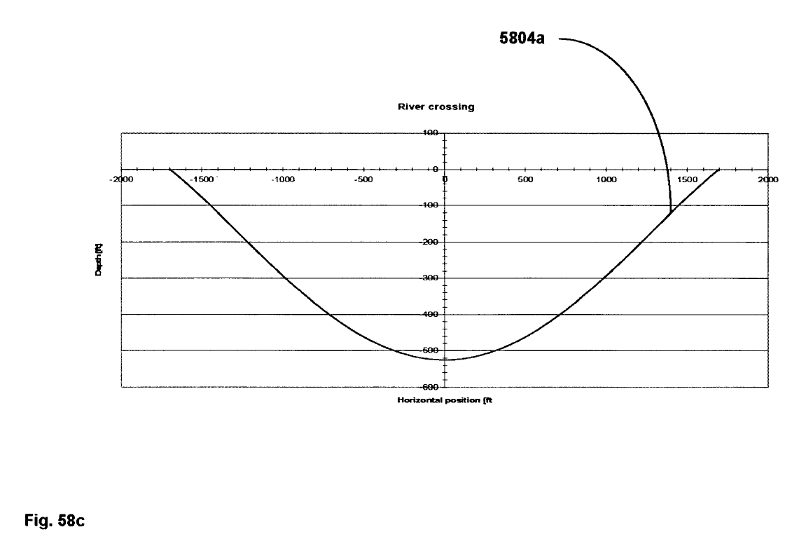

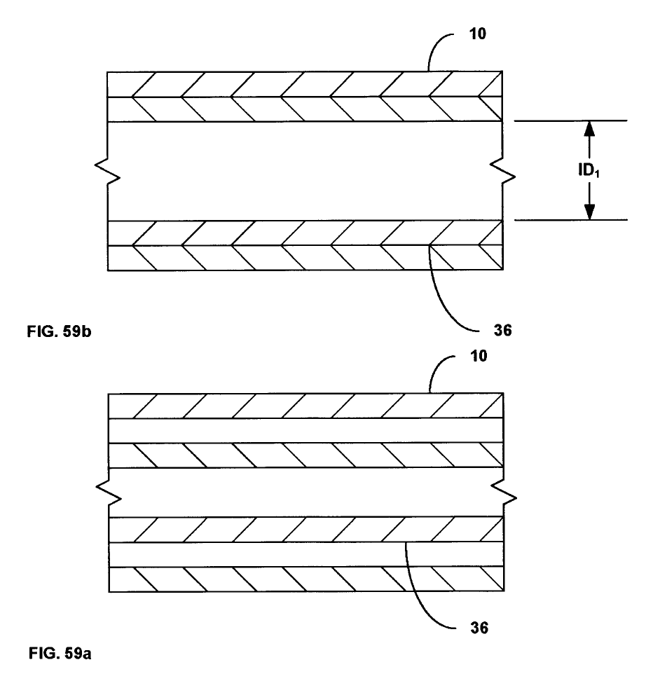

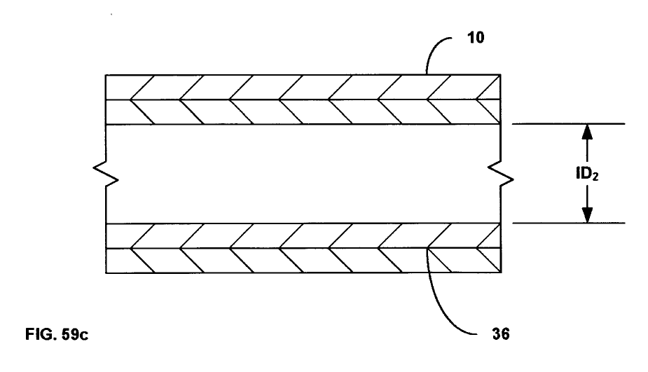

Referring to FIGS. 59a, 59b, and 59c, in an exemplary embodiment, one or more of the pipe sections 36 are positioned within the pipeline 10 and radially expanded and plastically deformed until they have an interior diameter ID₁. One or more of the pipe sections 36 may then be further radially expanded and plastically deformed until they have an interior diameter ID₂, where ID₂ is greater than ID₁. In an exemplary embodiment, the number of repeated radial expansion and plastic deformations of the pipe sections 36 may be greater than or equal to 2.

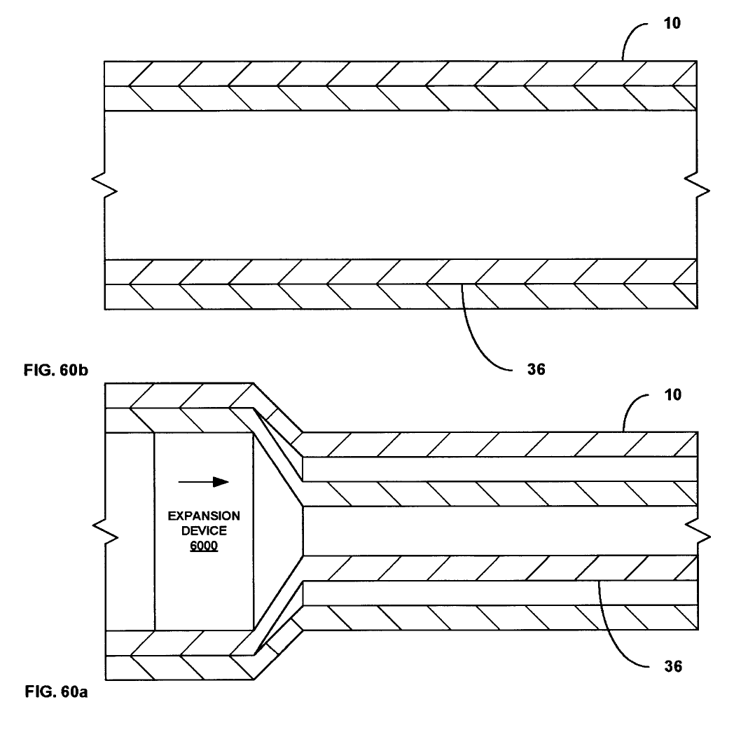

In an exemplary experimental embodiment, as illustrated in FIGS. 60a and 60b, a pipe section 36 was positioned within a pipeline 10, and then the pipe section and the pipeline were both radially expanded and plastically deformed by displacing an expansion device 6000 through the pipe section and the pipeline. In the exemplary experimental embodiment, the pipe section 36 and the pipeline 10 were both radially expanded and plastically deformed with the increase in the internal diameters ranging from about 29.6% to about 35.3%, for the pipe section 36, and from about 12.1% to about 12.9%, for the pipeline 10. These were unexpected results.

In a further exemplary experimental embodiment, in which the expansion device 6000 was displaced using fluid pressure, the pipe section 36 and the pipeline 10 were both radially expanded and plastically deformed with the increase in the internal diameter for the pipe section 36 equal to about 29.4%. These were unexpected results.

In a further exemplary experimental embodiment, in which the pipeline 10 had a bend radius of about 20 degrees and the expansion device 6000 was displaced using fluid pressure, the pipe section 36 and the pipeline 10 were both radially expanded and plastically deformed with the increase in the internal diameter for the pipe section 36 equal to about 21.2% and the increase in the internal diameter of the pipeline equal to about 5.1%. The expansion pressure while radially expanding and plastically deforming the pipe section 36 and the pipeline 10 through the bent portion of the pipeline was only about 2.7% higher than the expansion pressure while radially expanding and plastically deforming the pipe section 36 and the pipeline 10 through the non-bent portions of the pipeline. This extremely small variation in the expansion pressure was an unexpected result.

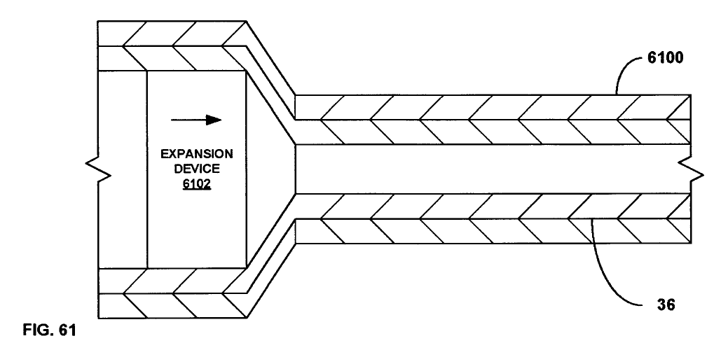

In an exemplary experimental embodiment, as illustrated in FIG. 61, a pipe section 36 having an outer coating 6100 was radially expanded and plastically deformed by displacing an expansion device 6102 through the pipe section. In several exemplary experimental embodiments, the outer coating 6100 was: a) Kersten coating Teflon; b) Kersten coating Halar; c) Kersten coating Rilan; d) Akzo Nobel Resicoat R5-726LD; e) Akzo Nobel Resicoat 500620; f) Akzo Nobel Resicoat 500644; g) Akzo Nobel Resicoat R5-105; h) Akzo Nobel Resicoat R6556; i) Akzo Nobel Resicoat 500536; or j) galvanized coating. In an exemplary experimental embodiment, following the radial expansion and plastic deformation of the pipe section 36, by up to about 27.5%, the following coatings 6100 maintained their bond to the exterior surface of the pipe section 36: a) Kersten coating Teflon; b) Kersten coating Halar; and c) Kersten coating Rilan. These were unexpected results. Furthermore, these unexpected exemplary experimental results demonstrated that using an abradable coating, which may provided lubrication and/or corrosion resistance, on the exterior surfaces of the pipe sections 36 was both feasible and commercially viable.

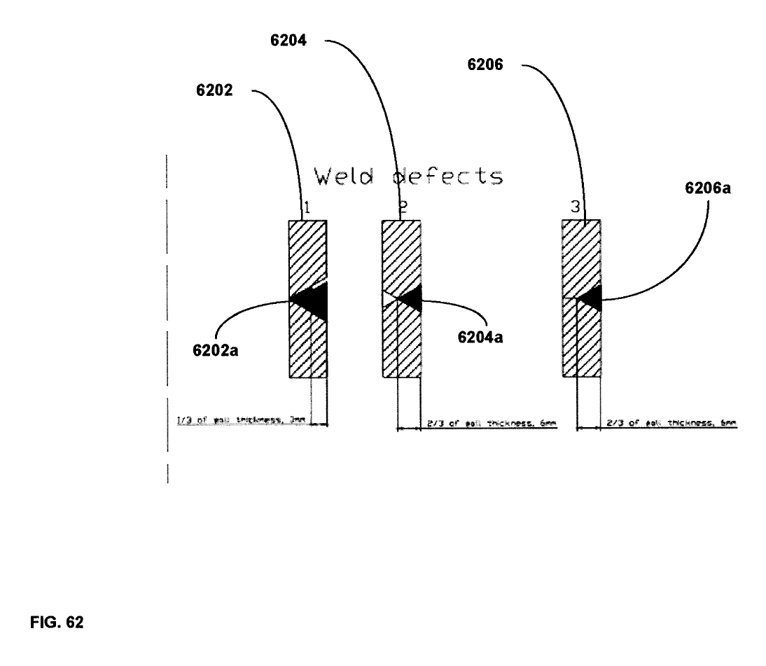

In an exemplary experimental embodiment, as illustrated in FIG. 62, pipe sections, 6202, 6204 and 6206, were manufactured having adjacent pipes coupled together by welded connections, 6202a, 6204a, and 6206a, respectively. In the exemplary experimental embodiment, each of the welded connections, 6202a, 6204a, and 6206a, include one or more defects. In particular, the welded connection 6202a was a butt weld that included a circumferential cut in the weld over a circumferential angle of 15 degrees, the welded connection 6204a included poor penetration of the welding material and a gap, and the welded connection 6206a included poor penetration of the welding material without a gap.

In an exemplary experimental embodiment, the welded connections 6202a, 6204a, and 6206a were radially expanded and plastically deformed by up to about 29.6%. In an exemplary embodiment, the radially expanded and plastically deformed welded connections, 6204a and 6206a, did not exhibit any failure due to the radial expansion and plastic deformation. This was an unexpected result. Furthermore, these unexpected exemplary experimental results demonstrated that radially expanding pipe sections 36 and/or a pipeline 10 having possibly inferior welded connections was both feasible and commercially viable. This was extremely important, particularly with respect to older pipelines 10 which may be of uncertain quality.

A method of repairing a damaged portion of an underground pipeline between first and second portions of the pipeline, the pipeline positioned within a subterranean formation below the surface of the earth has been described that includes: uncovering the first and second portions of the pipeline; removing portions of the first and second uncovered portions of the pipeline to permit access to the interior of the pipeline at the first and second access points within the pipeline; coupling pipe sections end to end; positioning the coupled pipe sections within the damaged portion of the pipeline; coupling an expansion device to the coupled pipe sections; and radially expanding and plastically deforming the coupled pipe sections within the damaged portion of the pipeline. In an exemplary embodiment, coupling pipe sections end to end comprises welding pipe sections end to end. In an exemplary embodiment, coupling pipe sections end to end comprises: heat treating the ends of the pipe sections. In an exemplary embodiment, coupling pipe sections end to end comprises: heat treating the ends of the pipe sections before welding. In an exemplary embodiment, coupling pipe sections end to end comprises: heat treating the ends of the pipe sections after welding. In an exemplary embodiment, coupling pipe sections end to end comprises: heat treating the ends of the pipe sections before and after welding. In an exemplary embodiment, coupling pipe sections end to end comprises: coating the exterior surfaces of the pipe sections. In an exemplary embodiment, coating the exterior surfaces of the pipe sections comprises: coating the exterior surfaces of the pipe sections with an abradable coating. In an exemplary embodiment, positioning the coupled pipe sections within the damaged portion of the pipeline comprises: pushing the coupled pipe sections into the damaged portion of the pipeline. In an exemplary embodiment, positioning the coupled pipe sections within the damaged portion of the pipeline comprises: pulling the coupled pipe sections into the damaged portion of the pipeline. In an exemplary embodiment, positioning the coupled pipe sections within the damaged portion of the pipeline comprises: pushing and pulling the coupled pipe sections into the damaged portion of the pipeline. In an exemplary embodiment, coupling an expansion device to the coupled pipe sections comprises: coupling a fluid powered expansion device to an end of the coupled pipe sections. In an exemplary embodiment, radially expanding and plastically deforming the coupled pipe sections within the damaged portion of the pipeline comprises: energizing the expansion device. In an exemplary embodiment, one or more of the pipe sections comprise: a tubular member having a corrugated cross-section. In an exemplary embodiment, radially expanding and plastically deforming the coupled pipe sections within the damaged portion of the pipeline comprises: radially expanding and plastically deforming the coupled pipe sections into engagement with the damaged portion of the pipeline. In an exemplary embodiment, the cross sectional area of the radially expanded and plastically deformed pipe sections are substantially equal to the cross sectional area of the damaged portion of the pipeline prior to radially expanding and plastically deforming the coupled pipe sections. In an exemplary embodiment, one or more of the pipe sections comprise: one or more sealing members coupled to an exterior surface of the pipe sections for engaging the damaged portion of the pipeline. In an exemplary embodiment, the expansion device comprises: a fixed expansion device. In an exemplary embodiment, the expansion device comprises: an adjustable expansion device. In an exemplary embodiment, the expansion device comprises: a fixed expansion device and an adjustable expansion device. In an exemplary embodiment, the expansion device comprises: an expansion device; and an actuator for displacing the expansion device relative to the pipe sections. In an exemplary embodiment, the actuator comprises: an actuator for pushing the expansion device through the pipe sections. In an exemplary embodiment, the actuator comprises: an actuator for pulling the expansion device through the pipe sections. In an exemplary embodiment, the actuator comprises: an actuator for rotating the expansion device through the pipe sections. In an exemplary embodiment, positioning the coupled pipe sections within the damaged portion of the pipeline comprises: vibrating the pipe sections. In an exemplary embodiment, positioning the coupled pipe sections within the damaged portion of the pipeline comprises: plastically deforming the coupled pipe sections within the damaged portion of the pipeline. In an exemplary embodiment, the expansion device comprises: a source of vibration proximate the expansion device. In an exemplary embodiment, the expansion device comprises: a rotary expansion device. In an exemplary embodiment, an interior surface of one or more of the pipe sections comprises: a lubricant coating. In an exemplary embodiment, radially expanding and plastically deforming the coupled pipe sections within the damaged portion of the pipeline comprises: hydroforming the coupled pipe sections within the damaged portion of the pipeline. In an exemplary embodiment, radially expanding and plastically deforming the coupled pipe sections within the damaged portion of the pipeline comprises: explosively forming the coupled pipe sections within the damaged portion of the pipeline. In an exemplary embodiment, radially expanding and plastically deforming the coupled pipe sections within the damaged portion of the pipeline comprises: indicating an end of the radial expansion and plastic deformation of the coupled pipe sections within the damaged portion of the pipeline. In an exemplary embodiment, positioning the coupled pipe sections within the damaged portion of the pipeline comprises: rotating the pipe sections. In an exemplary embodiment, positioning the coupled pipe sections within the damaged portion of the pipeline comprises: pulling on an end of the pipe sections using a vehicle positioned within the pipeline. In an exemplary embodiment, positioning the coupled pipe sections within the damaged portion of the pipeline comprises: floating the pipe sections within the pipeline. In an exemplary embodiment, positioning the coupled pipe sections within the damaged portion of the pipeline comprises: carrying the pipe sections on rollers through the pipeline. In an exemplary embodiment, positioning the coupled pipe sections within the damaged portion of the pipeline comprises: carrying the pipe sections on dissolvable rollers through the pipeline.

A method of repairing a damaged portion of an underground pipeline between first and second portions of the pipeline, the pipeline positioned within a subterranean formation below the surface of the earth, has been described that includes: uncovering the first and second portions of the pipeline; removing portions of the first and second uncovered portions of the pipeline to permit access to the interior of the pipeline at the first and second access points within the pipeline; heat treating ends of pipe sections; welding the pipe sections end to end; heat treating the welded ends of the pipe sections; coating the exterior of the welded pipe sections with an abradable coating; gripping the pipe sections and pushing the welded pipe sections into the damaged portion of the pipeline; pulling the welded pipe sections into the damaged portion of the pipeline; coupling an expansion device to an end of the welded pipe sections; and pressurizing an interior portion of the expansion device to displace an expansion cone through the welded pipe sections to radially expand and plastically deform the welded pipe sections into engagement with the damaged portion of the pipeline.

A method of repairing a damaged portion of an underground pipeline, the pipeline positioned within a subterranean formation below the surface of the earth, has been described that includes determining the location of the damaged portion of the underground pipeline; and radially expanding and plastically deforming one or more pipe sections within the damaged portion of the pipeline. In an exemplary embodiment, radially expanding and plastically deforming one or more pipe sections within the damaged portion of the pipeline comprises: moving an expansion device within the pipeline to a position proximate the damaged portion of the pipeline; and then radially expanding and plastically deforming one or more pipe sections within the damaged portion of the pipeline.

A system for repairing a damaged portion of an underground pipeline between first and second portions of the pipeline, the pipeline positioned within a subterranean formation below the surface of the earth, has been described that includes means for uncovering the first and second portions of the pipeline; means for removing portions of the first and second uncovered portions of the pipeline to permit access to the interior of the pipeline at the first and second access points within the pipeline; means for coupling pipe sections end to end; means for positioning the coupled pipe sections within the damaged portion of the pipeline; means for coupling an expansion device to the coupled pipe sections; and means for radially expanding and plastically deforming the coupled pipe sections within the damaged portion of the pipeline. In an exemplary embodiment, means for coupling pipe sections end to end comprises: means for welding pipe sections end to end. In an exemplary embodiment, means for coupling pipe sections end to end comprises: means for heat treating the ends of the pipe sections. In an exemplary embodiment, means for coupling pipe sections end to end comprises: means for heat treating the ends of the pipe sections before welding. In an exemplary embodiment, means for coupling pipe sections end to end comprises: means for heat treating the ends of the pipe sections after welding. In an exemplary embodiment, means for coupling pipe sections end to end comprises: means for heat treating the ends of the pipe sections before and after welding. In an exemplary embodiment, means for coupling pipe sections end to end comprises: means for coating the exterior surfaces of the pipe sections. In an exemplary embodiment, means for coating the exterior surfaces of the pipe sections comprises: means for coating the exterior surfaces of the pipe sections with an abradable coating. In an exemplary embodiment, means for positioning the coupled pipe sections within the damaged portion of the pipeline comprises: means for pushing the coupled pipe sections into the damaged portion of the pipeline. In an exemplary embodiment, means for positioning the coupled pipe sections within the damaged portion of the pipeline comprises: means for pulling the coupled pipe sections into the damaged portion of the pipeline. In an exemplary embodiment, means for positioning the coupled pipe sections within the damaged portion of the pipeline comprises: means for pushing and pulling the coupled pipe sections into the damaged portion of the pipeline. In an exemplary embodiment, means for coupling an expansion device to the coupled pipe sections comprises: means for coupling a fluid powered expansion device to an end of the coupled pipe sections. In an exemplary embodiment, means for radially expanding and plastically deforming the coupled pipe sections within the damaged portion of the pipeline comprises: means for energizing the expansion device. In an exemplary embodiment, one or more of the pipe sections comprise: a tubular member having a corrugated cross-section. In an exemplary embodiment, means for radially expanding and plastically deforming the coupled pipe sections within the damaged portion of the pipeline comprises: means for radially expanding and plastically deforming the coupled pipe sections into engagement with the damaged portion of the pipeline. In an exemplary embodiment, the cross sectional area of the radially expanding and plastically deformed pipe sections are substantially equal to the cross sectional area of the damaged portion of the pipeline prior to radially expanding and plastically deforming the coupled pipe sections. In an exemplary embodiment, one or more of the pipe sections comprise: one or more sealing members coupled to an exterior surface of the pipe sections for engaging the damaged portion of the pipeline. In an exemplary embodiment, the expansion device comprises: a fixed expansion device. In an exemplary embodiment, the expansion device comprises: an adjustable expansion device. In an exemplary embodiment, the expansion device comprises: a fixed expansion device and an adjustable expansion device. In an exemplary embodiment, the expansion device comprises: an expansion device; and an actuator for displacing the expansion device relative to the pipe sections. In an exemplary embodiment, the actuator comprises: an actuator for pushing the expansion device through the pipe sections. In an exemplary embodiment, the actuator comprises: an actuator for pulling the expansion device through the pipe sections. In an exemplary embodiment, the actuator comprises: an actuator for rotating the expansion device through the pipe sections. In an exemplary embodiment, means for positioning the coupled pipe sections within the damaged portion of the pipeline comprises: means for vibrating the pipe sections. In an exemplary embodiment, means for positioning the coupled pipe sections within the damaged portion of the pipeline comprises: means for plastically deforming the coupled pipe sections within the damaged portion of the pipeline. In an exemplary embodiment, the expansion device comprises: a source of vibration proximate the expansion device. In an exemplary embodiment, the expansion device comprises: a rotary expansion device. In an exemplary embodiment, an interior surface of one or more of the pipe sections comprises: a lubricant coating. In an exemplary embodiment, means for radially expanding and plastically deforming the coupled pipe sections within the damaged portion of the pipeline comprises: means for hydroforming the coupled pipe sections within the damaged portion of the pipeline. In an exemplary embodiment, means for radially expanding and plastically deforming the coupled pipe sections within the damaged portion of the pipeline comprises: means for explosively forming the coupled pipe sections within the damaged portion of the pipeline. In an exemplary embodiment, means for radially expanding and plastically deforming the coupled pipe sections within the damaged portion of the pipeline comprises: means for indicating an end of the radial expansion and plastic deformation of the coupled pipe sections within the damaged portion of the pipeline. In an exemplary embodiment, means for positioning the coupled pipe sections within the damaged portion of the pipeline comprises: means for rotating the pipe sections. In an exemplary embodiment, means for positioning the coupled pipe sections within the damaged portion of the pipeline comprises: means for pulling on an end of the pipe sections using a vehicle positioned within the pipeline. In an exemplary embodiment, means for positioning the coupled pipe sections within the damaged portion of the pipeline comprises: means for floating the pipe sections within the pipeline. In an exemplary embodiment, means for positioning the coupled pipe sections within the damaged portion of the pipeline comprises: means for carrying the pipe sections on rollers through the pipeline. In an exemplary embodiment, means for positioning the coupled pipe sections within the damaged portion of the pipeline comprises: means for carrying the pipe sections on dissolvable rollers through the pipeline.

A system for repairing a damaged portion of an underground pipeline between first and second portions of the pipeline, the pipeline positioned within a subterranean formation below the surface of the earth, has been described that includes means for uncovering the first and second portions of the pipeline; means for removing portions of the first and second uncovered portions of the pipeline to permit access to the interior of the pipeline at the first and second access points within the pipeline; means for heat treating ends of pipe sections; means for welding the pipe sections end to end; means for heat treating the welded ends of the pipe sections; means for coating the exterior of the welded pipe sections with an abradable coating; means for gripping the pipe sections and pushing the welded pipe sections into the damaged portion of the pipeline; means for pulling the welded pipe sections into the damaged portion of the pipeline; means for coupling an expansion device to an end of the welded pipe sections; and means for pressurizing an interior portion of the expansion device to displace an expansion cone through the welded pipe sections to radially expand and plastically deform the welded pipe sections into engagement with the damaged portion of the pipeline.

A system for repairing a damaged portion of an underground pipeline, the pipeline positioned within a subterranean formation below the surface of the earth, has been described that includes means for determining the location of the damaged portion of the underground pipeline; and means for radially expanding and plastically deforming one or more pipe sections within the damaged portion of the pipeline. In an exemplary embodiment, means for radially expanding and plastically deforming one or more pipe sections within the damaged portion of the pipeline comprises: means for moving an expansion device within the pipeline to a position proximate the damaged portion of the pipeline; and means for then radially expanding and plastically deforming one or more pipe sections within the damaged portion of the pipeline.

An underground pipeline has been described that includes a radially expanded pipeline; and a radially expanded and plastically deformed tubular liner positioned within and coupled to the pipeline. In an exemplary embodiment, the pipeline comprises a first portion that is radially expanded and a second portion that is not radially expanded; and wherein an inside diameter of the liner is substantially equal to an inside diameter of the second portion of the pipeline.

A method of joining a second tubular member to a first tubular member in a pipeline, the first tubular member having an inner diameter greater than an outer diameter of the second tubular member, has been described that includes positioning an expansion device within an interior region of the second tubular member; pressurizing a portion of the interior region of the second tubular member; and radially expanding and plastically deforming the second tubular member using the expansion device into engagement with the first tubular member; wherein an interface between the expansion device and the second tubular member does not include a fluid tight seal.

A method of fluidicly isolating a section of pipeline tubing has been described that includes running a length of expandable tubing into pipeline-lined borehole and positioning the expandable tubing across a section of pipeline to be fluidicly isolated; and plastically deforming at least one portion of the expandable tubing to increase the diameter of the portion to sealingly engage the pipeline to be fluidicly isolated by displacing an expansion device therethrough in the longitudinal direction.

An apparatus for expanding a tubular liner in a pipeline has been described that includes a support member; an expansion device coupled to the support member; a tubular liner coupled to the expansion device; and a shoe coupled to the tubular liner, the shoe defining a passage; wherein the interface between the expansion device and the tubular liner is not fluid tight.

A system for joining a second tubular member to a first tubular member in a pipeline, the first tubular member having an inner diameter greater than an outer diameter of the second tubular member, has been described that includes: means for positioning an expansion device within an interior region of the second tubular member; means for pressurizing a portion of the interior region of the second tubular member; and means for radially expanding and plastically deforming the second tubular member using the expansion device into engagement with the first tubular member; wherein an interface between the expansion device and the second tubular member does not include a fluid tight seal.

A system for fluidicly isolating a section of pipeline tubing has been described that includes: means for running a length of expandable tubing into pipeline-lined borehole and positioning the expandable tubing across a section of pipeline to be fluidicly isolated; and means for plastically deforming at least one portion of the expandable tubing to increase the diameter of the portion to sealingly engage the pipeline to be fluidicly isolated by displacing an expansion device therethrough in the longitudinal direction.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. A method of repairing a damaged portion of an underground pipeline, the pipeline positioned within a subterranean formation below the surface of the earth, comprising:
uncovering first and second portions of the pipeline;
removing portions of the first and second uncovered portions of the pipeline to permit access to the interior of the pipeline at first and second access points within the pipeline;
coupling pipe sections end to end;
positioning the coupled pipe sections within the damaged portion of the pipeline;
coupling an expansion device to the coupled pipe sections; and
radially expanding and plastically deforming the coupled pipe sections within the damaged portion of the pipeline.

2. The method of claim 1, wherein coupling pipe sections end to end comprises:
welding pipe sections end to end.

3. The method of claim 2, wherein coupling pipe sections end to end comprises:
heat treating the ends of the pipe sections.

4. The method of claim 3, wherein coupling pipe sections end to end comprises:
heat treating the ends of the pipe sections before welding.

5. The method of claim 3, wherein coupling pipe sections end to end comprises:
heat treating the ends of the pipe sections after welding.

6. The method of claim 3, wherein coupling pipe sections end to end comprises:
heat treating the ends of the pipe sections before and after welding.

7. The method of claim 1, wherein coupling pipe sections end to end comprises:
coating the exterior surfaces of the pipe sections.

8. The method of claim 7, wherein coating the exterior surfaces of the pipe sections comprises:
coating the exterior surfaces of the pipe sections with an abradable coating.

9. The method of claim 1, wherein positioning the coupled pipe sections within the damaged portion of the pipeline comprises:
pushing the coupled pipe sections into the damaged portion of the pipeline.

10. The method of claim 1, wherein positioning the coupled pipe sections within the damaged portion of the pipeline comprises:
pulling the coupled pipe sections into the damaged portion of the pipeline.

11. The method of claim 1, wherein positioning the coupled pipe sections within the damaged portion of the pipeline comprises:
pushing and pulling the coupled pipe sections into the damaged portion of the pipeline.

12. The method of claim 1, wherein coupling an expansion device to the coupled pipe sections comprises:
coupling a fluid powered expansion device to an end of the coupled pipe sections.

13. The method of claim 1, wherein radially expanding and plastically deforming the coupled pipe sections within the damaged portion of the pipeline comprises:
energizing the expansion device.

14. The method of claim 1, wherein one or more of the pipe sections comprise:
a tubular member having a corrugated cross-section.

15. The method of claim 1, wherein radially expanding and plastically deforming the coupled pipe sections within the damaged portion of the pipeline comprises:
radially expanding and plastically deforming the coupled pipe sections into engagement with the damaged portion of the pipeline.

16. The method of claim 1, wherein the cross sectional area of the radially expanded and plastically deformed pipe sections are substantially equal to the cross sectional area of the damaged portion of the pipeline prior to radially expanding and plastically deforming the coupled pipe sections.

17. The method of claim 1, wherein one or more of the pipe sections comprise:
one or more sealing members coupled to an exterior surface of the pipe sections for engaging the damaged portion of the pipeline.

18. The method of claim 1, wherein the expansion device comprises:
a fixed expansion device.

19. The method of claim 1, wherein the expansion device comprises:
an adjustable expansion device.

20. The method of claim 1, wherein the expansion device comprises:
a fixed expansion device and an adjustable expansion device.

21. The method of claim 1, wherein the expansion device comprises:
an expansion device; and
an actuator for displacing the expansion device relative to the pipe sections.

22. The method of claim 21, wherein the actuator comprises:
an actuator for pushing the expansion device through the pipe sections.

23. The method of claim 21, wherein the actuator comprises:
an actuator for pulling the expansion device through the pipe sections.

24. The method of claim 21, wherein the actuator comprises:
an actuator for rotating the expansion device through the pipe sections.

25. The method of claim 1, wherein positioning the coupled pipe sections within the damaged portion of the pipeline comprises:
vibrating the pipe sections.

26. The method of claim 1, wherein positioning the coupled pipe sections within the damaged portion of the pipeline comprises:
plastically deforming the coupled pipe sections within the damaged portion of the pipeline.

27. The method of claim 1, wherein the expansion device comprises:
a source of vibration proximate the expansion device.

28. The method of claim 1, wherein the expansion device comprises:
a rotary expansion device.

29. The method of claim 1, wherein an interior surface of one or more of the pipe sections comprises:
a lubricant coating.

30. The method of claim 1, wherein radially expanding and plastically deforming the coupled pipe sections within the damaged portion of the pipeline comprises:
hydroforming the coupled pipe sections within the damaged portion of the pipeline.

31. The method of claim 1, wherein radially expanding and plastically deforming the coupled pipe sections within the damaged portion of the pipeline comprises:
explosively forming the coupled pipe sections within the damaged portion of the pipeline.

32. The method of claim 1, wherein radially expanding and plastically deforming the coupled pipe sections within the damaged portion of the pipeline comprises:
indicating an end of the radial expansion and plastic deformation of the coupled pipe sections within the damaged portion of the pipeline.

33. The method of claim 1, wherein positioning the coupled pipe sections within the damaged portion of the pipeline comprises:
rotating the pipe sections.

34. The method of claim 1, wherein positioning the coupled pipe sections within the damaged portion of the pipeline comprises:
pulling on an end of the pipe sections using a vehicle positioned within the pipeline.

35. The method of claim 1, wherein positioning the coupled pipe sections within the damaged portion of the pipeline comprises:
floating the pipe sections within the pipeline.

36. The method of claim 1, wherein positioning the coupled pipe sections within the damaged portion of the pipeline comprises:
carrying the pipe sections on rollers through the pipeline.

37. The method of claim 1, wherein positioning the coupled pipe sections within the damaged portion of the pipeline comprises:
carrying the pipe sections on dissolvable rollers through the pipeline.

38. The method of claim 1, wherein radially expanding and plastically deforming the coupled pipe sections within the damaged portion of the pipeline comprises:
injecting energy into the pipeline.

39. The method of claim 35a, wherein the injected energy is selected from the group consisting of: thermal, acoustic, electrical, and magnetic energy.

40. The method of claim 1, wherein radially expanding and plastically deforming the coupled pipe sections within the damaged portion of the pipeline comprises:
rupturing the pipeline.

41. The method of claim 1, further comprising:
operably coupling one or more portions of the pipe sections to one or more other portions of the pipeline after radially expanding and plastically deforming the pipe sections.

42. The method of claim 1, wherein the pipeline includes one or more nonlinear portions each having one or more bend radii; and further comprising:
moving the coupled pipe sections through one or more of the nonlinear portions of the pipeline.

43. The method of claim 42, wherein the bend radii range up to about 20 degrees.

44. The method of claim 1, wherein the pipeline includes one or more nonlinear portions each having one or more bend radii; and wherein one or more of the nonlinear portions comprise at least a portion of the damaged portion of the pipeline.

45. The method of claim 44, wherein the bend radii range up to about 20 degrees.

46. The method of claim 1, wherein radially expanding and plastically deforming the coupled pipe sections within the damaged portion of the pipeline comprises:
radially expanding and plastically deforming the coupled pipe sections a plurality of times within the damaged portion of the pipeline.

47. The method of claim 1, wherein radially expanding and plastically deforming the coupled pipe sections within the damaged portion of the pipeline comprises:
radially expanding and plastically deforming the coupled pipe sections and the damaged portion of the pipeline at the same time.

48. The method of claim 47, wherein the inside diameter of the coupled pipe sections are increased by up to about 35.3%; and wherein the inside diameter of the damaged portion of the pipeline are increased by up to about 12.9%.

49. The method of claim 8, wherein radially expanding and plastically deforming the coupled pipe sections within the damaged portion of the pipeline comprises:
radially expanding and plastically deforming the coupled pipe sections by up to about 27.5%; and
wherein the abradable coating maintained its bond with the exterior surfaces of the radially expanded and plastically deformed pipe sections.

50. The method of claim 1, wherein the pipeline comprises a plurality of pipeline segments coupled end to end by welded connections.

51. The method of claim 50, wherein one or more of the welded connections comprise one or more defects.

52. A method of repairing a damaged portion of an underground pipeline between first and second portions of the pipeline, the pipeline positioned within a subterranean formation below the surface of the earth, comprising:
uncovering the first and second portions of the pipeline;
removing portions of the first and second uncovered portions of the pipeline to permit access to the interior of the pipeline at the first and second access points within the pipeline;
heat treating ends of pipe sections;
welding the pipe sections end to end;
heat treating the welded ends of the pipe sections;
coating the exterior of the welded pipe sections with an abradable coating;
gripping the pipe sections and pushing the welded pipe sections into the damaged portion of the pipeline;
pulling the welded pipe sections into the damaged portion of the pipeline;
coupling an expansion device to an end of the welded pipe sections; and
pressurizing an interior portion of the expansion device to displace an expansion cone through the welded pipe sections to radially expand and plastically deform the welded pipe sections into engagement with the damaged portion of the pipeline.

53. A method of repairing a damaged portion of an underground pipeline, the pipeline positioned within a subterranean formation below the surface of the earth, comprising:
determining the location of the damaged portion of the underground pipeline; and
radially expanding and plastically deforming one or more pipe sections within the damaged portion of the pipeline.

54. The method of claim 53, wherein radially expanding and plastically deforming one or more pipe sections within the damaged portion of the pipeline comprises:
moving an expansion device within the pipeline to a position proximate the damaged portion of the pipeline; and
then radially expanding and plastically deforming one or more pipe sections within the damaged portion of the pipeline.

55. A system for repairing a damaged portion of an underground pipeline between first and second portions of the pipeline, the pipeline positioned within a subterranean formation below the surface of the earth, comprising:
means for uncovering the first and second portions of the pipeline;
means for removing portions of the first and second uncovered portions of the pipeline to permit access to the interior of the pipeline at the first and second access points within the pipeline;
means for coupling pipe sections end to end;
means for positioning the coupled pipe sections within the damaged portion of the pipeline;
means for coupling an expansion device to the coupled pipe sections; and
means for radially expanding and plastically deforming the coupled pipe sections within the damaged portion of the pipeline.

56. The system of claim 55, wherein means for coupling pipe sections end to end comprises:
means for welding pipe sections end to end.

57. The system of claim 55, wherein means for coupling pipe sections end to end comprises:
means for heat treating the ends of the pipe sections.

58. The system of claim 56, wherein means for coupling pipe sections end to end comprises:
means for heat treating the ends of the pipe sections before welding.

59. The system of claim 56, wherein means for coupling pipe sections end to end comprises:
means for heat treating the ends of the pipe sections after welding.

60. The system of claim 56, wherein means for coupling pipe sections end to end comprises:
means for heat treating the ends of the pipe sections before and after welding.

61. The system of claim 55, wherein means for coupling pipe sections end to end comprises:
means for coating the exterior surfaces of the pipe sections.

62. The system of claim 61, wherein means for coating the exterior surfaces of the pipe sections comprises:
means for coating the exterior surfaces of the pipe sections with an abradable coating.

63. The system of claim 55, wherein means for positioning the coupled pipe sections within the damaged portion of the pipeline comprises:
means for pushing the coupled pipe sections into the damaged portion of the pipeline.

64. The system of claim 55, wherein means for positioning the coupled pipe sections within the damaged portion of the pipeline comprises:
means for pulling the coupled pipe sections into the damaged portion of the pipeline.

65. The system of claim 55, wherein means for positioning the coupled pipe sections within the damaged portion of the pipeline comprises:
means for pushing and pulling the coupled pipe sections into the damaged portion of the pipeline.

66. The system of claim 55, wherein means for coupling an expansion device to the coupled pipe sections comprises:
means for coupling a fluid powered expansion device to an end of the coupled pipe sections.

67. The system of claim 55, wherein means for radially expanding and plastically deforming the coupled pipe sections within the damaged portion of the pipeline comprises:
means for energizing an expansion device.

68. The system of claim 55, wherein one or more of the pipe sections comprise:
a tubular member having a corrugated cross-section.

69. The system of claim 55, wherein means for radially expanding and plastically deforming the coupled pipe sections within the damaged portion of the pipeline comprises:
means for radially expanding and plastically deforming the coupled pipe sections into engagement with the damaged portion of the pipeline.

70. The system of claim 55, wherein the cross sectional area of the radially expanding and plastically deformed pipe sections are substantially equal to the cross sectional area of the damaged portion of the pipeline prior to radially expanding and plastically deforming the coupled pipe sections.

71. The system of claim 55, wherein one or more of the pipe sections comprise:
one or more sealing members coupled to an exterior surface of the pipe sections for engaging the damaged portion of the pipeline.

72. The system of claim 55, wherein the expansion device comprises:
a fixed expansion device.

73. The system of claim 55, wherein the expansion device comprises:
an adjustable expansion device.

74. The system of claim 55, wherein the expansion device comprises:
a fixed expansion device and an adjustable expansion device.

75. The system of claim 55, wherein the expansion device comprises:
an expansion device; and
means for displacing the expansion device relative to the pipe sections.

76. The system of claim 75, wherein the means for displacing the expansion device relative to the pipe sections comprises:
means for pushing the expansion device through the pipe sections.

77. The system of claim 75, wherein the means for displacing the expansion device relative to the pipe sections comprises:
means for pulling the expansion device through the pipe sections.

78. The system of claim 75, wherein the means for displacing the expansion device relative to the pipe sections comprises:
means for rotating the expansion device through the pipe sections.

79. The system of claim 55, wherein means for positioning the coupled pipe sections within the damaged portion of the pipeline comprises:
means for vibrating the pipe sections.

80. The system of claim 55, wherein means for positioning the coupled pipe sections within the damaged portion of the pipeline comprises:
means for plastically deforming the coupled pipe sections within the damaged portion of the pipeline.

81. The system of claim 55, wherein the expansion device comprises:
a source of vibration proximate the expansion device.

82. The system of claim 55, wherein the expansion device comprises:
a rotary expansion device.

83. The system of claim 55, wherein an interior surface of one or more of the pipe sections comprises:
a lubricant coating.

84. The system of claim 55, wherein means for radially expanding and plastically deforming the coupled pipe sections within the damaged portion of the pipeline comprises:
means for hydroforming the coupled pipe sections within the damaged portion of the pipeline.

85. The system of claim 55, wherein means for radially expanding and plastically deforming the coupled pipe sections within the damaged portion of the pipeline comprises:
means for explosively forming the coupled pipe sections within the damaged portion of the pipeline.

86. The system of claim 55, wherein means for radially expanding and plastically deforming the coupled pipe sections within the damaged portion of the pipeline comprises:
means for indicating an end of the radial expansion and plastic deformation of the coupled pipe sections within the damaged portion of the pipeline.

87. The system of claim 55, wherein means for positioning the coupled pipe sections within the damaged portion of the pipeline comprises:
means for rotating the pipe sections.

88. The system of claim 55, wherein means for positioning the coupled pipe sections within the damaged portion of the pipeline comprises:
means for pulling on an end of the pipe sections using a vehicle positioned within the pipeline.

89. The system of claim 55, wherein means for positioning the coupled pipe sections within the damaged portion of the pipeline comprises:
means for floating the pipe sections within the pipeline.

90. The system of claim 55, wherein means for positioning the coupled pipe sections within the damaged portion of the pipeline comprises:
means for carrying the pipe sections on rollers through the pipeline.

91. The system of claim 55, wherein means for positioning the coupled pipe sections within the damaged portion of the pipeline comprises:
means for carrying the pipe sections on dissolvable rollers through the pipeline.

92. The system of claim 55, wherein means for radially expanding and plastically deforming the coupled pipe sections within the damaged portion of the pipeline comprises:
means for injecting energy into the pipeline.

93. The system of claim 75a, wherein the injected energy is selected from the group consisting of:
thermal, acoustic, electrical, and magnetic energy.

94. The system of claim 55, wherein means for radially expanding and plastically deforming the coupled pipe sections within the damaged portion of the pipeline comprises:
means for rupturing the pipeline.

95. The system of claim 55, further comprising:
means for operably coupling one or more portions of the pipe sections to one or more other portions of the pipeline after radially expanding and plastically deforming the pipe sections.

96. The system of claim 55, wherein the pipeline includes one or more nonlinear portions each having one or more bend radii; and further comprising:
means for moving the coupled pipe sections through one or more of the nonlinear portions of the pipeline.

97. The system of claim 96, wherein the bend radii range up to about 20 degrees.

98. The system of claim 55, wherein the pipeline includes one or more nonlinear portions each having one or more bend radii; and wherein one or more of the nonlinear portions comprise at least a portion of the damaged portion of the pipeline.

99. The system of claim 98, wherein the bend radii range up to about 20 degrees.

100. The system of claim 55, wherein means for radially expanding and plastically deforming the coupled pipe sections within the damaged portion of the pipeline comprises:
means for radially expanding and plastically deforming the coupled pipe sections a plurality of times within the damaged portion of the pipeline.

101. The system of claim 55, wherein means for radially expanding and plastically deforming the coupled pipe sections within the damaged portion of the pipeline comprises:
means for radially expanding and plastically deforming the coupled pipe sections and the damaged portion of the pipeline at the same time.

102. The system of claim 101, wherein the inside diameter of the coupled pipe sections are increased by up to about 35.3%; and wherein the inside diameter of the damaged portion of the pipeline are increased by up to about 12.9%.

103. The system of claim 62, wherein means for radially expanding and plastically deforming the coupled pipe sections within the damaged portion of the pipeline comprises:
means for radially expanding and plastically deforming the coupled pipe sections by up to about 27.5%; and
wherein the abradable coating maintained its bond with the exterior surfaces of the radially expanded and plastically deformed pipe sections.

104. The system of claim 55, wherein the pipeline comprises a plurality of pipeline segments coupled end to end by welded connections.

105. The system of claim 104, wherein one or more of the welded connections comprise one or more defects.

106. A system for repairing a damaged portion of an underground pipeline between first and second portions of the pipeline, the pipeline positioned within a subterranean formation below the surface of the earth, comprising:
means for uncovering the first and second portions of the pipeline;
means for removing portions of the first and second uncovered portions of the pipeline to permit access to the interior of the pipeline at the first and second access points within the pipeline;
means for heat treating ends of pipe sections;
means for welding the pipe sections end to end;
means for heat treating the welded ends of the pipe sections;
means for coating the exterior of the welded pipe sections with an abradable coating;
means for gripping the pipe sections and pushing the welded pipe sections into the damaged portion of the pipeline;
means for pulling the welded pipe sections into the damaged portion of the pipeline;
means for coupling an expansion device to an end of the welded pipe sections; and
means for pressurizing an interior portion of the expansion device to displace an expansion cone through the welded pipe sections to radially expand and plastically deform the welded pipe sections into engagement with the damaged portion of the pipeline.

107. A system for repairing a damaged portion of an underground pipeline, the pipeline positioned within a subterranean formation below the surface of the earth, comprising:
means for determining the location of the damaged portion of the underground pipeline; and
means for radially expanding and plastically deforming one or more pipe sections within the damaged portion of the pipeline.

108. The system of claim 107, wherein means for radially expanding and plastically deforming one or more pipe sections within the damaged portion of the pipeline comprises:
means for moving an expansion device within the pipeline to a position proximate the damaged portion of the pipeline; and
means for then radially expanding and plastically deforming one or more pipe sections within the damaged portion of the pipeline.

109. An underground pipeline, comprising:
a radially expanded pipeline; and
a radially expanded and plastically deformed tubular liner positioned within and coupled to the pipeline.

110. The pipeline of claim 109, wherein the pipeline comprises a first portion that is radially expanded and a second portion that is not radially expanded; and wherein an inside diameter of the liner is substantially equal to an inside diameter of the second portion of the pipeline.

111. A method of joining a second tubular member to a first tubular member within a pipeline, the first tubular member having an inner diameter greater than an outer diameter of the second tubular member, comprising:
positioning an expansion device within an interior region of the second tubular member;
pressurizing a portion of the interior region of the second tubular member; and
radially expanding and plastically deforming the second tubular member using the expansion device into engagement with the first tubular member;
wherein an interface between the expansion device and the second tubular member does not include a fluid tight seal.

112. A method of fluidicly isolating a section of pipeline tubing, comprising:
running a length of expandable tubing into pipeline-lined borehole and positioning the expandable tubing across a section of pipeline to be fluidicly isolated; and
plastically deforming at least one portion of the expandable tubing to increase the diameter of the portion to sealingly engage the pipeline to be fluidicly isolated by displacing an expansion device therethrough in the longitudinal direction.

113. An apparatus for expanding a tubular liner in a pipeline, comprising:
a support member;
an expansion device coupled to the support member;
a tubular liner coupled to the expansion device; and
a shoe coupled to the tubular liner, the shoe defining a passage;
wherein the interface between the expansion device and the tubular liner is not fluid tight.

114. A system for joining a second tubular member to a first tubular member within a pipeline, the first tubular member having an inner diameter greater than an outer diameter of the second tubular member, comprising:
means for positioning an expansion device within an interior region of the second tubular member;
means for pressurizing a portion of the interior region of the second tubular member; and
means for radially expanding and plastically deforming the second tubular member using the expansion device into engagement with the first tubular member;
wherein an interface between the expansion device and the second tubular member does not include a fluid tight seal.

115. A system for fluidicly isolating a section of pipeline tubing, comprising:
means for running a length of expandable tubing into pipeline-lined borehole and positioning the expandable tubing across a section of pipeline to be fluidicly isolated; and
means for plastically deforming at least one portion of the expandable tubing to increase the diameter of the portion to sealingly engage the pipeline to be fluidicly isolated by displacing an expansion device therethrough in the longitudinal direction.

116. A method of repairing a damaged portion of an underground pipeline, the pipeline positioned within a subterranean formation below the surface of the earth, comprising:
uncovering one or more portions of the pipeline;
removing portions of the uncovered portions of the pipeline to permit access to the interior of the pipeline at one or more access points within the pipeline;
positioning one or more pipe sections within the damaged portion of the pipeline;
coupling an expansion device to the pipe sections; and
radially expanding and plastically deforming the pipe sections within the damaged portion of the pipeline.

117. A system for repairing a damaged portion of an underground pipeline, the pipeline positioned within a subterranean formation below the surface of the earth, comprising:
means for uncovering one or more portions of the pipeline;
means for removing portions of the uncovered portions of the pipeline to permit access to the interior of the pipeline at one or more access points within the pipeline;
means for positioning one or more pipe sections within the damaged portion of the pipeline;
means for coupling an expansion device to the pipe sections; and
means for radially expanding and plastically deforming the pipe sections within the damaged portion of the pipeline.

118. A method of up-rating a portion of an underground pipeline, the pipeline positioned within a subterranean formation below the surface of the earth, comprising:
uncovering one or more portions of the pipeline;
removing portions of the uncovered portions of the pipeline to permit access to the interior of the pipeline at one or more access points within the pipeline;
positioning one or more pipe sections within the pipeline;
coupling an expansion device to the pipe sections; and
radially expanding and plastically deforming the pipe sections within the pipeline;
wherein the capacity of the pipeline to convey fluidic materials is increased after radially expanding and plastically deforming the pipe sections within the pipeline.

119. A system for up-rating a portion of an underground pipeline, the pipeline positioned within a subterranean formation below the surface of the earth, comprising:
means for uncovering one or more portions of the pipeline;
means for removing portions of the uncovered portions of the pipeline to permit access to the interior of the pipeline at one or more access points within the pipeline;
means for positioning one or more pipe sections within the pipeline;
means for coupling an expansion device to the pipe sections; and
means for radially expanding and plastically deforming the pipe sections within the pipeline;
wherein the capacity of the pipeline to convey fluidic materials is increased after radially expanding and plastically deforming the pipe sections within the pipeline.

120. A method of coupling a tubular liner to an underground pipeline, the pipeline positioned within a subterranean formation below the surface of the earth, comprising:
injecting energy into the pipeline; and
radially expanding and plastically deforming the tubular liner within the pipeline during the injecting.

121. The method of claim 120, wherein the injected energy is selected from the group consisting of: thermal, acoustic, electrical, and magnetic energy.

122. A system for coupling a tubular liner to an underground pipeline, the pipeline positioned within a subterranean formation below the surface of the earth, comprising:
means for injecting energy into the pipeline; and
means for radially expanding and plastically deforming the tubular liner within the pipeline during the injecting.

123. The system of claim 122, wherein the injected energy is selected from the group consisting of: thermal, acoustic, electrical, and magnetic energy.
